(19) United States
(12) Patent Application Publication
(10) Pub. No.: US 2022/0165104 A1
(43) Pub. Date: May 26, 2022

(54) SECURITIZED AND ENCRYPTED DATA FOR VEHICLE SERVICE CONCIERGE (SC) DEVICES AND SYSTEMS THAT PROVIDE AND PREDICT IMPROVED OPERATIONS AND OUTCOMES

(71) Applicant: Service Concierge, Quincy, MA (US)

(72) Inventors: DIARMUID GARDINER, Quincy, MA (US); BARTOSZ CZERWINSKI, Cellbridge (IE)

(21) Appl. No.: 17/441,120

(22) PCT Filed: Mar. 19, 2020
(86) PCT No.: PCT/US20/23692

§ 371 Date: Sep. 20, 2021

Related U.S. Application Data
(60) Provisional application No. 62/820,690, filed on Mar. 19, 2019.

(51) Int. Cl. G07C 5/08; G07C 5/00; G06Q 30/02; G06Q 10/08

(52) U.S. Cl. CPC G07C 5/0808; G07C 5/006; G07C 5/0816; G06Q 10/0875; G07C 5/008; G06Q 30/0284; G07C 5/0841

(57) ABSTRACT

Computer-based concierge service (SC) virtual and/or real devices operational in connection with or separately from access and user devices where the (SC) devices comprise an ability to communicate with vehicle owners to assess potential issues vehicles have or will experience and to determine, schedule, and individualize each detail of a vehicle's visit to a dealership or business. The SC devices are employed to provide predictive insights into metrics associated when servicing a vehicle in the presence or absence of the owner. The predictor devices can be any virtual and/or real device that includes networked or stand-alone computer terminals, smart or cell phones, scanners, printers, etc., all capable of transceiving data and data signals and all of which capable of receiving, storing, retrieving, and analyzing data obtained directly from data transmitted to and from the vehicle as well as data received by virtual or real devices.

### PRIORITY

This application is a 371 National Phase filing of PCT/US2020/023692 filed Mar. 19, 2020, which claims priority under US 35 USC 119 from Provisional Application No. 62/820,690 entitled “Securitized And Encrypted Data For Vehicle Service Concierge (SC) Devices And Systems That Provide And Predict Improved Operations And Outcomes” filed Mar. 19, 2019.

### FIELD OF INVENTION

The present disclosure relates generally to devices and/or systems that enable and provide automation of predictive estimates and reports associated with all known and anticipated needs, costs, and pricing of servicing vehicles as well as automation of service appointment generation, assessment of required services and assignment of tasks to provide service by service associates or other employees within a dealership/vehicle service organization. These tasks are achieved by a combination of hardware, software, databases and advanced machine learning algorithms that support artificial intelligence (AI) to provide service organizations with the capabilities to address both current and future aspects of care, maintenance, predictive needs, and potential upgrades not previously available to owners of automobiles, trucks, and other transportation vehicles. More particularly, the present disclosure relates to utilizing computers and computer-networked devices with databases and systems that provide vehicle organizations with the capability to predict revenue streams based on the use of constantly updated information in order to optimize efficiency and profitability. This disclosure also includes details which address the fact that as autonomous/driverless vehicles become more commonplace, the need for human interaction will dwindle giving rise to vehicles that are self-maintaining as well as self-driving. It is also important to have the ability to securitize and encrypt the customer and vehicle informational data transmitted to and from numerous dealership concierge service predictor (SC) devices and associated systems.

### DISCUSSION OF RELATED ART

In the field of automotive servicing, consumers purchase either new or used vehicles that may or may not have a warranty.

While automotive sales are obviously important to automobile dealerships, servicing also represents a substantial portion of their business. As such, vehicle dealerships have servicing departments which handle high volumes and therefore also are faced with a heavy workload.

During a typical servicing write-up, a customer will arrive at a dealership either with or without an appointment and request “on the spot” attention. The service advisor or others at the dealership will make a brief determination of the necessary parts and labor needed to complete the repair. It is important to note that this vehicle write-up must be completed quickly in order for the servicing department to effectively handle a high volume of repairs. Thus, there is little time to perform an effective preliminary diagnosis, and underlying problems often appear after the repair process has begun and an estimate has been given. Another difficulty is that few resources exist that can aid in vehicle-specific diagnosis when determining servicing requirements. High employee turnover also typically exists at the service advisor position, which creates additional resource and scheduling difficulties (for the dealership or vehicle servicing organization).

Normally, a service advisor at a dealership/organization ‘performs a repair estimate, creates an initial repair order, dispatches the work to a service technician, schedules the service and monitors the progress of repair. The service associate also communicates the progress of repair back to the customer and serves as a point of contact. In the present disclosure, the service associate can be either a service technician or a service advisor or function as both. It is also possible that the dealership service will use telephone operators, receptionists, etc., involved in the booking of a vehicle for the dealership. Upon completion of the servicing, the service associate performs additional tasks to explain the services performed and supervises the return of the vehicle to the owner. Arranging the departure of a customer once the customer is ready to leave the vehicle for repair demands significant effort from the service advisor. Specifically, a service advisor has to contact loaner vehicle management systems, rental vehicle options, taxi and uber-like businesses, etc., to arrange outbound travel for the consumer/customer/user.

Loaner vehicle dispatch system demands Know Your Customer (KYC) procedure which involve customer identification with physical and/or digital documents. These resource are resource intensive regarding the time spent by service advisors and other dealership employees. For the purposes of this disclosure, customers, consumers, and users of the SC devices (virtual and/or real) are often interchangeable as one or more persons that are advantaged by the use of the SC. The SC devices and systems has the ability to automate the functions associated with these tasks.

One shortcoming of these approaches includes the write-up process and the need for effective pre-diagnosis. The write-up process is a process which has historically included human interaction with vehicle owners and those involved in all aspects of servicing the vehicle and their owners). Specifically, the collection of service information such as symptoms associated with the vehicle's performance, appearance, etc., customer identification and vehicle identification is performed manually and under substantial time constraints. Furthermore, the analysis of the service information is typically cursory. Additionally, other short comings of current business methods includes the need for manual labor required in booking (scheduling) a vehicle for inspection and/or service. The SC has the ability to automate the functions associated with these tasks using artificial intelligence (AI) systems together with custom hardware, software and dynamic databases that can be continuously updated.

Of further concern and what has not been previously addressed is the need for owners and operators of the dealership/organization to reliably, consistently, and reproducibly predict the workloads and associated costs of servicing multiple vehicles on (normally) an irregular basis. In order to efficiently and economically operate the dealership while also producing regular and reproducible quality service, an additional need exists to employ devices and systems that will provide real time capabilities to predict and monitor costs, profitability, and associated services required on a per vehicle/owner basis. Furthermore, to be economically viable, the SC ecosystem of devices and systems must be able to automate scheduling of vehicles which also reduces human labor workload(s).

The present disclosure overcomes the aforementioned disadvantages as well as other disadvantages described below in further detail.

### SUMMARY

In accordance with the teachings of the present disclosure one or more computer-based devices and/or systems are provided that collect information in the form of data or data sets regarding a vehicle from a user that must provide at least a VIN (vehicle identification number) as well as a customer/consumer identification code (CIC). The CIC can be a phone number, email id, instant messenger id, or other desired identification of the customer/consumer needed to complete transactions in a business environment. Devices typically used for both the VIN and CIC number identifiers include scanner, sensors, as well as APIs with manual and/or voice or and/or biometric computer inputs. One major purpose for service concierge predictor device(s) (SC) is to determine, schedule, detail, and individualize real-time and future visits for a vehicle that either abruptly (i.e. in an unscheduled manner) enters the dealers' workshop or have been scheduled (or “booked”) for service. In addition, the SC includes use of a scheduling software, a kiosk for customer/consumer interaction, and providing the ability for the customer to have transportation while the vehicle is being serviced. The SC predictor is capable of accurate and precise prediction of required items that are also useful for optimizing business operations at a dealership during servicing of a vehicle by utilizing acquired data that includes at least the following items;
a) Non-essential items that will be recommended and sold for/while servicing the vehicle
b) Which, what and how items will be sold during the servicing
c) The level of expertise of the technician that will be required
d) The essential equipment that will be required
e) The essential and non-essential parts stock requirements
f) The total number of hours the vehicle will reside in the vehicle bay/workshop of the dealership
g) The final repair order value—which is the cost to the consumer
h) Prediction and optimization of the utilization/need of/for loaner vehicles
i) Based on time and mileage, maintenance items that will be sold
j) Which staff member of the dealership/organization should interact with the customer and a list of these staff members which can be automatically updated.

Many predictive systems can provide predictions utilizing quantitative data. In the present disclosure, the SC automated service scheduling system provides unique functionalities compared with current state-of-the-art systems that includes; interaction with a consumer of a vehicle to obtain details of the needs of the consumer using text, voice, and/or data either singularly or in any combination. The SC can automatically understand and interpret the major issues of concern for the consumer regarding the vehicle based on the consumer's description of the problem. Issues of concern are further used to ask the least number of questions to zero-in on the most probable problems in the vehicle. For the purposes of this disclosure, non-essential items include those that are not required to keep the vehicle on the road and drivable. Drivable, in this instance means that the vehicle also meets all the safety requirements for the jurisdiction where the vehicle is registered anywhere in the world (both inside and outside the United States). Keeping the vehicle drivable and/or usable constitutes providing the parts, service, labor, etc. that is required but does not include non-essential parts and service unless the customer/vehicle owner has requested this option.

With the use of the generated data from databases created using the predictive capabilities listed in at least (a j) above, the devices and associated system will provide business intelligence in the form of predictive reports that at least predict and can provide plots with reports that have the capability to detail at least the following;
1. Current/future shop revenues
2. Current/future shop efficiency
3. Current/future staffing needs
4. Current/future bay needs
5. Define and predict most efficient process models
6. Current/future averages regarding all vehicle's make/model/year and associated repair order values
7. Current/future parts inventory requirements
8. The number of service vehicles to be traded in and upgraded
9. The appropriate time to present the customer with an offer for trade-in
10. Real time prediction of the mood of the consumer (state of mind at any instance of time) that allows for prediction of the probability of an upsell option for the vehicle

The databases should be protected via securitization and/or encryption and can be dynamically changing databases that accumulate and sort data as needed to provide artificial intelligence to the service concierge devices. These devices are a unique combination of the use of hardware (including kiosk) and software (including built-in digital voice assistant, voice assistant in the kiosk, web sites with pages to collect detailed customer and vehicle information software capabilities, etc.) that assist with building and deployment of an accurate predictive business intelligence system with accuracy that is greater than from those predictive systems which do not have access to the set of complete rich and unique data including associated systems that are a portion of the SC. The predictor devices, in the present disclosure include requirements that make it impossible to obtain the predictions associated with the predictor devices and the SC system without the use of computers and/or computer networks. The SC devices can operate as either stand-alone devices, interconnected (via the world wide web or internet, intranet, or cloud) devices, and/or mobile devices. Predictive analytics can be performed on the cloud with computational infrastructures supporting the cloud and using predictive analytics with software that is operational with associated hardware so that virtual and/or real devices can perform the necessary operations. The predictor devices can be installed within dealerships or other businesses on stand alone or networked terminals, personal computers, laptops, etc., within the vehicles (in dashboards, consoles, etc.) or simply installed as mobile apps (applications) on smart phones. Accessing the predictions of the predictor devices must be simple, reliable, and reproducible and the predictions should be easily reported to those in need of the prediction outputs. The predictive business intelligence is targeted primarily senior managers and corporate level executives in dealerships/businesses and is useful for all transportation vehicles including boats, ships, aerospace, military, and those intended for space travel and exploration. Other versions of the SC systems are included that can be utilized with existing systems such as SAP, Zoho, CRM (customer relations management), Google, Apple, and Amazon voice activated assistants including Alexa, Echo, etc. as well as other Business Intelligence (BI) software platforms required by each dealership/business. The SC system has been developed so that adoption to and with each of the BI platforms is possible and easily accommodated.

Further objects, features and advantages of the invention will become apparent from a consideration of the following description and the appended claims when taken in connection with the accompanying drawings.

More specifically the present disclosure includes one or more access and user devices and/or systems comprising: at least one computer processing unit (CPU) with computational capabilities that is connected to and controls a computer memory via an address bus and a data bus where said address bus accesses a designated range of computer memories and range of memory bits and said data bus provides a flow of transmission(s) of data into and out of said CPU and computer memory; so that one or more computer-based vehicle concierge service (SC) devices are operational in connection with or separately from said access and user devices, said (SC) devices comprising; an ability to communicate with a vehicle owner, obtain a description of an owner's concern regarding a vehicle, assess potential issues that might exist for each vehicle, as well as to determine, schedule, and individualize each detail of a vehicle visit to any vehicle associated business that enters a workshop, wherein said (SC) devices are employed to provide predictive analysis that includes and predicts or monitors or predicts and monitors services and associated costs required for each vehicle and/or fleet of vehicles on a per vehicle basis and that includes a time required for accomplishment of said services.

In addition, the SC devices provide information in a form of data and act to control one or more outputs devices, wherein said output devices are computing devices, wherein databases store data and configure bi-directional transmission of data to and from multiple SC devices, wherein said user devices, said access devices, and said SC devices are computing devices, and wherein one or more user, access, and SC devices store and provide at least partial copies of portions of a master database, and wherein said master database can also include partial databases and each of said databases are linked and communicate with each other and wherein said user, access and/or SC devices include one or more logging and monitoring databases that provide statistical and numerical calculations utilizing data.

In another embodiment, the one or more SC devices authenticate using a first set of computing operations, and validate using a second set of computing operations, and wherein a third set of computing operations controls access for a specified set of users of said SC devices and wherein data associated with said operations is securitized or encrypted or securitized and encrypted.

Here the SC devices provide information in data format that optimizes performance and profitability for said vehicle associated business and wherein said data is accessible in order that said data is produced, analyzed, and interpreted and is optionally contained within a report that summarizes interpretation of said data and wherein said vehicle associated business is a dealership.

The vehicle abruptly enters a dealership's workshop in an unscheduled manner and the vehicle can be scheduled for future service at said dealership's workshop.

The predictive assessments provide statistical certainty with regard to vehicular needs based upon historical data obtained from each vehicle and wherein said historical data resides in one or more static or dynamic databases that are included within said one or more computer-based SC devices.

Here, the databases are located within at least one of a group consisting of; a stand-alone, laptop, or mobile computer, a client-server, a network of computers that are networked individually or together and access an internet, a cellular phone that is a smart phone, and a cloud computer.

The devices access at least one of a group consisting of an internet, intranet, and extranet such that said devices can obtain data generated from multiple sources in addition to data obtained from a single or multiple vehicle related businesses and/or dealerships.

Here, the costs, profitability and associated services required data is provided on a per owner basis for individual or fleets of vehicles to vehicle related businesses and dealerships.

Prediction of items required to service said vehicles are selected from at least one of a group consisting of; non-essential items that will be recommended for/while service is performed for said vehicles during servicing, a level of skill of one or more technicians that will be required, essential equipment required, essential and non-essential parts stock requirements, a total number of hours said vehicle(s) will reside in a vehicle bay/workshop of said dealership, a final repair order value that includes a cost to a consumer, and prediction and optimization of utilization and need of and for loaner vehicles, wherein said prediction is based on data attributes including time and mileage, time on roadways, streets, and highways, as well as customer spending habits, number of vehicles owned and maintenance items that will be sold so that how and which one or more staff members of said vehicle related business and/or dealership should interact with an owner of said vehicle.

In yet another embodiments the use of data from databases created or obtained using said SC devices provides business intelligence in a form of predictive reports that at least predict and can also provide plots with said reports that provide details from at least one of a group consisting of; current/future shop revenues, current/future shop efficiencies, current/future staffing needs, current/future bay needs, current/future averages regarding all vehicle makes/models/years and associated repair order values, current/future parts inventory requirements, a number of service vehicles to be traded in and upgraded, and an appropriate time to present customers with an offer for trade-in that is dependent on predictions obtained from said SC.

The databases are protected via securitization and/or encryption and are dynamically changing databases that can accumulate and sort data as needed to provide artificial intelligence (AI) to said SC devices.

The devices can be virtual devices and/or real devices.

In a further set of embodiments, one or more transaction secured computer-based dealership concierge service predictor (SC) devices that transmit to and receive data from one or more transaction secured SC devices to another, comprising: a housing; a computer driven communication processor containing a microprocessor and data storage encryption capacity fixedly mounted in said housing; one or more circuits fixedly mounted in said housing and communicatively coupled with said computer driven communication processor; a power source coupled with said circuits; at least one transceiver including a data transceiver portion coupled with said housing and coupled with said circuits and with said computer driven communication processor where one or more sensors are held within or on one or more surfaces of said transaction secured SC devices; wherein said transaction secured SC devices transmit and receive encrypted signals from one or more said transaction secured SC devices to another that form specific transmissions determined by one or more users, to said transceiver and a vehicle data transceiver portion of said transceiver;

wherein said transceiver and said vehicle data transceiver portion of said transceiver determines, via authentication and validation, identification of said users and confirms if said users are allowed access and manipulation of said transaction secured SC devices via utilization of said computer driven communication processor;
wherein said computer driven communication processor provides, processes, and analyzes confirmation and authentication of said users and allows a designated set of users of said SC transaction secured devices to operate said SC devices.

The circuits are connected to sensors or said circuits themselves function as sensors,

wherein said circuits are selected from the group consisting of; electronic, optical, and radiation emitting or receiving or both radiation emitting and receiving energized circuits that transmit and receive signals and wherein one or more display portions are communicatively coupled with said circuits.

Here, the display portions display timepiece data or transaction data or both timepiece data and transaction data.

The devices can be either real devices, virtual devices, or both real and virtual devices.

These devices here can be selected from one or more of a group consisting of; computer terminals, laptop computers, smart phones that are cell phones with computation capabilities, printers, kiosks, vehicular dashboards with computational capabilities and visual or audio or both visual and audio displays, and transceivers with visual or audio or visual and audio information conveyance capabilities.

In yet a further embodiment, the SC devices includes one or more Service Concierge (SC) Predictor AI module(s) that is a software module that operates together with and can reside within or external to said SC device(s) and that is responsible for provision of descriptive, predictive, and prescriptive business data for vehicle dealerships, associated vehicle businesses, and any stakeholders of said businesses, and wherein said Service Concierge Predictor AI module provides data that utilizes data stored in Dealership Management Systems DMS and related databases with data derived from dealerships and vehicle associated businesses and generates data using digital communication channels either housed within said SC device(s) or data derived from external data and databases.

In some cases, the SC Predictor AI Module has data is continuously updated data that includes a consumer's description of vehicle problems, concern types detected by a Service Concierge Understand AI module, and consumer's emotion(s) regarding said vehicle wherein said continuously updated data is continuously improving data in that data capture is useful for data analysis of one or more vehicles and said data analysis is based upon at least consumer interaction with vehicle(s) data and direct from vehicle automated interaction data.

Further vehicle interaction data includes customer's vehicle data that is captured by sensors that utilize data sent through digital communication channels including vibration sensors in addition to additional data captured directly from informational data that is contained within vehicles.

In some cases, unique consumer interaction data and vehicle interaction data available on SC device(s) are transformed by said SC Predictor AI module using techniques that include log transformation and binarizing categorical predictor variables in order to allow said SC Predictor AI module to generate business analytics for said vehicle associated businesses, said business analytics selected from at least one or more of a group consisting of a dealership, a customer/consumer, vehicle repair and maintenance records, and wherein said vehicles include at least one or more of a group consisting of automobiles, trucks, motorcycles, snowmobiles, above and below water transportation craft, aircraft, and spacecraft and wherein said group can also be a fleet of said vehicles.

These devices and/or systems are employed to provide at least one of a group consisting of service, repairs, maintenance and predictive analysis for autonomous or driverless or autonomous and driverless vehicles on a per vehicle basis and includes a time required for accomplishment of said services.

In another embodiment, one or more transaction secured computer-based dealership concierge service predictor (SC) wherein the transaction and/or transactions are secured by one or more access devices or one or more user devices or both one or more access devices and one or more user devices comprising: at least one computer processing unit (CPU) with computational capabilities that is connected to and controls a computer memory via an address bus and a data bus where the address bus accesses a designated range of computer memories and range of memory bits and the data bus provides a flow of transmission(s) into and out of the CPU and computer memory; one or more real or one or more virtual master distributed auto-synchronous array (DASA) databases or both one or more real and one or more virtual master distributed auto-synchronous array (DASA) databases located within or external to the access devices and the user devices, where the master (DASA) databases at least store and retrieve data and also include at least two or more partial distributed auto-synchronous array (DASA) databases, wherein the partial DASA databases function in either an independent manner, a collaborative manner or both an independent manner and a collaborative manner, wherein the master and the partial DASA databases analyze and provide information in a form of data and act to control one or more output devices, wherein the output devices are computing devices, wherein one or more output devices create user devices, and wherein the master and said partial DASA databases configure bi-directional transmission of data to and from multiple partial user devices, to and from multiple partial access devices or to and from both multiple partial user and multiple partial access devices, wherein the user devices and said access devices are computing devices, and wherein one or more partial user and one or more partial access devices store and provide at least partial copies of portions of the master DASA databases, and wherein the master DASA databases, the partial DASA databases or both the partial DASA databases and the master DASA databases are linked and communicate with each other as well as inclusion of one or more logging and monitoring databases that provide statistical and numerical calculations utilizing data, wherein the one or more access devices authenticate using a first set of computing operations, and validate using a second set of computing operations, and wherein a third set of computing operations controls access for a specified set of users. This embodiment and the concepts and utilization of securitization and encryption of the data is included in U.S. Pat. No. 10,154,021 issued Dec. 11, 2018 which is hereby incorporated by reference.

### BRIEF DESCRIPTION OF THE DRAWINGS

FIGS. 1A-1M Working Example(s) and Embodiments that Utilize the SCD

FIGS. 2A and 2B: Customer Initiation Regarding Utilization of SCD

FIG. 3: Initiation of Interaction and Interface between Customer and Kiosk

FIGS. 4A, 4B, 4C: Addition of Customer Details Using SCD

FIGS. 5A, 5B, 5C: Customer Record Number and Customer Information Look-up Using SCD

FIGS. 6A, 6B: Customer New Repair Order Sequence for SCD

FIGS. 7A, 7B, 7C: Initial Vehicle Registration using SCD

FIGS. 8A, 8B: First Stage for Kiosk Interaction with the SCD

FIG. 9A, 9B: Second Stage Interaction with Kiosk with SCD Interaction

FIG. 10A, 10B: Third Stage Kiosk Operating Procedures for the SCD Customer/Kiosk

FIG. 11 A, 11B, 11C, 11D: Final Stage Kiosk Operating Procedures for the SCD

FIG. 12: Historical and Situational Data that Can be Accessed and Analyzed for the CSD and Associated Systems

FIG. 13 Service Visit Analysis and Predictions for the SCD

FIG. 14. Flow Path that Provides Business Intelligence Predictive Reports

FIG. 15A and FIG. 15B: First Set of SCD System Architecture Schematic Diagrams

FIGS. 16 A, B, C, D, E and F (Second Set of SCD System Architecture Schematic Diagrams

FIGS. 17A, B, C, D, E, F, G, H, I, J, K, L (Third Set of SCD System Architecture Schematic Diagrams)

FIGS. 18 A, B, C, D, E, F, G, H, I, J, K, L (Third Set of SCD System Architecture Schematic Diagrams)

FIGS. 19A and B: Fourth Set of SCD System Architecture Schematic Diagrams

FIG. 20: A Schematic Diagram Indicating Procedures and Operations for the SC Devices and Associated Systems

FIG. 21: A 3-D Representation of the use of a kiosk and stand combination

### DETAILED DESCRIPTION

In order to accomplish the present disclosure of the service concierge predictor that will determine, schedule, detail, and individualize real-time and future visits for a vehicle that either abruptly (i.e. in an unscheduled manner) enters the dealers' workshop or has been scheduled (or “booked”) for service as well as providing information to optimize dealership/business performance and profitability, it is necessary to access, produce, analyze and report acquired data. Here, the data generated are unique to the SCDs with or without a kiosk. The kiosk provides a GUI (graphical user interface) for the service concierge (SC) software that together with external digital voice assistants/web APIs/databases which are optionally securitized and encrypted, enables users to receive and protect the predictive analytics as it is deployed. These voice assistants/web APIs/with the included access to databases are a portion of the hardware/software ecosystem that automates the SC process. This data includes at least the following;
a. Historical repair order information (booked service items, recommended items, sold items) from
   i. Particular store/business location
   ii. Region
   iii. Vehicle brand (make) and model
b. Historical vehicle owner's spending patterns
   i. Type of recommendations previously purchased
   ii. Percentage of recommendations previously purchased
   iii. Dollar amount spent per visit
   iv. Service visit frequency
c. Time of day when the vehicle arrived at the store
d. Technician's number and type of recommendations
e. The value in currency of the technician's recommendations
f. Technician's recommendation rate based on year, make, model and mileage
g. Advisor close rate on recommendations percentage
h. Advisor close rate on customer pay recommendations
i. Advisor recommendation rate based on year, make, model and mileage
j. Vehicle make/model/year/mileage
k. Driver's age group/gender/location
l. Time of year/month/weather
m. Dealership location
n. Dealership business hours
o. Number of shop bays
p. Number of shop technicians
q. Number of advisors
r. Repair order/hours sold and actual ratio number for technician
s. Repair order/hours sold and number of bays actual ratio number

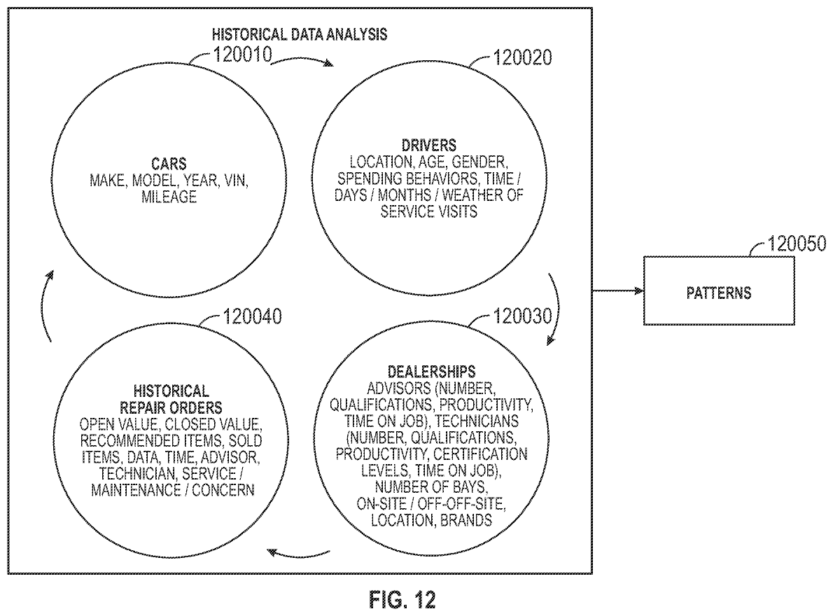

The historical data analysis is depicted in FIG. 12 and indicates data that can be utilized to provide predicative patterns. These patterns are then analyzed and develop the basis for the final predictive audio, visual, and/or audio-visual reports.

The process for predictive analysis includes pattern recognition and one or more predictor devices that utilize a combination of content-based analysis of historical repair orders together with a content-agnostic analysis of a combination of the data input factors indicated in FIG. 12.

By the application of content-based analysis of the content of historical repair orders, the textual description of line items recommended and sold, and based on historical transaction outcomes, it is possible to predict the probability and quantity of purchases that a customer will make for servicing the vehicle. Based on the historical data, content-agnostic systems will learn based on low-dimensional representations for users and products. The basic concept for SC is that the data indicates how similar customers, driving similar vehicles, in similar locations, etc., will approve similar recommendations. Both methods, content-based and content-agnostic have been combined into an ensemble model in order to improve the final predictive patterns and their outcomes.

In order to provide the prediction capabilities, content based and content agnostic analysis can access analyze and utilize a variety of different data patterns and associated probabilities. The SC devices and associated system(s) utilize heuristic, initially low precision methods to calculate, enforce, and/or inhibit resulting in outcome probabilities in order to achieve predictive optimization models. The predictive optimization models improve outcomes with each successive repair and other service transactions for individual and/or fleets of vehicles. In order to provide the prediction capabilities, content-based and content agnostic analysis will return a variety of different patterns. The SC devices and associated system utilizes heuristic, initially low precision methods to calculate, enforce or inhibit resulting outcome patterns to drive predictive optimization models. The probability models are further automatically enhanced by the outcomes of each next repair order transaction. Specifically, when there is limited data, techniques including alpha smoothing, Bayesian prior distributions that are uniform are invoked. Domain knowledge provided by subject matter experts is used to set hyperparameter values of Bayesian graphical models in order to derive probabilities regarding business metrics.

For the present disclosure, at least two types of predictions are available by utilizing a Concierge Service Predictor (SC) device;
1. Ad-hoc, real-time predictions on each vehicle service visit as appointments or repair orders are generated
2. On-demand, business intelligence reports

Figure B provides the flow path and associated details that provides the necessary processes for the SC to fulfill its function.

To train the machine learning algorithm to recommend correct operations historical data about previous vehicle service visits is a requirement for the SC system. For each such appointment, information about the vehicle (such as its model, mileage, year of production, history of previous repairs), information about the client (e.g. demographics, ideally historical vehicle spending patterns, mood and mindset at the time of vehicle servicing) and general information such as date of visit (the time of year might be relevant) and location must be obtained. This data is used as input to the machine learning model of the present disclosure. It is necessary to use information that is predictive of which vehicle services will be eventually sold.

Moreover, for each of these vehicle service visits, a list of vehicle services/operations that were recommended and a list of which of these were actually sold is required. This data generated is used as targets for the machine learning model and allows for the AI functionality. As more data is generated and stored/accessed, the databases become more robust and can be utilized to develop predictor reliability. In the test phase, only predictor variables are sufficient and target variables can easily predicted. More difficult variable predictions are possible with the use of the SC devices and associated systems. This is a critical aspect of the present disclosure, because supervised learning is utilized and the model learns by comparing its predictions with the targets.

Additionally, to calculate (or use as targets and train a separate model to predict it) items such as the total number of hours the vehicle will be in the bay/workshop and what equipment will be required, we need information about such requirements for each operation that can be recommended.

Predictive Algorithms

The SC devices provide ad-hoc, real-time predictions on each vehicle service visit as an appointment or repair orders are generated.

Content-based and content agnostic analysis will return a variety of different pattern outcomes. The SC devices and associated systems will utilize low precision methods to calculate, enforce and/or inhibit resulting outcome patterns to drive predictive optimization models. The probability models will thus be further automatically enhanced by the outcomes of each next repair order transaction.

In one embodiment, machine learning will be applied to predicting, for each operation (e.g. type of repair), the probability with which this mechanical operation will be needed and sold. Based on performance of predictive algorithms which SC determines by assessing prediction accuracy scores, the remainder of the important values are obtained by hard-coded rules. For example, in the “Concierge app” (one of the first implemented applications of the SC), five (5) services are recommended with the highest probabilities of the need and request being assigned to each of the services. The total number of hours the vehicle will be in the bay/workshop is calculated by summing the durations of operations with probabilities exceeding a certain threshold. Statistical models that include Bayesian graphical models, machine learning models including neural networks and random forests are all employed to derive predictive probability densities for target variables. Utilizing these techniques and models, it is possible to predict target variable values and limits on these values with increasing accuracy. Also, needed parts and equipment are determined and the list of parts, equipment and repair/upgrade is obtained from the SC prediction (including the AI modules) regarding which options and service operations will be sold to the customer/consumer.

Next, these values are used as targets that are subsequently utilized to train separate models to predict them directly based on the same input data. The artificial intelligence (AI) aspect of this embodiment is that as more values and associated targets are developed that can be added to databases or stored or otherwise accessed, the more accurate and precise the predictions will become. It is important that the SC devices and systems utilize both techniques to determine which one yields better performance metrics including many state of the art supervised machine language techniques.

In this embodiment, the “machine learning problem” is framed or known as a supervised multi-label classification with missing labels. The multi-label portion allows for the situation where there often is more than one correct answer—more than one of the recommended services might be purchased by the customer/consumer. “Classification” in this case means that each operation model provides outputs with probabilities addressing how this operation will be sold to the user given the (over time optimized) input circumstances (information about the vehicle, its owner, time of year etc.).

“With missing labels” means that the SC recommends only a limited subset of operations during each appointment, so for many of them it is unknown whether they'd be actually sold if they were recommended.

The exact algorithm used in the framework of supervised multi-label classification is determined empirically and these empirical iterations will continue over time based upon data developed within the dynamic databases. The specific machine learning models that fits this framework include at least the Gradient Boosted Decision Trees and Neural Networks models. There are numerous well known algorithms available for solving multi-label classification problems. These include multilabel K nearest neighbor, neural networks, and decision trees. Each of these algorithms provide better predictive accuracies compared with other known algorithms depending on the data and data sets available. The SC device(s) checks for the accuracy of the predictions derived from each of these algorithms periodically and chooses which of the algorithms to employ based on the datasets of business metrics available to achieve the best predictive analytics.

Predictive Business Intelligence Reporting for a Vehicle Dealer, Distributor and Manufacturer Including a Predictive Analytics Dashboard

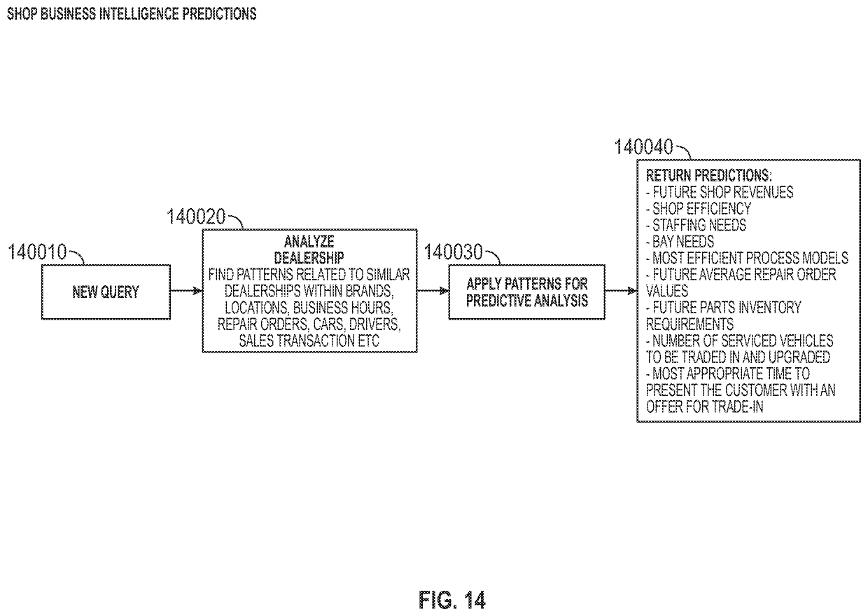

FIG. 14 below is a schematic that indicates the process flow for business intelligence gathering and reporting. For each vehicle manufacturer, distributor, and separately each dealership/business, it is necessary to collect a large amount of critical data that involves the business activities of each of these entities. The SC devices and system also utilizes data specifically captured by both hardware and software modules described in more detail below. These modules access data that includes customer emotions, topics of concern, repair orders associated with natural language terms and strength of association when the customer interacts whit the SC. Such data includes, but is not limited to:
shop revenues
average repair order values
parts used for repairs
number of serviced vehicles traded in and upgraded
number of staff members needed for repairs

The business value to reliably forecast the data listed above is immense, as there are no devices or systems currently in place to provide these forecasts with the immediacy, accuracy, and precision that the present disclosure regarding the SC provides. Together with the increasing improvement of artificial intelligence, dynamically driven databases, and computational capabilities, using increased historical data and power of time series analysis, it is now possible to achieve this reliable forecast in the form of the predictor devices and systems (CSPs) as presently disclosed.

In addition, it is important to understand how to proceed when anomalies in the data sets arise. For the SC kiosk, for example, unique data generated from the kiosk along with available data and data sets from other sources is used to provide predictive insights and early alerts for each vehicle or vehicle fleet. These predictive insights can then be transferred to the vehicle dashboards, back to the kiosks, or to other external hardware/software interfaces within virtual and/or real devices as needed to improve customer experience and dealership/vehicle related business revenues. It is possible, for instance, that he revenue of some dealership(s) might increase more rapidly than trends and seasonality “learned” by the models described would suggest. It is necessary and good practice int his case to provide an automatic alarm of such occurrences and search for the possible reason that data anomalies have arisen to be able to correct for these anomalies as needed. Unique data generated by the SC kiosk along with available datasets is used to produce predictive insights and early alerts that are in turn available for us in dashboards, the SC kiosk and other external software and hardware systems that improve the customer's experience and also increases for dealerships and other entities that can utilize the SC.

As alluded to in FIG. 14, data patterns for prediction analytics that are similar to one another can be found using various similarity metrics such as cosine similarity, jaccard distance, KL divergence, etc. These metrics can be applied to a raw data set or derived data sets from data transformations (such as text pre-processing techniques including stemming and numeric data transformations such as log transformation)

More specificity regarding the use of the data and associated algorithms is provided below;

Data Collection and Use

To train the machine learning models it is necessary to collect historical data focused around, but not limited to, all the variables for predictor device (SC) forecasts (including shop revenues, average repair order values, service recommendations, customer behaviors, etc.) for an ever-increasing number of large data subset databases obtained from vehicle dealerships. Moreover, data is stored within databases that includes business hours, location and brand of dealerships that we don't want to forecast (because they're more or less constant) but are predictive of variables of interest and which are useful in providing further capabilities for the SC. Similarity of a test data item compared to trained data items with respect to predictor variables is used to calculate the value of dependent variables for test data items. Patterns that are similar to one another can be found using various similarity metrics such as cosine similarity, jaccard distance, KL divergence etc. These metrics can be applied for raw data and/or or derived data sets derived from data transformation(s) (including text pre-processing techniques e.g. stemming and numeric data transformations and log transformations).

For the present disclosure, it is necessary and possible to model the dealerships as a time series, so that all the variables (those to be forecasted and those predictive of them) are appropriately labeled with the corresponding date (e.g. average repair order value on a certain date such as 13.02.2019).

In the case of the need for anomaly detection, it may be necessary label unexpected, anomalous events (to provide knowledge of the dealership and the time of occurrence of such anomaly) for the purpose of continuous re-evaluation of the prediction models utilized within the SC devices and associated system. Anomaly detection can also be handled as unsupervised machine language (ML) problems with no labels required. For example, the user may want to know the number of vehicles entering a dealership on a daily basis. Without any data received in advance and without fixing any rules before the use of the SC, advanced algorithms can determine whether there will be an unusually large number of vehicles at a dealership on a given day. Such automated anomaly detection can be used to predict future anomalous events at dealerships.

Algorithm(s)

There are traditional methods that can be utilized for time series analysis that allow modeling trends and seasonally for the sequential, time-dependent data as obtained with the SC devices as the data includes moving averages and autocorrelations. Nonetheless, the methodology used includes a modern method that is a type of recurrent neural network: Long-Short Term Memory (a.k.a. LSTM) applied to our predictive algorithms is at least one of the techniques that is utilized in creating the SC.

Recurrent neural networks, a class of machine learning models, are well suited for these modeling sequences. In particular, LSTMs have been shown to be very good at capturing long-term dependencies in such sequential data. LSTM is a system architecture which can build recurrent neural networks that represent a class or statistical algorithms. On such LSTM is a time series LSTM model which sorts through historical data of, in this case a vehicle dealership one day at a time (or week or month, and it is dynamically changeable with time resolution) and the data must contain all the values of all variables (e.g. average repair order value on a given day, number of repair orders).

After some time, the LSTM model portion of the SC “learns” the underlying data patterns and is able to generate the continuation of the sequence with reasonable accuracy. More specifically, the LSTM portion can generate the continuation of a sequence after the present day, and therefore forecast the future values of most if not all business variables of interest.

The Anomaly Detection in Time Series with Lstms

The anomaly detection is performed by measuring how much the actual data differs from the predictive forecast of our LSTM model. If it differs too much, then this is deemed an anomaly and the information saved indicates that an unexpected event occurred at a given time at a given dealership. In some cases, there might be some delay in anomaly detection because we want to examine longer periods of time to avoid the model being mis-lead by noise.

Service Conceirge Predictor (SC) Workflows;

Further embodiments describing multiple process workflows for the SCD are described next.

More concisely, the SCD is a distributed, cloud-based system aimed to enhance customer experience by using artificial intelligence and automated processes in the vehicle servicing process. There are 3 main components (a-c) of the process:
a) A scheduling/appointment booking process which includes in-car voice assistant experience
b) A pre-visit process that includes service reminders and estimates of the equity through an “equity mining” process. For the Equity mining process the CSP: identifies if the customer's vehicle is eligible or suitable for an upgrade based on the value of the vehicle that the customer is currently driving that including finance repayments, current vehicle market value and residual finance value.
c) The actual dealership/business visit process which includes self check-in using (and in some instances) a self-service kiosk device

A more detailed description the basic processes (a-c) including technical diagrams as well as a detailed description of the Artificial Intelligence solutions utilized in the SC system is more concisely provided in steps 1-3 as follows;
1. Service Concierge Understand AI (artificial intelligence) module
2. Service Concierge Recommend AI (artificial intelligence) module
3. Service Concierge Predictor AI (artificial intelligence) module

These three modules are also described in detail below;

An appointment booking that utilizes one or more SC devices and provides verbal and oral communications in connection with a website. The booking can also be accomplished using text based or automated voice phone calls as well as other audio-visual communications systems.
a. The appointment booking that utilizes one or more SC devices includes;
   i. The SC device is placed on a dealer/business website allowing the customer to book an appointment to service their vehicle
   ii. The customer(s) visits a dealer/manufacturer's/distributor's website where they can easily book a service using embedded features on the website
   iii. The customer enters any unique identifier such as mobile phone number/vehicle registration number/VIN etc.
   iv. The SC device assists with finding the customer in a Dealer Management System (DMS) based on the customer's identifier provided
   v. SC responds confirming the identity of the customer
   vi. SC finds vehicles associated with the customer on DMS
   vii. DMS returns a list of vehicles
   viii. SC requests that the customer choose a vehicle which they want to service
   ix. Customer confirms the vehicle
   x. SC requests the customer for the vehicle mileage
   xi. Customer confirms the mileage
   xii. SC asks the customer if they want maintenance performed or if it a concern
   xiii. Customer's decision: Maintenance OR Concern

1. Customer Selects Maintenance
a. SC proposes service packages or items as recommended by manufacturer based on the details such as car mileage, make, model, year, customer's previous purchases etc. SC also allows the customer to select maintenance items, e.g. oil change, tires or full service packages including service plans.
b. Customer confirms their choice
c. SC confirms the approximate cost of this maintenance
d. SC asks the customer if there are any other concerns
e. Decision: Customer selects Yes/No
   i. Yes—Go to concerns
   ii. No—Go to date confirmation

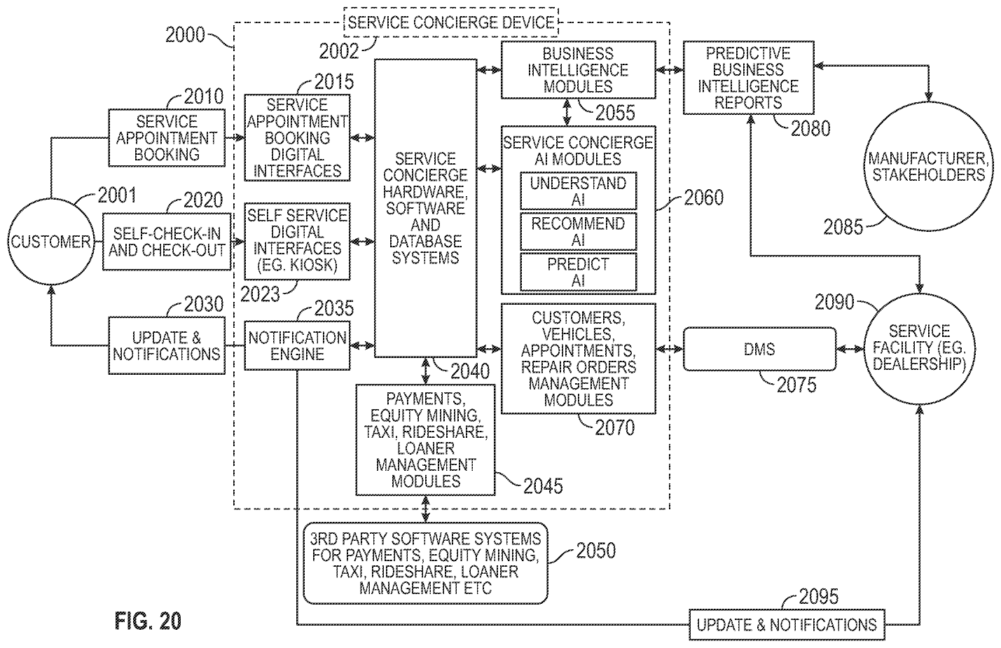

2. Customer Selects Concern
NOTE: In this section we address the use and reference to the SC Understand AI module. In addition, the Service Concierge Understand AI module is described. A schematic indicating how these AI modules interact with the Service Concierge Devices and associated systems is also included in FIG. 20.

a. SC attempts to initially understand the concern

Option 1: In the learning phase of SC's “AI understand” module, SC lists a selection of concern types (2 levels of nesting)
1. Customer selects a concern
2. SC asks the customer predefined questions based on customer's answers (up to 3 levels of nesting)
3. Customer answers the questions
4. SC asks the customer to describe the issue using their own words.
   ii. Option 2: once the AI is sufficiently trained by using increasing data sets
1. SC asks the customer to select the concern type (1 level of nesting)
2. SC asks the customer to describe the issue.
3. Customer describes the issue using their own natural language
4. SC utilizes using SC Understand AI module and attempts to understand the customer's intent and description of the issue.
5. SC if no sufficient information is gathered, asks the customer additional questions.

b. SC gathers information collected from the customer and:
i. Prepares the information package for further analysis, pattern recognition and SC Understand AI input, based on data attributes including
1. Concern selected
2. Questions asked for the customer
3. Customer natural language description
4. Final Repair Order line item—this is the report issued for the service/repair process of the concern in question
ii. SC automatically writes one or more line items in repair order using concern type selected and correlated with relevant operation codes along with customer's statement objective—consisting of the SC's questions and customer's answers, description of the concerns.

c. SC presents the customer with the cost of handling the concern and asks for confirmation.

d. Customer confirms

e. SC asks if there are any other concerns

f. Decision: Customer selects Yes/No
i. Yes—Customer is taken to the beginning of concern identification step
ii. No—Customer is taken to confirming the appointment date as described below
ii. Date confirmation: SC requests that the customer confirm the date and time of the service visit and proposes service schedules
iii. Customer selects one of the proposed service schedules
iv. SC displays/communicates via audio, visual and.or manual electronic format interaction a summary of the customer's scheduled booking
v. SC asks the customer regarding the best communication channel for future communications. This includes essentially all forms of electronic communications including phone, text, email, messenger/notification services which can be provided via one or more electronic hardware devices that possess
vi. Customer confirms and provides the details of the channel
vii. SC remotely creates an appointment object to internal/external database systems that are accessible to systems such as workshop time management software/dealership management system
viii. SC sends the customer a message/notification via their preferred communications channel, with a summary of their appointment, including the booking number, a QR code, calendar specific attachment (such as iCal) and map system (eg. Google maps) link with geo-location of the workshop.

b. Appointment booking through one or more electronic medium including automated voice assistants (Amazon Alexa, Google Assistant, Apple Siri, in-vehicle voice assistant, etc.)
i. Customer invokes the voice assistant (e.g. “Alexa start Service Concierge”/“hey Google I want to service my car”)
ii. Voice assistant service connects to SC utilizing a graphical user interface GUI and public-facing API (applications programming interface) that retrieves and/or sends the customer's mobile phone number (on file with the customer's online Amazon/Google/Apple etc account) or any other chosen identifier (eg. RFID tag of the vehicle, VIN number of the vehicle etc), and finds and retrieves the identity and customer information from all available dealership management systems (DMS) and manufacturer/distributor software systems connected and integrated with SC SC returns customer information to the voice assistant
iii. If the voice assistant doesn't know the customer's identity or is unable to identify the customer via SC SC requests that the customer provide their identity information such as mobile phone number, etc.
iv. Customer provides their unique identifier, such as their mobile number
1. Case 1: voice assistant/SC finds the customer based on their identifier—proceed to Dealership/business selection
a. Case 2: voice assistant/SC does not have customer infoVoice assistant/SC asks the customer to provide their details: Name, Email, Phone number and vehicle details: Make, Model, Year, Mileage
b. Customer provides the details.
c. SC creates a new customer profile.
v. If the customer is known and identified, for this embodiment the Voice assistant asks the customer if they want to service their vehicle in a proposed dealership/business and provides a list of proposed dealerships/facilities or one dealership/facility.
1. Case 1: Customer confirms the dealership/facility selection provided
2. Case 2: Customer rejects the proposed selection or no relevant dealership/facility is found:
a. SC suggests appointments in the nearest dealerships/facilities based on the customer's or cars location.
   vi. SC finds vehicles associated with the customer on a dealership management system (DMS)/database or manufacturer database.
   vii. Dealership management system (DMS) or manufacturer database returns a list of vehicles belonging or managed by the customer
   viii. If there is more than one vehicle returned, voice assistant asks the customer which vehicle is to be serviced (e.g. 2018 Audi A4 or 2016 Audi Q5)
   ix. Customer confirms the vehicle to be serviced.
   x. SC attempts to tries to predict the current mileage of the vehicle, based on the vehicle data attributes, such as; make/model/year/time of last visit and last known mileage and presents it to the customer via voice assistant and asks the customer for confirmation or asks the customer for the current mileage on their vehicle. This information can also be gathered automatically from the vehicle via connected car systems that include dashboard hardware/software GUI interfaces.
xi. Customer confirms the mileage
xii. Voice assistant asks the customer if they want to schedule vehicle maintenance or is concerned that maintenance should be conducted and if so for what item(s) and when

In addition, the SC has the following additional capabilities;
a. SC may ask the customer to state the nature of the concern
b. Voice assistant requests that the customer describe the issue using their own language.
c. SC records the customer's statement
d. SC asks the customer up to 3 follow up questions trying to better understand the issue.

h. For an additional specific case when the nature of the concern requires that the customer may request roadside assistance:
i. If the customer's vehicle is immobile or in any case when the Understand AI will conclude that the customer may require roadside assistance, SC via voice assistant, may ask the customer if they require roadside assistance.
ii. If the customer confirms, SC asks the customer to confirm the vehicle location.
iii. SC communicates the customer's request to the roadside assistance provider via the roadside assistance service API which accepts data with the following parameters:
   1. Customer name and phone number
   2. Vehicle make/model/year
   3. Concern information gathered so far
   4. Vehicle location
   b. Voice assistant communicates to the customer the diagnostic fee amount and asks for confirmation.
   c. Customer confirms
   d. Voice assistant asks the customer to confirm the date and time of the visit (see appointment booking via web widget for details)
   e. Customer confirms date and time
   f Voice assistant sends the date and time to Concierge API
   g. The SC API returns a summary of the customer's booking to voice assistant service
   h. Voice assistant reads the extent of the order to the customer and asks for confirmation
   i. Customer confirms
   j. Voice assistant asks the customer if the mobile phone number or any other communications channel of customer's choice number on file would be best to send further updates and notifications
   k. Customer confirms or may provide details of a different communications channel
   l. SC automatically creates an appointment object on DMS via DMS API
   m. SC sends the customer a confirmation message on the preferred communication channel, with a summary of the appointment, including the booking number, with a digital calendar object attachment and workshop geolocation details as well as an QR code representation image of the appointment details (e.g. date, time, appointments number).

2. Customer selects service:
a. SC based on the car mileage requests service package as recommended by manufacturer or allows customer to select maintenance items, eg. oil changes, tires, engine/emissions updates, etc.
   n. Voice assistant asks the customer to select the package
   o. Customer confirms their choice
   p. SC/voice assistant confirms the approximate cost of this maintenance
   q. Voice assistant asks the customer if there are any other concerns
   r. Customer selects Yes/No
   s. Decision: Customer selects Yes/No
i. Yes—Go to concerns
ii. No—Go to date confirmation

After the booking, before the customer's arrival to the dealership/vehicle associated business (no Valet option selected)
a. Concierge sends the customer a reminder message utilizing their preferred communications channel, in advance of the appointment date. Typically, these reminder messages are sent 24 hours before the appointment.
b. Subsequently, Concierge sends the customer a message if they would like their vehicle appraised
   i. This message will be sent right after the appointment reminder message. If the appointment date is sooner than in 24 h, this message should be sent right after the confirmation date.
   ii. The message should be sent only, if certain equity mining conditions are met—based on the dealership/brand preference settings:
1. Vehicle must not be older than the age specified in the dealership preference settings
2. Vehicle must not have a mileage higher than the amount specified in the dealership preference settings
3. Vehicle equity must be as specified in the dealership preference settings
   iii. Customer responds Yes/No
   iv. If the customer responded with Yes—concierge sends the customer a text message “Thank you, I have arranged a meeting with used cars manager. They will meet you at the reception upon your arrival”.
c. Concierge notifies the used cars sales manager in the dealership by email of the appointment created, including iCal attachment, customer's name, vehicle year, make and model and VIN number (if known it by that time).

2. At Dealership/Business Facility; Check-In Upon Customer's Arrival to the Workshop

(SC Kiosk with Peripherals and Customer Communication)
a. Vehicle recognition and check-in preparation
   i. Customer arrives at the dealership and drives into service bay
   ii. A camera mounted at the entrance to the service bay scans the vehicle's number plate
   iii. SC system retrieves the number plates and using OCR/processes them.
   iv. SC finds the vehicle plate number in the DMS
   v. If the plate number corresponds to a vehicle already known it is possible to find with the DMS and DMS/SP appointments. The SPV displays this information on a kiosk screen in a form of a list of vehicles currently under service/repair including:
1. Customer's name
2. Customer's vehicle: year, make, model.
   vi. SPV looks up recall information should there be any recall due for the vehicle.
   vii. The same information is also displayed on the monitor (screens) in the drive with a note—“Please check in at the kiosk”

Customer Check-In

The customer check-in process upon customer's arrival to the dealership/workshop is performed utilizing either SC Kiosk device which in at least one embodiment is a self-service kiosk with at least one digital user interface (for example with a large touch screen display, digital payment, digital printing, audio, video and sensors), or customer's mobile device application and/or a vehicle's built-in digital systems.

The customer's interaction is enabled by the SC, for example, with a kiosk graphical interface with audio communications capabilities such that each element of the conversation between the customer and the SC is loaded onto the screen upon the completion of the previous step. Customers can use any digital channel for communication with the SC for example, through voice (speech recognition) input or touchscreen/keyboard entry. The SC responds to the customer through kiosk on-screen display, notifications, messages and voice and utilizing various forms of hardware including smart phones, laptops, in-vehicle dashboards with GUIs, etc.

The most recent text-to-speech and speech-to-text algorithms are implemented in the SC thereby enabling the customer to interact with SC with natural language.

One embodiment of a workflow that employs the kiosk together with the SC is as follows:
vii. Customer approaches the SC kiosk
   1. The SC has the ability to identify vehicles entering the service drive scan eg. by scanning vehicle number plates, RFID sensors, NFC etc. If vehicle identification is successfully accomplished, the identity of the vehicle is used for retrieving the appropriate booking details.
   2. If SC returns a valid customer's booking—their original booking is displayed on a list on the SC terminal screen and can be highlighted as needed.
   3. If vehicle identification is not accomplished, the customer can use other digital channels to retrieve their booking details, for example they can scan their booking confirmation QR code or enter a booking number to retrieve their booking.
   4. If the customer doesn't have a booking (e.g. a drive-in scenario)—a temporary appointment object is automatically created for both the SC and the DMS, upon the customer's check-in process. The temporary appointment object consists of customer and vehicle details, date, time and appointment ID.
      viii. Customer confirms their identity and vehicle by interacting with SC, e.g, by confirming their name and vehicle, or mobile number on the kiosk screen.
      ix. SC devices presents to the customer (e.g. displays on the kiosk screen) the customer's appointment information—a summary of the items provided by the customer at the time of booking an appointment or returned from the temporary appointment object.
      x. Customer confirms the appointment details.
      xi. If there is at least one concern type, listed on the appointment summary, and the customer did not explain the concern in sufficient detail at the time of appointment booking, or the Concierge Understand AI module could not interpret the concern types at the time of appointment booking, SC asks the customer to explain the concern using their natural language, if customer had not used natural language to explain the concern during an initial attempt for appointment booking.
      xii. SC here is based either on manual selection of the concern type, or automated natural language processing, utilizing the Concierge Understand AI module that will derive concern type and then ask the customer follow up questions trying to better understand the concern and derive meaningful symptoms from the appropriate database(s). SC will ask these questions by accessing data from data at rest in databases or data on the move that is being sent via transceivers utilizing digital channels such as voice based/text based/touch screen based input and associated output.
      xiii. Symptoms data derived from this conversation will be subsequently matched with the actual cases/service operations.
      xiv. SC records the customer's statement (a summary of customer's natural language input and questions and answers subsequently given) for future use for creating a repair order document.
      xv. The SC communicates that further investigation will be performed by service technician
      xvi. The customer may provide additional comments.
      xvii. The SC Recommend AI module, based on analysis of historical data will recommend items/additional services. Examples of historical data includes the following;
   1. Historical data for current customer (past repair orders), including customer's previous purchase habits
   2. Information on current process (questions and answers from decision tree processes)
   3. Information regarding user purchased product in the past (or not)
   4. Vehicle year/make/model
   5. Previous vehicle service history
   6. Similar vehicles historical repair orders information
   7. Time of year
   8. Weather
   9. Dealer preference settings e.g. mandatory upsell items
   10. Mindset of the customer including mood at time of service request
      xviii. These recommendations can utilize various approaches in machine learning (ML) to recommend additional services (including service name, additional time required to perform the operation and their cost) or items. Approaches include those that heavily use the textual and numeric data to find similarities with current customer(s) with other customers who have made prior purchases. Content agnostic algorithms can also be used. Supervised machine learning approaches can yield more optimal results.
      xix. The customer makes a decision to add any of the recommendations to their order which would modify the appointment objective and subsequently populate and/or repopulate the repair order.
      xx. Based on the vehicles identification, SC retrieves the recall campaign information data from 3rd party (external) databases including manufacturer recall catalogued data.
      xxi. If there is an active recall campaign for the vehicle—SC communicates this fact to the customer and allows for a decision to add the recall operation to the order, which can be offered at no cost.
      xxii. The SC displays a summary of the order with a list of selected services, their cost including tax and total approximate time to execute repairs or maintenance.
      xxiii. SC asks the customer for legal approve of the process, using various digital channels, such as but not limited to signing the order electronically on the screen.
      xxiv. SC asks the customer to confirm their preferred communications protocol for receiving further notifications and sending a digital copy of their repair order.
      xxv. SC may ask the customer to make a payment or pre-authorization of the payment through any digital or physical payment methods or devices including card payment, e-wallet payment, QR code scan based payment, RFID payment, digital currency, etc. Physical payment may include actual use of physical currency into the machine.
      xxvi. SC may acknowledge the state of the transaction by physical (e.g. printing a receipt) or digital (e.g. sending a digital copy of the receipt by a Short Message Service (SMS) that normally available on cellular telephone networks
      xxvii. Depending on the expected service time, SC may offer the customer with the options for the alternative transportation, such as, for example:
   1. Loaner vehicle
   2. Shuttle service
   3. Taxi or rideshare services
      xxviii. SC provides the customer, based on their transportation selection, the ability and facilities sufficient for the customer to receive their choice. These options are shown as options via channels such as KIOSK, messages, mobile phones, messenger services etc and customer feedback is received via the same channel used by the customer. For example, the following options are presented to the customer:
   1. Automated loaner vehicle dispatch process
   2. Rideshare or taxi services ordering process
      xxix. SC communicates to the customer the next steps regarding the repair or service and informs the customer that they will be updated on the process via their selected communication channel.

Service Updates, Final Payment and Vehicle Return
xxx. Concierge notifies the customer of the progress with the repair by text.
1. Notification once the vehicle entered the shop including expected repair completion time.
2. Notification once the vehicle is being washed and prepared for collection.
3. Notification once the vehicle is ready for collection
   a. A summary of the final bill including itemized services, parts and labor and the total amount for the service which at this point will be charged to the customer's card on file.
xxxi. The final payment is charged to the customer's payment method.
xxxii. Customer receives an electronic summary of their bill by text.

### DETAILED DESCRIPTION OF THE FIGURES WITH WORKING EMBODIMENTS

In addition to the descriptions given above regarding the functionality of the SC devices and associated systems, working examples are provided and described with figures that represent primarily one or more flow paths and processes required for one or more embodiments of the present disclosure.

For purposes of this disclosure, frontend refers to a channel with a user interface such as a kiosk with a touch-screen including computational (software) capabilities of data communications channels required for full functionality.

Service concierge customers/consumers interact with SC devices via such frontends. Backend refers to data storage systems and associated software hosted by SC devices (and assorted AI modules) that can read, write and manipulate datasets. Publish-Subscribe, refers to a message queue paradigm in software-based computation whereby senders of information (publishers), send data to an abstract class of recipients (subscribers), without specifying individual recipients. Action Cable mentioned in the Figures refers to this Publish-Subscribe approach for communication between the server or the backend and many clients or many user interaction sessions in the front end. API refers to one or more application program interfaces which are software interface(s) for communication between at least two software objects in a computer memory. DMS refers to one or more dealership management systems that includes data storage systems and associated software. A channel is a software object that represents a user interaction session on a website or kiosk etc. A vehicle set is a unique combination of make, model, and manufacturing year of a vehicle. UI refers to a user interface which denotes a hardware or software device with which a human user can interact via communication media (including analogue, digital, optical signals that transmit data via a keyboard, digital voice assistant, smart phone or other computing appliances. VIN refers to vehicle identification number and is used for uniquely identifying vehicles. UAI module refers to Understand Artificial Intelligence module that can be hosted on SC devices.

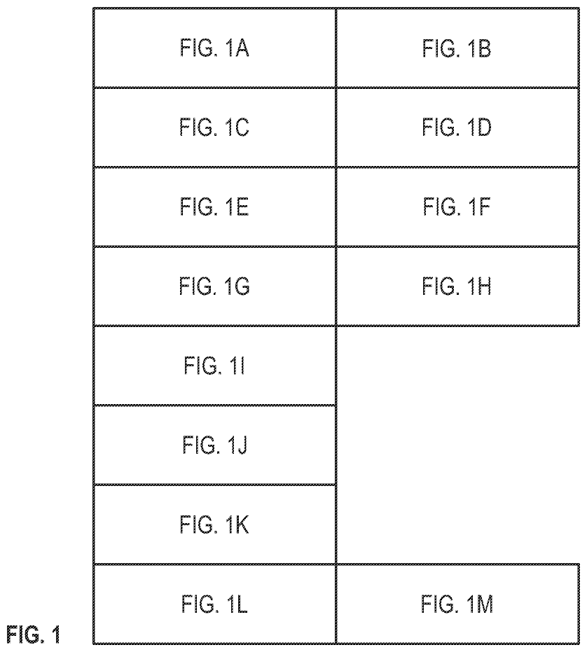

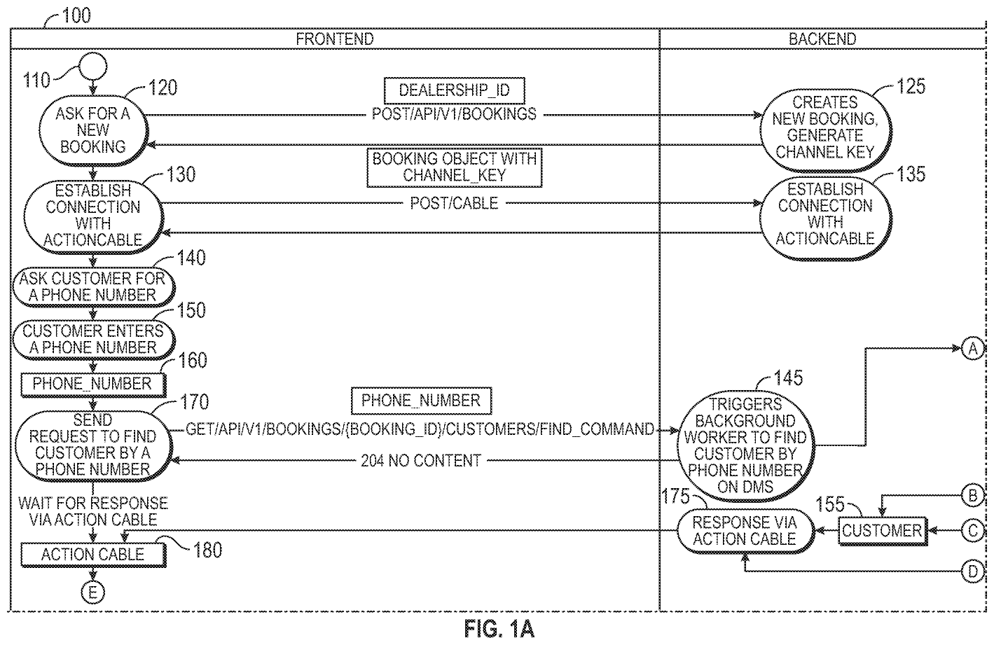

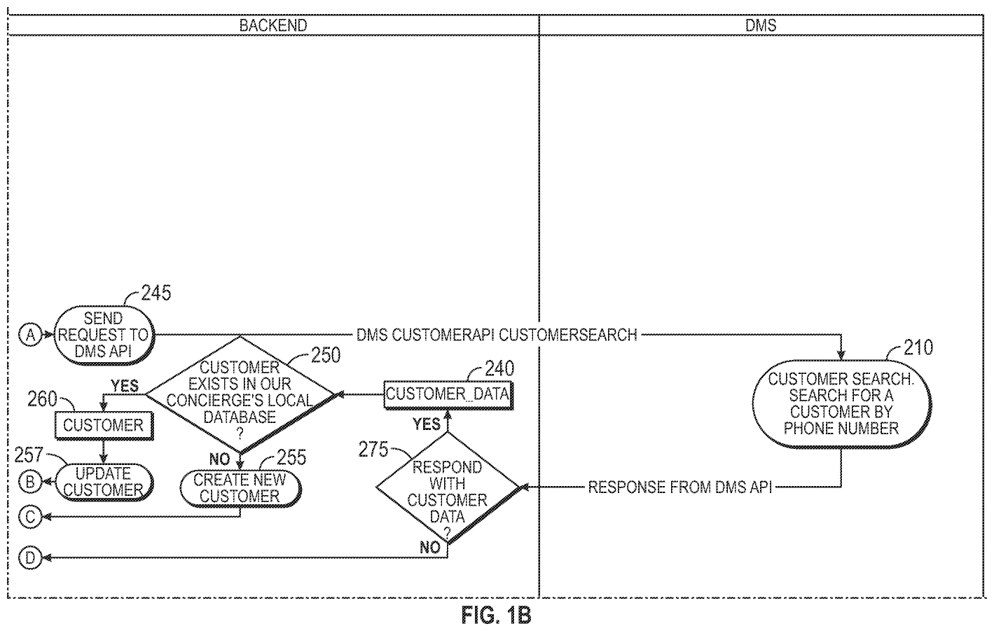

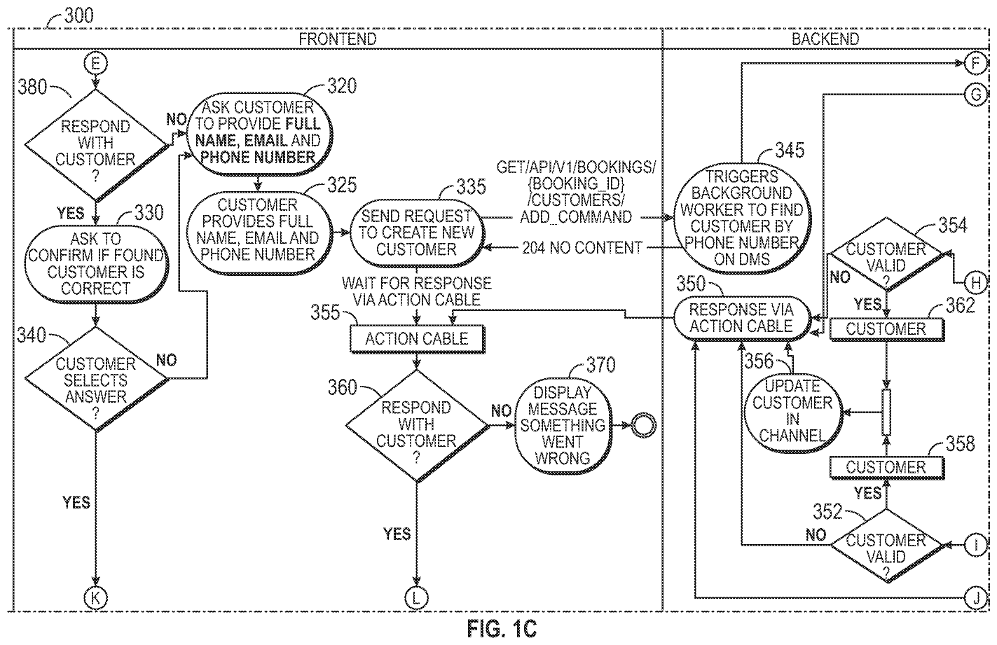

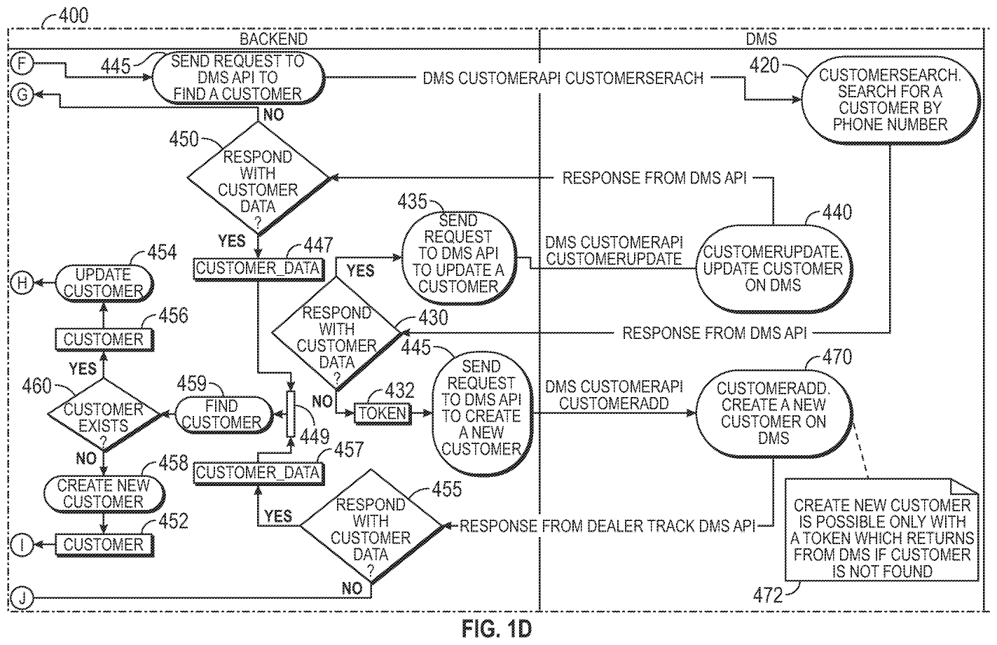

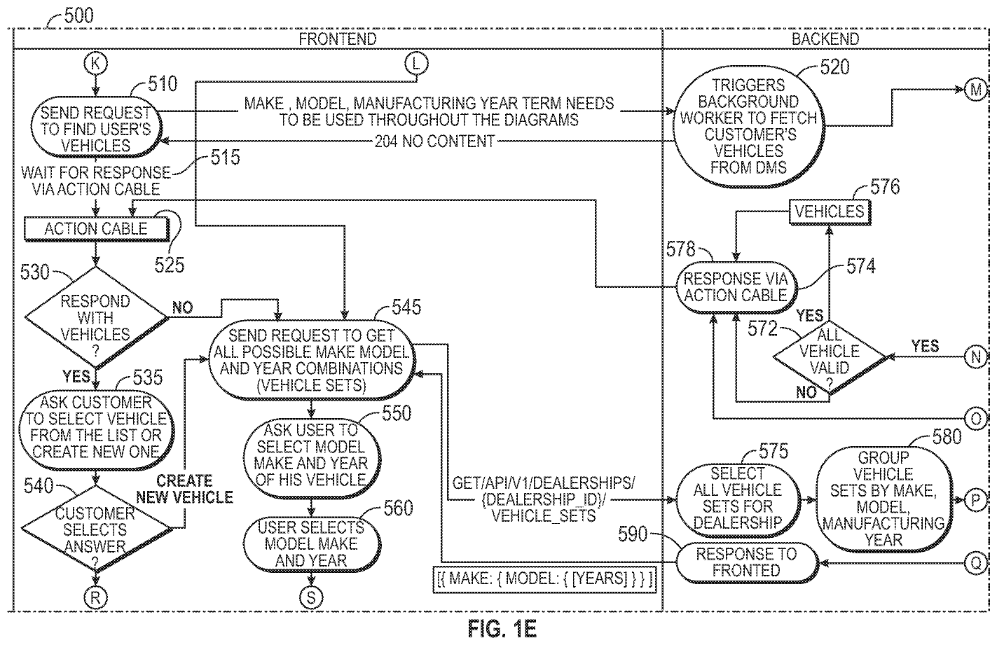

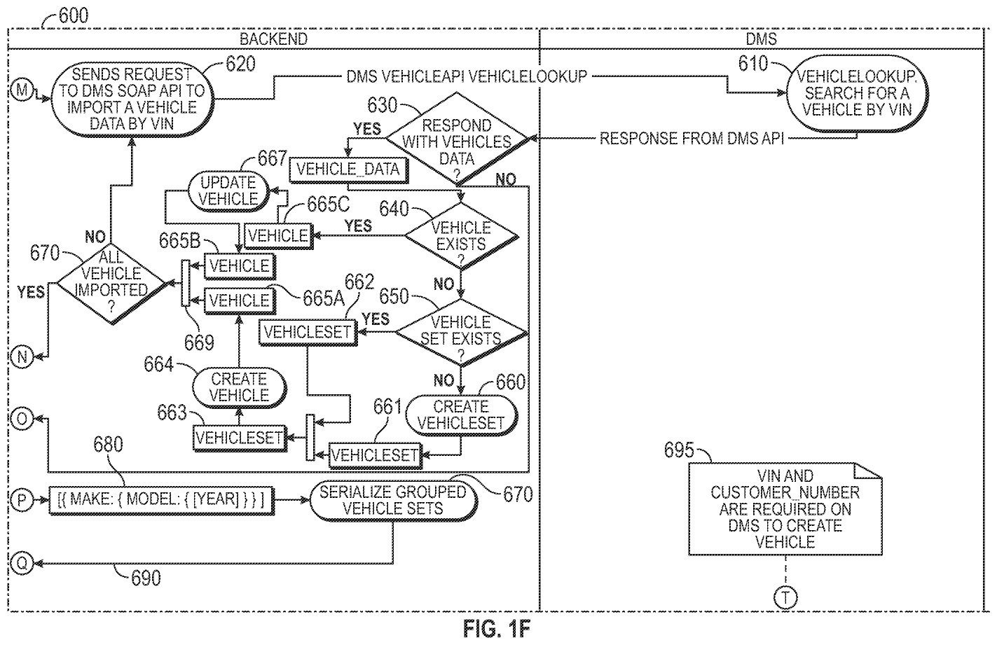

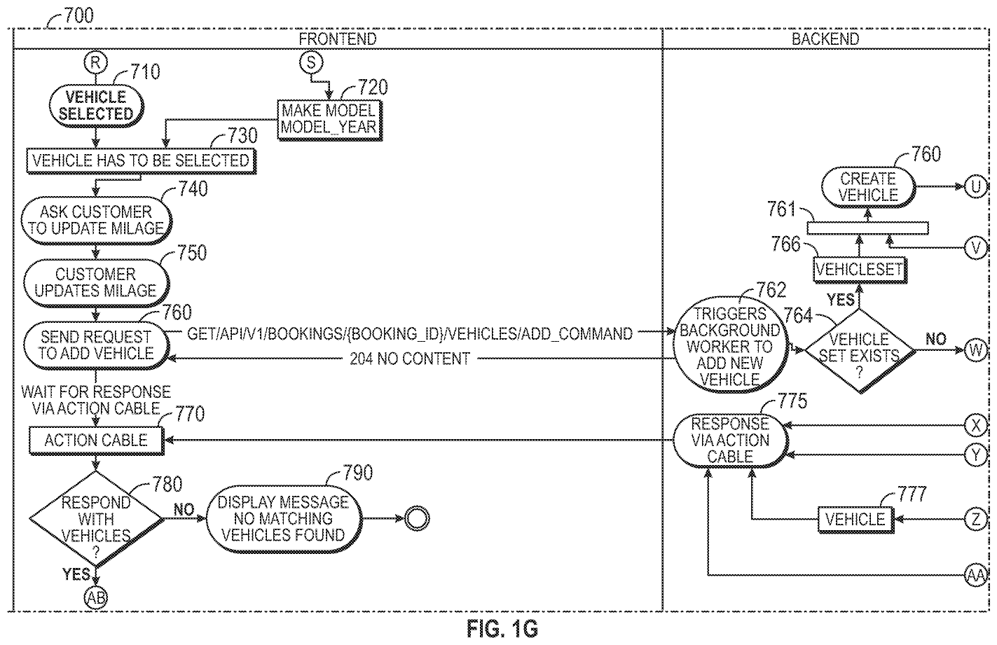

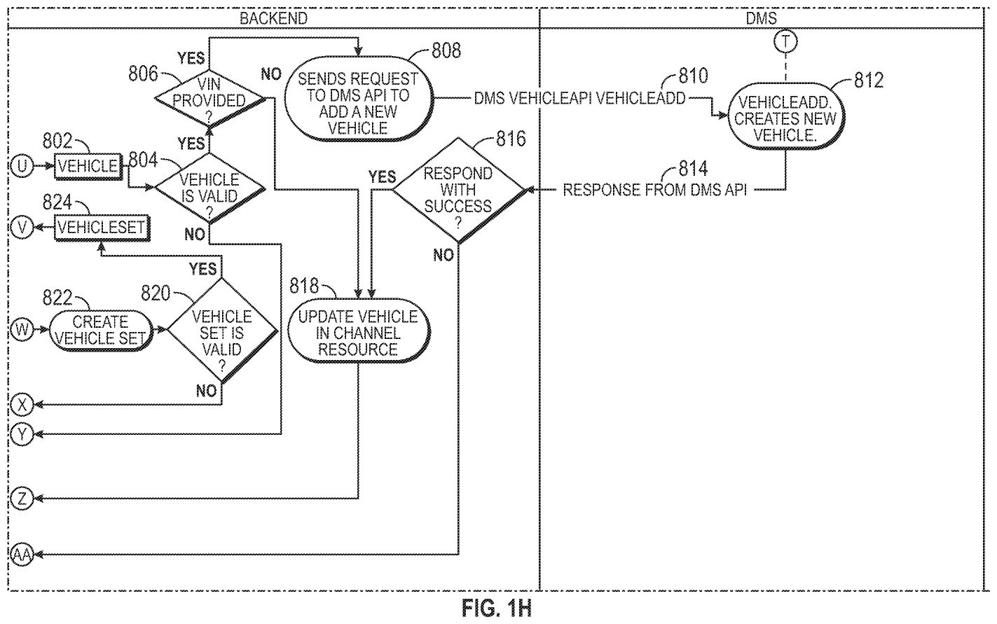

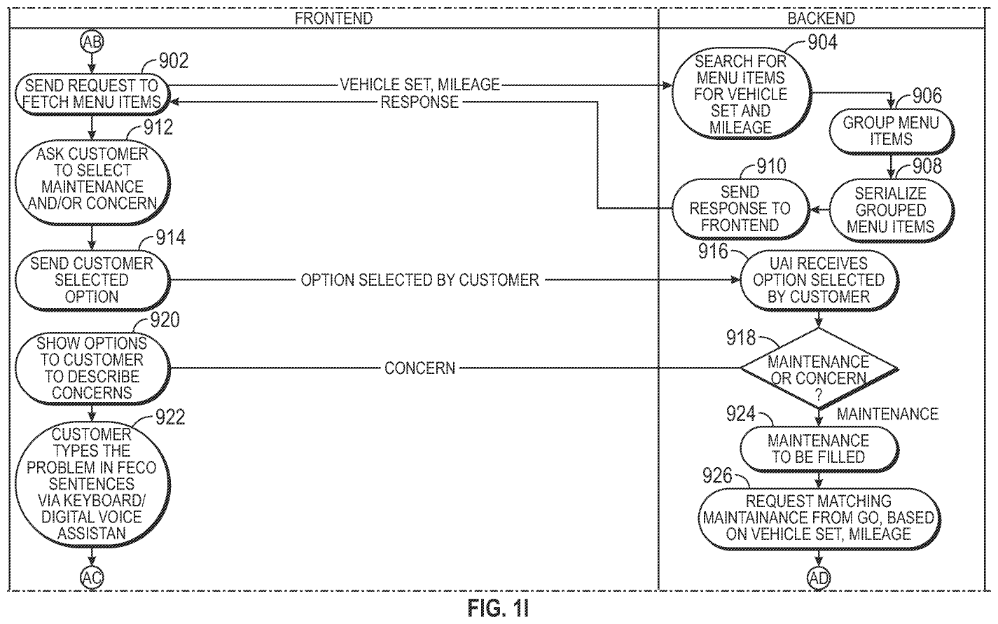

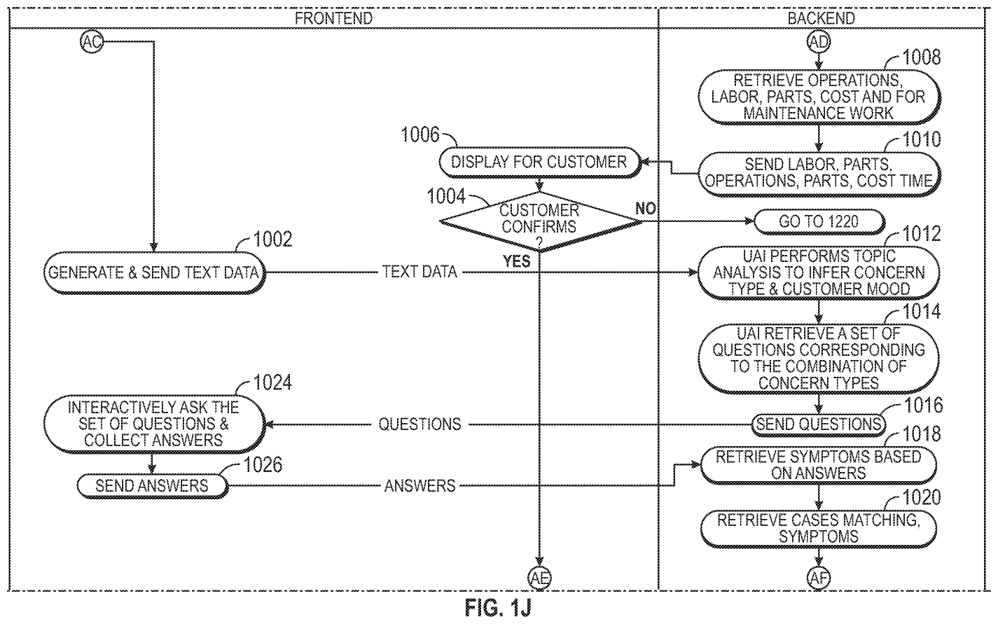

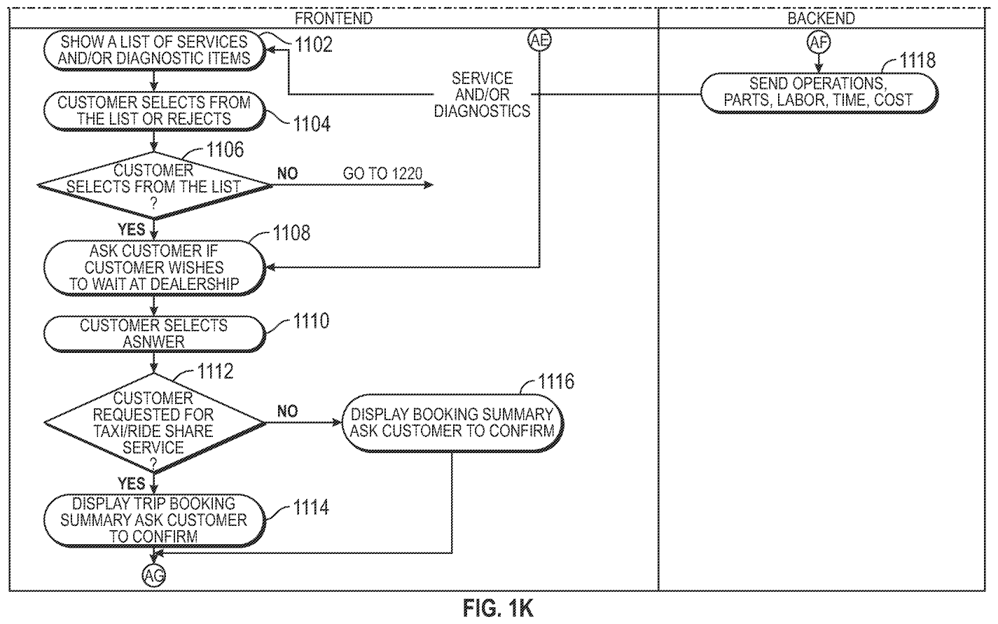

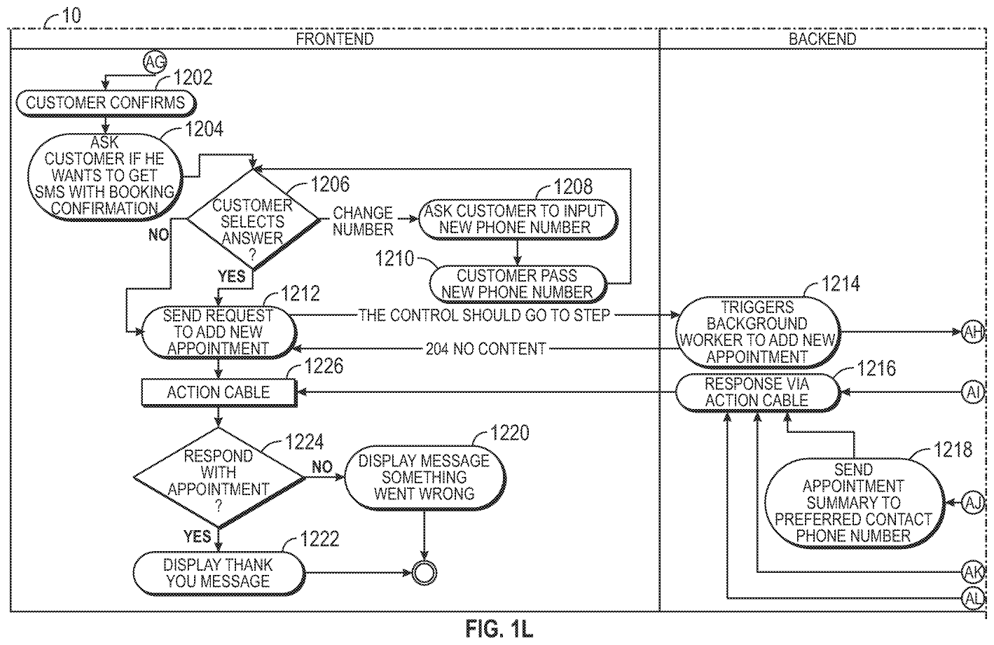

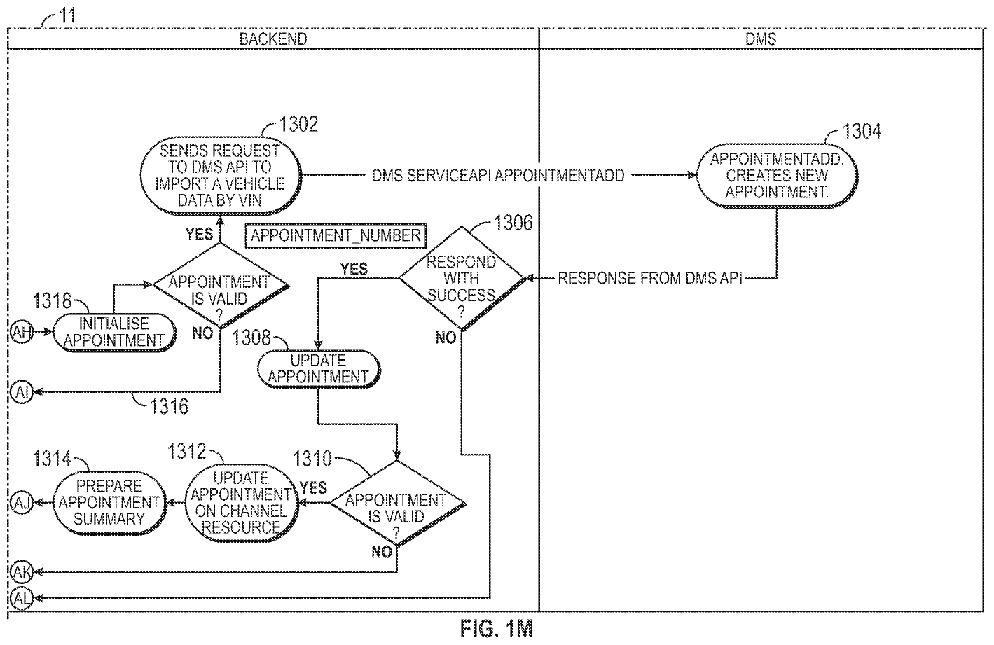

Specifically, for FIGS. 1A-1M, the following flow process is as follows;

FIGS. 1A-1M Working Example(s) and Embodiments that Utilize the SCD

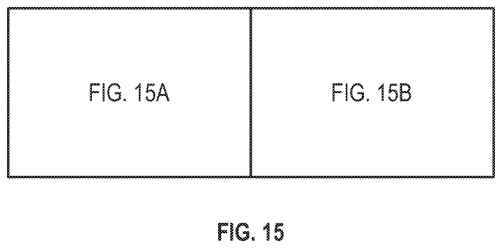

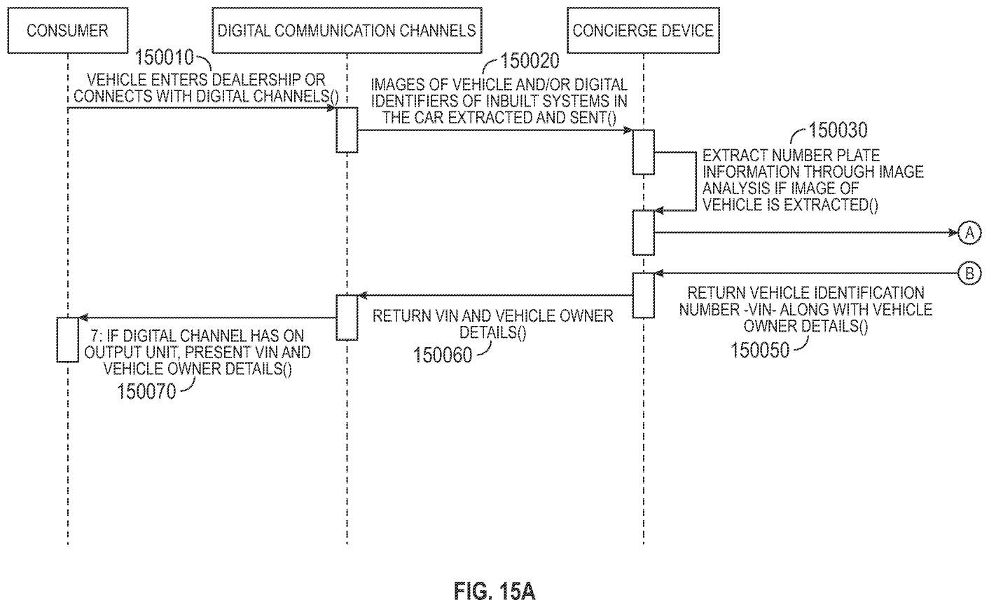

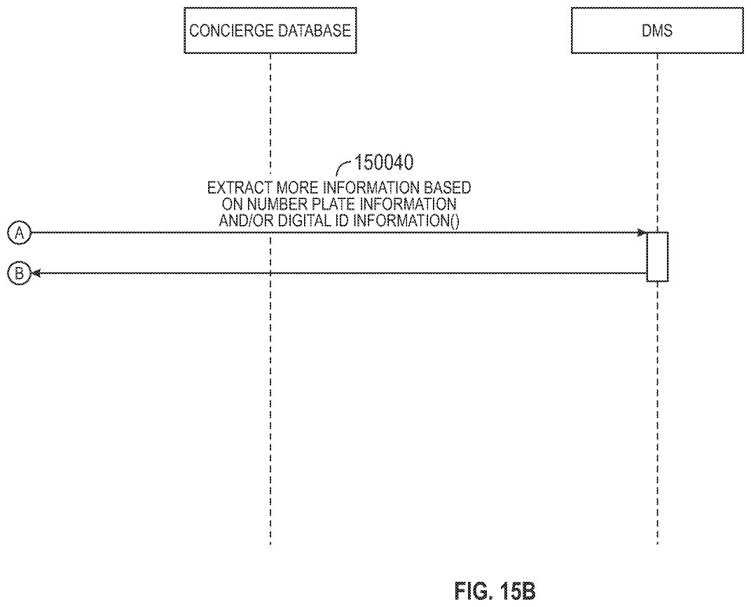

For FIG. 1 A, (100), A customer requests a new booking via the touchscreen interface of Kiosk software (110). This creates a user interaction session which is a software object in the computer memory of the kiosk (see FIG. 15). Here, the software process (120) within the kiosk initiates a request for creating a new booking on the Concierge Service (CS) device(s) for service/maintenance of a vehicle. The process (120) also allows for sending the dealership ID associated with servicing the vehicle to the SCP

The Service Concierge device (SCP) (125) creates a new booking and generates a key for identifying the channel responsible for customer's interaction with the kiosk. It sends an object corresponding to the new booking along with a channel key.

The software process (130) triggered at Step 120 in the kiosk establishes a connection with the action cable responsible for handling the communication between kiosk software and the SCD.

A software process (135) in the SCP receives the action cable connection request and sends back connection details to the software process in the kiosk. Another software process (140) triggered at Step 120 in the kiosk provides a screen which requests a phone number of a customer. The customer enters the phone number (150) by either typing in on the keyboard available on the screen of the kiosk or via digital voice assistant available on the kiosk.

A software object (160) to hold the phone number is created in the physical memory of kiosk by the software process triggered at Step 120.

Another software process in the kiosk (170) sends a request to the SCD to search a customer by phone number. Such a request can be sent via an API. It then starts waiting for response on the Action Cable connection established at 130.

The SCP triggers a software process (145) to find the customer by phone number.

For FIG. 1B, the software process created at Step 145 in FIG. 1A sends a request to DMS (245) via a DMS customer search API exposed by DMS.

The DMS performs a customer search operation (210) on the DMS database and sends a response with the result from the search operation. The software process created at Step 145 checks whether response from the DMS API (275) has customer data. If response from DMS API does not have customer data, an error message is shared as response on the action cable shown at Step (175). If customer data exists at step 275, a software object (240) corresponding to the customer data found is created. The SCP's local database (250) is searched for the customer record corresponding to the customer data object created at Step (240).

If Concierge's local database does not contain customer record corresponding to the customer data object created at Step 240, a new customer record (255) is created in Concierge's local database. If a customer record corresponding to customer data object created at Step 240 is found in SCD's local database, a check is made (260) to ensure that all the data fields in customer record and customer data objects match. If they don't match, a customer data object which is copy of customer data object created at Step 240 is generated. Otherwise, customer data object with attribute values from customer record is created. Customer record in SCD's local database is updated (257) with customer data object created at Step 260.

As in FIG. 1A (155) the customer data object generated at either Step 255 or Step 257 is copied.

A Response received from Steps 155 as customer object (175) and 275 as an error message is exposed to an action cable available at Kiosk. Since this action cable has established a connection with the action cable in the Kiosk, response is shared with the action cable in kiosk the as shown.

An action cable software object (180) receives the response from SCD.

For FIG. 1C a check is made by a software process at Kiosk (380) to determine whether customer data object is received as at step 180 shown in FIG. 1A.

If customer data object is not found at Step 180, a screen is shown on kiosk requesting a customer to provide full name and phone number (320).

A customer enters full name and phone number on the touch screen of the kiosk (325). If customer data object is found at Step 180, a screen prefilled with the customer data is shown asking the customer to confirm whether customer data found is correct (330). If the user selects an answer indicating a negative response (340), software control is passed to Step 320.

A software process in the kiosk stores the data input by a customer in the physical memory of kiosk (335) and sends a request to SCD to add a new customer. This is done by connecting with SCD via an API. The software process waits for messages on action cable established at Step 130 as shown in FIG. 1A.

The SCP triggers a software process to search a customer by phone number (345). The details received from the API initiated at Step 335 are used for this request.

For FIG. 1D, the Software process created at Step 345 initiates a request to DMS API to search for the customer by phone number (445). DMS Customer Search API utilized and exposed with the SCD is used for this.

The customer record is searched by DMS by using phone number as identifier of customer record and sends a response to Concierge software process (420) triggered at Step 345. in addition, the software process triggered at Step 345 checks whether response data from DMS API contains customer data (430). The software process triggered at Step 345 sends a request to DMS to update the customer record with new data (435) entered by customer at Step 325. Here, the DMS updates the customer record with information received in customer update request (440) initiated at Step 435 and sends a response back to the SCD regarding the result of customer update operations.

The Software process triggered at Step 345 checks whether the response from DMS after performing customer update at Step 440 indicates a successful customer update operation (450). If the check for successful customer update operation at Step 450 is positive, software process triggered at Step 345 creates a customer data object in Concierge's physical memory (447). A token software object is created (432) if check for customer data in the response is negative at Step 430. The software process triggered at Step 345 initiates a request to DMS to create a new customer record at DMS (445). This request is sent by Concierge via an API. The DMS creates a customer record in a database hosted by DMS (470) and sends a response back to Concierge. The software process triggered at Step 345 checks whether response from DMS API from Step 470 indicates a success and has customer data (455). If the check for the presence of customer data in response received at Step 455 indicates a success, software process triggered at Step 345 creates a software object which holds customer data (457). If the customer data object created at either Step 447 or at Step 457 is passed to a software interface (449) is invoked. If the the software interface activated at Step 449 initiates the search for customer record at SCD's local database (459) is invoked. The software process triggered at Step 345 checks whether search for customer data in the local database is successful (460). If search for customer data indicates the presence of matching customer record at Step 460, a customer data object is created in SCD's physical memory (456) by the software process triggered at Step 345. A request is made to the SCD's local database by software process triggered at Step 345 to update a customer record that matches customer data object (454) created at Step 456. If the search for customer data at Step 460 shows that customer record does not exist in local database at SCD a new customer record is created (458) as the SCD's local database. Once software control finishes executing Step 458, software process triggered at Step 345 creates a customer data object (452). The steps shown in FIGS. 1C and 1D indicate that (352) is a customer data object created at Step 452 that is checked for its validity. (354) is a customer data object created at Step 454 that is checked for its validity. If customer data object is found to be valid at Step 352, a customer data object is created which (358) that can be used for updating data in a data channel.

If customer data object is found to be valid at Step 354, a customer data object is created (362) which can be used for updating data in a data channel.

The customer data objects created at either Step 358 or Step 362 is used to update a data channel in the SCP (356) An update on the data channel at Step 356 results in a response being shared on an action cable that is connected with the software system in kiosk (350). Otherwise, a failure and corresponding error messages at Step 450 or Step 455 are shared as response on the action cable.

An action cable on the kiosk receives a response from the action cable in the SCD (355). The software process mentioned at Step at 335, which is responsible for customer data checks whether action cable received valid customer data object in the response from action cable at the SCD (360). If the check for valid customer data at Step 360 shows that no valid customer data is received, kiosk displays an error message (370) indicating that some hardware/software failure occurred and requests the customer to contact service adviser.

For FIG. 1E, if a valid customer data is retrieved at Step 360, the software process triggered at Step 120 sends a request to find vehicles owned by the customer (510). It sends such a request to the SCD via an API. It waits for response from the SCD via an action cable. The SCD triggers a software process to fetch customer's vehicles from DMS (520).

For FIG. 1F, the software process triggered at Step 520 retrieves vehicle identification number (VIN) from the SCD's local database and requests DMS to retrieve vehicle data corresponding to the VIN (620). The DMS searches for vehicle by VIN and returns a response to the SCD (610). The software process triggered at Step 520 as in FIG. 1E, checks whether DMS returned a response with vehicle data (630). If the vehicle data is found to be present in the response checked at Step 630, the software process triggered at Step 520 sends a request to the local database at Concierge to see whether a vehicle record exists corresponding to the vehicle data (640). If a vehicle record is found to be present in the local database, a vehicle data object corresponding to vehicle record is created in SCD's physical memory (665C) by the software process triggered at Step 520. If a vehicle record is not found at Step 640, the software process triggered at Step 520 sends a request to the local database at SCD to determine whether a vehicle set exists corresponding to the vehicle data (650). If a vehicle set is found in the query at Step 650, a vehicle set object corresponding to vehicle set is created in SCD's physical memory (662) by the software process triggered at Step 520. If vehicle set is not found in the SCD's local database in Step 650, a vehicle set record is added using vehicle data available (660) from Step 630.

A vehicle set object corresponding to vehicle set is created in SCD's physical memory (661) by the software process triggered at Step 520. A copy of the vehicle set object is created (663) using data from Step 661 or 662.

Vehicle set object available at Step 663 is used to create a vehicle set record in a local database of the SCD (664). For the SCD a vehicle object is created from a vehicle set object (665A) available at Step 664.

A vehicle record matching with vehicle data available at Step 665C is updated in a local database of the SCD (667). A vehicle object is created from vehicle set object available at Step 665C, (665B). In addition, a software interface at the SCD uses vehicle object available at Step 665A or Step 665B that passes control and vehicle object to the software process (669) triggered at Step 520. A check is made by the software process (670) triggered at Step 520 to determine if all vehicles data have been imported into memory. As shown in FIG. 1 E, a check is made (572) by the software process triggered at Step 520 to determine whether all vehicles data imported and checked at Step 670 is valid. If any vehicle data is found to be invalid, a response indicating failure is sent to action cable at the SCD.

If vehicle data is found to be valid at Step 572, a software object containing data of vehicles is created and a response indicating success (576) along with vehicle data is sent to an action cable at the SCD. The response sent at either Step 576 or Step 572 is shared and captured on action cable (578) at the SCD and the same response is passed on to the action cable in front end. Th action cable at the front end (525) receives response from action cable in SCD. The software process triggered at Step 120 receives the response on the action cable it listens to and checks whether response contained vehicle data (530).

If vehicle data is found in Step 530, the software process triggered at Step 120 initiates a request for the UI module on the kiosk to show a screen containing vehicle details. The UI screen shows vehicle details and requests the customer to select a vehicle from the list or create a new vehicle in customer records. The customer selects an option on the UI screen. (540). A software process triggered at Step 120 checks whether the customer chooses to create a new vehicle record. If a customer chooses to create a new vehicle record, a request is sent to the SCD retrieve all possible combinations of make, model and manufacturing year (i.e., vehicle set) of vehicles (545). It receives the result of the query after Step 590 is executed.

A software process at the SCD receives the request sent at Step 545 and retrieves all vehicle sets available for the dealership in question by querying local database available at the SCD (575). The software process triggered at Step 575 groups these vehicle sets by make, model and manufacturing year (580). The software process triggered at Step 575 serializes the grouped vehicle sets (670).

A serialized data set of grouped vehicles (690) is sent to a software process on the SCD. The software process mentioned in Step 690 is responsible for sharing the grouped vehicles data set with Kiosk (590). It shares grouped vehicle data set with kiosk. The software process triggered at Step 120 initiates a request with a UI software module to show a screen to the customer asking for details make, model and manufacturing year of customer's vehicle (550). The customer selects make, model and manufacturing year from options shown on UI screen of the kiosk (560).

For FIG. 1G, if the software process triggered at Step 120 finds that customer chooses to select a vehicle from the list of vehicles shown at Step 535, a software object containing data of vehicle selected by customer is created (710).

If a customer selects make, model and manufacturing year at Step 560, a software object containing data of make, model and manufacturing year is created (720) by software process triggered at Step 120. Next a vehicle has to be selected (730).

The software module triggered at Step 120 initiates a request to show a UI screen on the kiosk asking the customer to update mileage of the vehicle (740). Mileage updated by the customer on UI screen is captured by software module triggered at Step 120. A request to add a vehicle is sent from the software module created at Step 120 to the SCD (760). The SCD triggers a software module to add a new vehicle (762). The software module triggered at Step 762 checks whether vehicle set data exists in Concierge's local database (764)

If Step 764 indicates that a matching vehicle set data exists in the SCD's local database, a software object containing vehicle set is created (766).

For FIG. 1H, if Step 764 in Figure G indicates that no matching vehicle set data exists in the SCD's local database, it creates a vehicle set record in Concierge's local database (822).

The Software module triggered at step 762 checks whether vehicle set created is valid (820). If vehicle set record is found to be valid at Step 820, a software object containing vehicle set data is created by software module (824) triggered at step 762 and shown in Figures G and H. The vehicle set software object created at Step 824 or Step 766 is used by a software interface at the SCD (761) to create a copy of vehicle set software object.

Vehicle set software object created at Step 761 is used to create a vehicle record in SCD's local database by software module (760) triggered at Step 762.

A software object containing vehicle information from vehicle record created at Step 760 is generated by software module (802) triggered at Step 762.

The software module triggered at Step 762 checks whether vehicle object created at step 802 is valid (804). If the vehicle object is found to be valid at Step 804, the software module triggered at Step 762 checks whether a VIN exists in the vehicle object (806). If VIN is found software module (808) is triggered at Step 762 that sends a request to DMS API to add a new vehicle record.

The DMS adds a new vehicle record in its database and sends a response to the SCD (812). The software module triggered at Step 762 checks whether the response from DMS indicates a successful vehicle record creation at DMS (816). If vehicle record creation is found to be successful or VIN is not provided as verified at Step 806, vehicle data (818) is updated on the data channel in the SCD. Once the vehicle data is updated on channel resource at Step 818, a software object of vehicle data is created in the SCD's physical memory (770).

Either an error response from Step 820 or Step 804, or Step 816 is shared on the action cable at the SCD device or success response with vehicle data is shared on the action cable at SCD.

The action cable at the kiosk receives the response from action cable at Service Concierge device (770).

The software process triggered at Step 120 checks whether response on action cable has a response (780) with vehicle data at Step 770.

If Step 780 indicates that response contains an error, an error message is displayed informing the customer that no matching vehicles are found.

If Step 780 indicates that response contains vehicle data, software process triggered at Step 780 sends a request to Concierge to fetch menu items that are relevant for corresponding vehicle set and mileage.

Service Concierge device searches the local database for menu items that match with vehicle set and mileage shared at Step 902. A software process is triggered in Service Concierge device. The software process groups the menu items retrieved at Step 904. The software process triggered at Step 906 serializes grouped menu items to be shared with kiosk for display. Once software control returns back to Step 902 after executing Step 910, a UI screen is displayed on kiosk asking the customer to select maintenance or concern as a vehicle issue faced by customer. At Step 914, the option selected by customer either as maintenance or concern is shared by a kiosk software module with Service Concierge device. UAI software module in Concierge receives option selected by customer at Step 916. A check is made is to see whether the customer opted for a maintenance or has concerns about the vehicle at Step 918. If customer selection indicates concern at Step 918, control returned by Service Concierge device along with concern option is used by kiosk to show options for customer to describe concerns. At Step 922, customer selects one of the options such as keyboard or digital voice assistant etc. and describes the concern in natural language such as English. A software module in the kiosk decodes the data sent through customer interaction at Step 922 and sends the data in textual format to Service Concierge device. At Step 1012, UAI performs topic analysis by applying latent dirichlet allocation (LDA) technique to understand hidden topics or concern types in textual data. UAI performs emotion analysis on textual data based on a thesaurus of emotions mapped with words to infer emotions of the customer. UAI retrieves a set of questions based on concern types and emotions inferred at Step 1012. A software process in Concierge packs these questions in an N-ary tree data structure and sends the data structure to the software process triggered at Step 120 in kiosk. Software process triggered at Step 120 shows a UI screen where the questions present in N-ary data structure are interactively presented to the customer and answers are recorded. Software process triggered at Step 120 sends answers to Service Concierge device. Service Concierge device retrieves a set of symptoms based on answers received at Step 1026 and N-ary tree data structure sent at Step 1016. Service Concierge device retrieves a set of cases that correspond to the symptoms retrieved at Step 1018. Operations and corresponding parts, labor, time and cost of operations is sent to kiosk based on cases retrieved at Step 1020. Software process triggered at Step 120 shows a UI screen that displays a list of services and/or diagnostics based on data received from Step 1118. Customer selects one or more items displayed on the list at Step 1102 or rejects all of them. Software process triggered at Step 120 checks the items selected by customer at Step 1104. If customer rejected all the items shown at Step 1104, software control is passed to Step 1220. Software process triggered at Step 120 shows a UI screen on kiosk. This screen asks a customer whether customer wishes to wait at dealership. Customer enters the option for the question posed at 1108. A check is made by software process triggered at Step 120 to see if customer requested for a taxi or rideshare service at Step 1110. If customer does not select taxi or rideshare option at Step 1110, booking summary is displayed on a UI screen. Customer is asked to confirm booking and control is taken to Step 1202. If customer selects taxi or rideshare option at Step 1110, booking summary along with details of taxi or rideshare service is displayed on a UI screen. Customer is asked to confirm booking and control is taken to Step 1202. Service Concierge device requests the local database to retrieve matching items based on vehicle set and mileage data received at Step 918. Service Concierge device retrieves operations and corresponding parts, labor, cost and time for maintenance work based on data retrieved at Step 926. Service Concierge device sends the data retrieved at Step 1008 to kiosk Software process triggered at Step 120 displays the data retrieved at Step 1010 to the customer for confirmation by customer. A check is made to see whether customer confirms at Step 1006. If customer does not confirm at Step 1004, software control is taken to Step 1220. Otherwise, software control is taken to Step 1108. At Step 1202, a customer confirms booking summary shown to the customer on the screen of kiosk. A screen is shown on kiosk asking whether the customer wants to get a message on customer's phone/email etc. with details of booking confirmation at Step 1204. At Step 1206, a customer selects an option shown at Step 1204. At Step 1212, if customer chooses no option or selects one of the options available namely existing phone number or email, a software process at kiosk sends a request to create a new appointment by sending a booking id to Service Concierge device. At Step 1214, Service Concierge device triggers a software process to add a new appointment. At Step 1162, software process triggered at Step 1214 initializes an appointment object in Concierge's memory. Software process triggered at Step 1214 checks whether appointment object created at Step 1318 is valid. At Step 1302, if appointment object is found to be valid software process triggered at Step 1214 sends a request to DMS to retrieve a vehicle's data by VIN. At Step 1304, DMS creates a new appointment and sends response to Service Concierge device. At Step 1306, software process triggered at Step 1214 checks whether response sent by DMS regarding new appointment creation indicates a success. If Step 1306 indicates a successful appointment creation, matching record is updated in Concierge's local database. This is done at Step 1308. At Step 1310, software process triggered at Step 1214 checks whether appointment object updated at Step 1308 is valid. If appointment object is found to be valid at Step 1310, appointment object is updated on channel. This is accomplished at Step 1312. At Step 1314, once appointment object is updated on the channel, appointment summary is prepared by software process triggered at Step 1214. At Step 1218, software process triggered at Step 1214 sends an appointment summary to phone number from appointment or customer's phone number. At Step 1216, response indicating error is captured on action cable if an error indicated by Step 1316 or Step 1310 or Step 1306 is encountered by software process triggered at Step 1214. If appointment summary was successfully sent at Step 1218, a success response along with appointment summary is captured as response in action cable. At Step 1226, Action cable at kiosk receives the response from action cable in Service Concierge device. At Step 1224, software process triggered at Step 1214 checks whether appointment summary details exist in the response captured by action cable. At Step 1220, if appointment details do not exist when checked at Step 1224, kiosk shows an error message on UI screen indicating something went wrong. At Step 1222, if appointment summary is present when response is checked at Step 1070, a thank you message is displayed along with details of appointment summary.

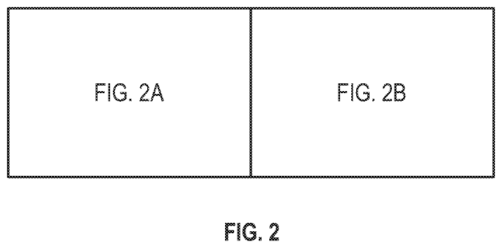

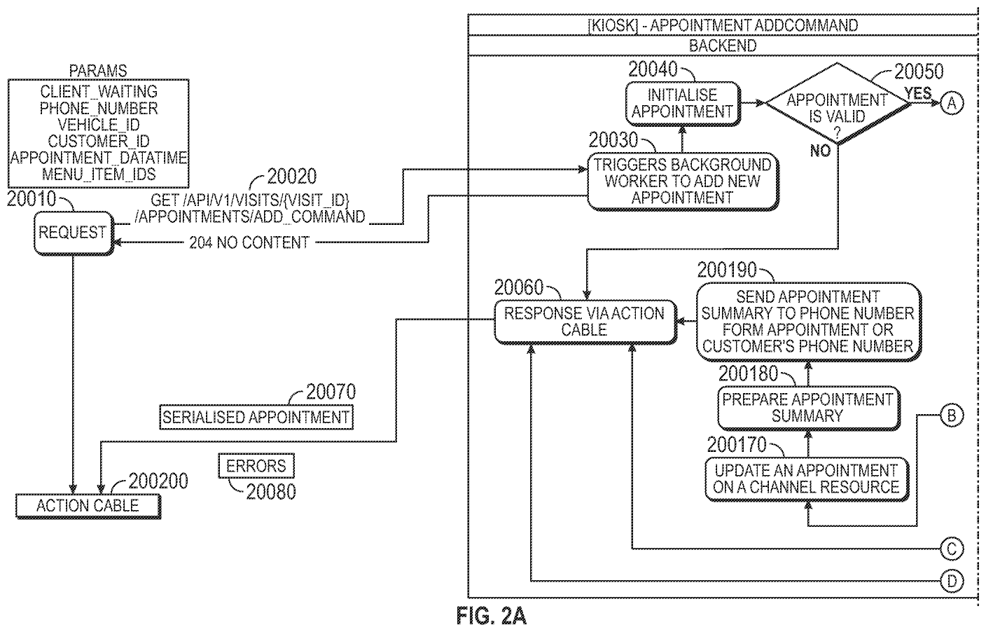

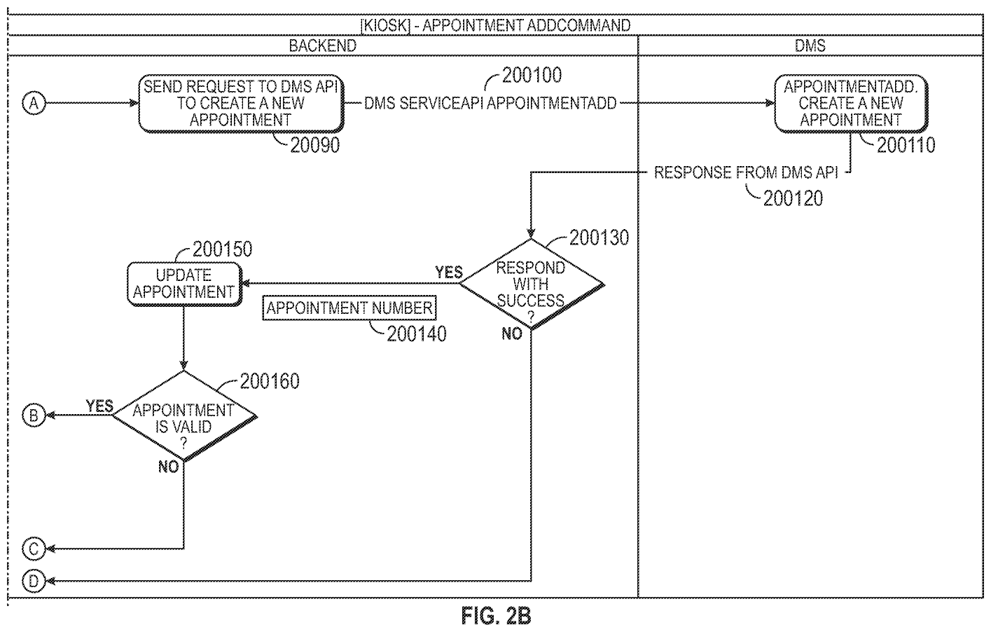

For FIGS. 2A and 2B, the following descriptions are provided with a different numbering system. In the interest of repeating much of what has been described in FIGS. 1A-1M above, FIGS. 2-9 and 13-20 have been numbered using the same numbering system with the verbiage abbreviated so that one can follow the sequence for each separate flow diagram in a logical manner. FIGS. 2-9 and 13-20 represent additional working examples and embodiments describing additional functionality associated with the SC devices and system of the present disclosure

FIGS. 2A and 2B: Customer Initiation Regarding Utilization of SCD
20010: Customer initiates an appointment booking request by interacting with an interface of a website. The customer provides details including customer's phone number, required vehicle information (Vehicle ID which includes vehicle information either precisely defined by vehicle registration number, VIN or widely by make, model and year), preferred date and time for appointment. Each dealership has various options of services available with varying prices. A customer can choose one or more of these services at a dealership. Such a list of available services is available as menu items on user interface such as website. Customer is asked to provide the preference regarding waiting at a dealership during the service.

The website software module creates software objects including phone number, vehicle registration number (if provided), customer ID in its computer memory along with preferences shared by Customer. It creates and establishes a software connection to an action cable mentioned at in block 200200.
20020: It then sends create appointment request via an API to SC along with software objects created above as parameters of the request.
20030: SC then triggers a software process responsible for handling the request to create the appointment.
20040: This software process initialises an appointment object by checking the list of blocked schedules available at Concierge database. This database periodically gets updated by DMS.
20050: Software process checks whether appointment requested by customer is valid by comparing it to a list of available schedules in the appointment object.
20090: If appointment schedule requested by customer is available as verified at step 20050, a request is sent to DMS by the software process to create a new appointment.
200100: DMS service API transfers the request at step 20090 to DMS.
200110: DMS creates an appointment by creating appropriate database entry.
200120: DMS sends response regarding success status of the appointment creation and appointment details if any, back to the software process.
200130: Software process at Concierge receives a success message along with appointment details. It checks whether appointment creation was successful. If appointment creation was not successful, it sends an error response to the action cable. Software process returns an appointment number mentioned in block 200140 to database system at Concierge if DMS appointment creation was inferred to be successful at Step 200130.
200150: Database system writes those details to Concierge database.
200160: A software process at Service Concierge device checks whether appointment object is valid. If appointment object is invalid, an error response is shared on the action cable.
200170: If such appointment object is found to be valid at Step 200160, appointment object is updated on a channel resource
200180: An appointment summary object is prepared by a software process Service Concierge device.
200190: A software process at Service Concierge device sends the appointment summary to phone number of the relevant customer and share this message on the action cable.
20060: This software process checks for responses from software processes at Concierge. It checks whether appointment request made is valid by considering parameter values such as date etc. It checks whether response from DMS regarding appointment creation is successful. It checks whether appointment summary has been successfully created and sent to customer. If these three checks indicate error, it shares an error message mentioned in block 20080 to the action cable. If check for appointment summary object creation and sending is successful, it shares a serialized appointment object mentioned in block 20070.
200200: An action cable responsible for communication between software components is initiated. The error and success messages shared on this are used by website to show appropriate messages to the customer via widget screens.

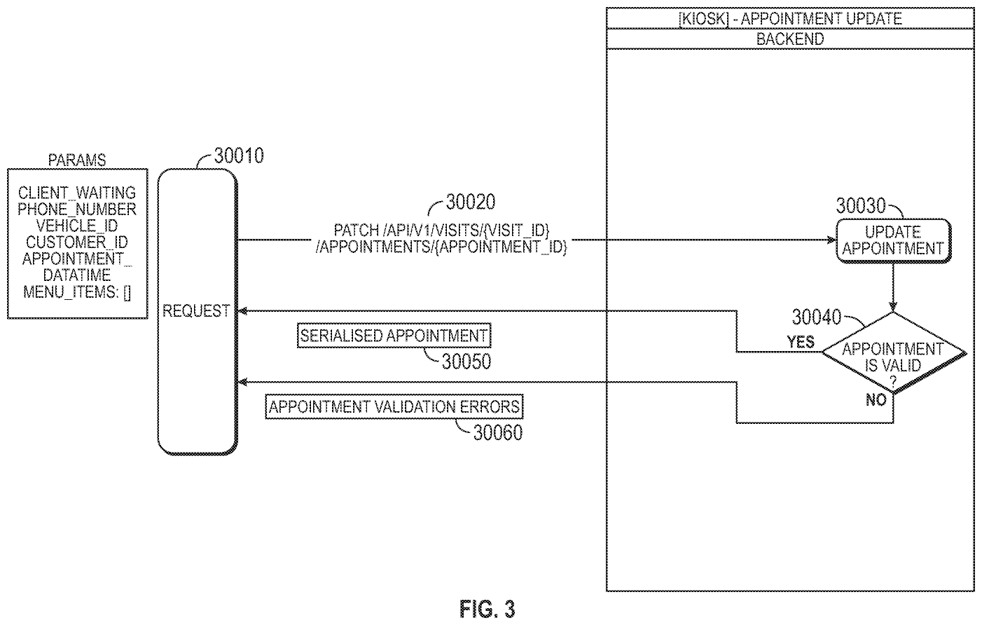

FIG. 3: Initiation of Interaction and Interface between Customer and Kiosk
30010: A customer interacts with UI screen of a kiosk and provides details including a vehicle id, phone number, customer id, appointment date and time of the vehicle's service to request for updating existing appointment for servicing the vehicle. This request is sent to Concierge for validating the appointment update request. Kiosk waits for response from Concierge to show either a successfully updated appointment or an error message.
30020: Service Concierge device receives request for updating the appointment with details mentioned in Step 30010.
30030: Service Concierge device checks whether the request for updating appointment is valid by checking local database.
30040: If request for updating appointment is found to be valid at Step 30030, a serialized appointment object with updated appointment data fields is sent to kiosk.
30050: If request for updating appointment is found to be invalid at Step 30030, an error message is sent to kiosk.

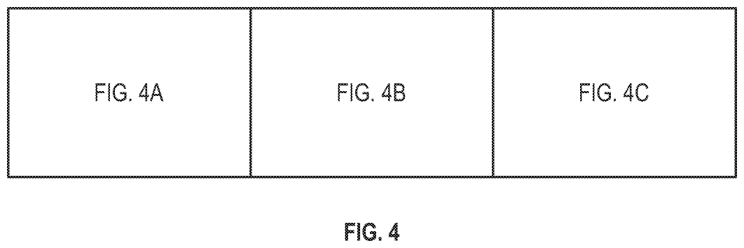

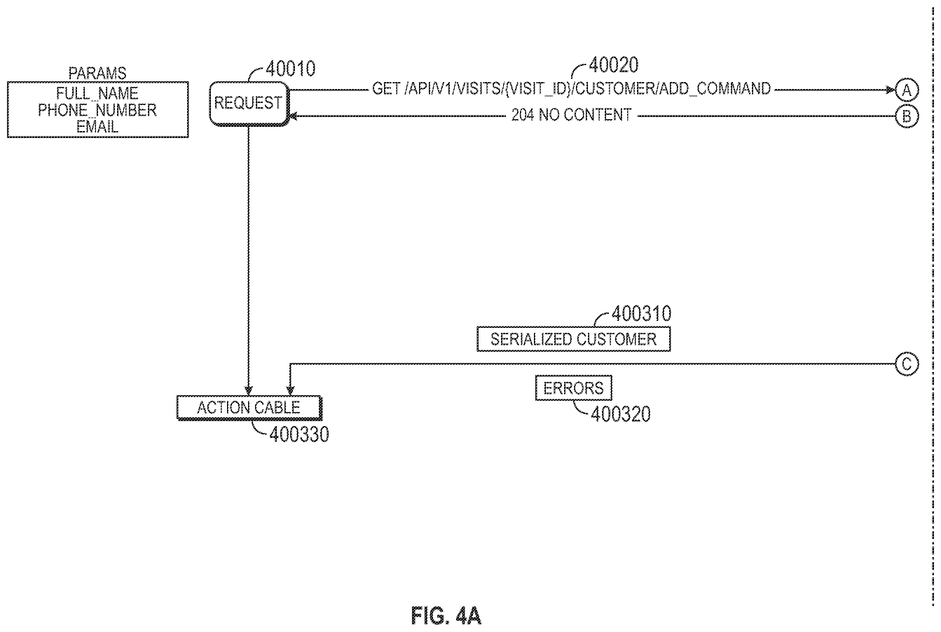

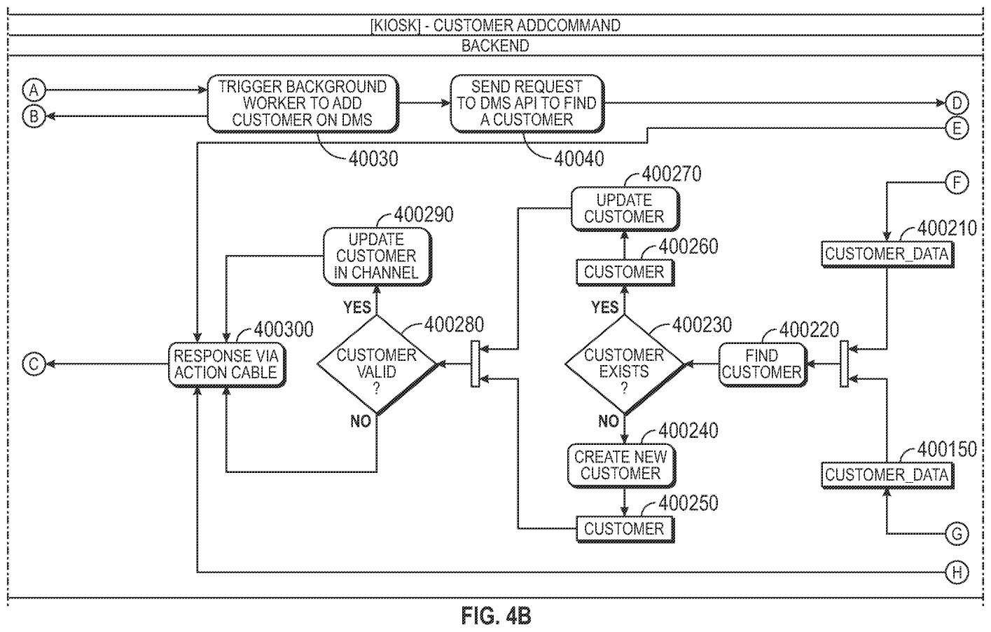

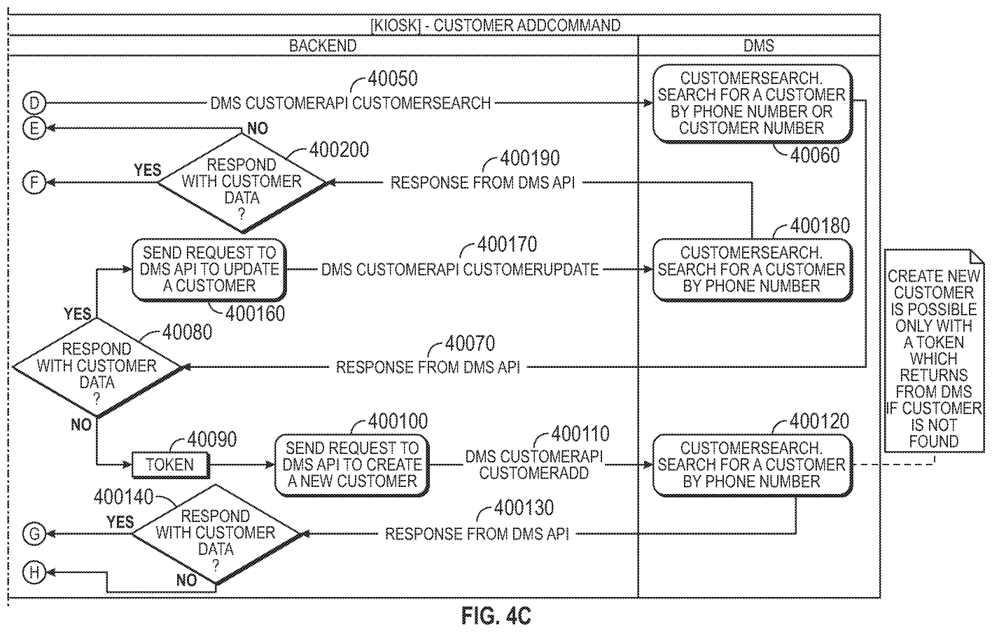

FIGS. 4A, 4B, 4C: Addition of Customer Details Using SCD
40010: Customer initiates a request to add customer details by interacting with touchscreen interface of the kiosk. The customer provides details including customer's full name, phone number and email address. The Kiosk software module creates software objects including full name, phone number, email address in its computer memory. It creates and establishes a software connection to an action cable mentioned in block 400330.
40020: A kiosk software module sends a request to add customer details via an API to SC along with software objects created above as parameters of the request.
40030: SC then triggers a software process responsible for handling the request to add customer details.
40040: This software process sends a request to DMS API to query for customer based on customer details received.
40050: DMS customer API responsible for search is activated.
40060: DMS initiates a software module to search for a customer record by using phone number or customer number.
40070: DMS returns the search results of query for customer details to Service Concierge device via an API.
40080: Concierge checks whether response from DMS search result had a response with customer data. If response data is empty, it creates a token mentioned in block 40090 and customer data.
400100: A software process sends a request to DMS API to create a new customer record.
400110: DMS API responsible for adding a new customer is activated
400120: DMS performs customer search by phone number. If customer is not found, a new customer record is created. Otherwise, existing customer record is updated.
400130: DMS sends the response to Concierge via DMS API.
400140: Concierge checks whether response from DMS API regarding new customer record creation is positive.
400150: If new customer record creation is successful, an object of customer record is created in Concierge's physical memory.
400160: If response from DMS API regarding a customer search is positive and has customer record, a software process at Concierge sends a request to DMS API to update customer record.
400170: DMS API responsible for updating a customer record is activated.
400180: DMS searches for a customer by phone number and updates the customer record found.
400190: A response regarding customer record update is sent via an API from DMS.
400200: A software process in Concierge checks whether response from DMS at step 400190 indicates a success.
400210: If customer update at Concierge is successful, a customer record is created at Concierge's physical memory.
400220: A software process in Concierge searches for the customer record returned at step
400210 or step 400150 exists in Concierge's local database.
400230: Result from database search at step 400220 is checked.
400240: If the check at database search for customer at step 400230 reveals that customer record does not exist, a software process initiates a routine to create a customer object.
400250: A customer object is created in Concierge's memory and written to Concierge's database
400260: If customer record exists, a customer record object is created in Concierge's memory.
400270: A software process at Concierge will update record in the database if data received from DMS is not a match with the customer record at Concierge's local database.
400280: A check is made as to whether customer record returned at step 400250 or step 400270 are valid. An error message is sent as a response to action cable if customer record is invalid.
400290: A channel is updated with customer record if customer record is found to be valid at step 400280. A success flag is sent as response along with customer record details.
400300: Response from steps 400140, 400200, 400280 and 400290 is captured for an action cable by a software process at Concierge. An error message indicated at block 400320 is sent if control reached the action cable from steps 400140, 400200 and 400280. Otherwise a serialized customer record indicated at block 400310 is shared on the action cable.
400330: An action cable responsible for communication between software components is initiated by kiosk. The error and success messages shared on this are used by kiosk to show appropriate messages to the customer via kiosk touch screen. If Service Concierge device fails to identify the customer, or any other identification or DMS communication errors appear which prevents the customer from continuing the appointment booking process, Concierge will either connect the customer with one of the service advisors during business hours or ask the customer to leave a message after hours.

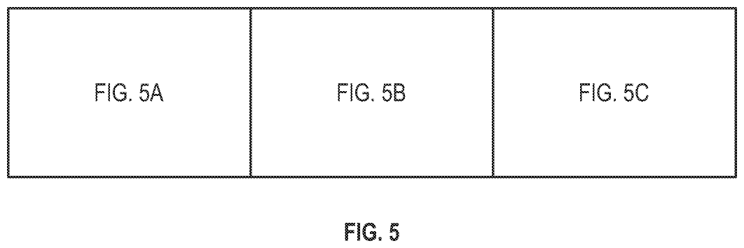

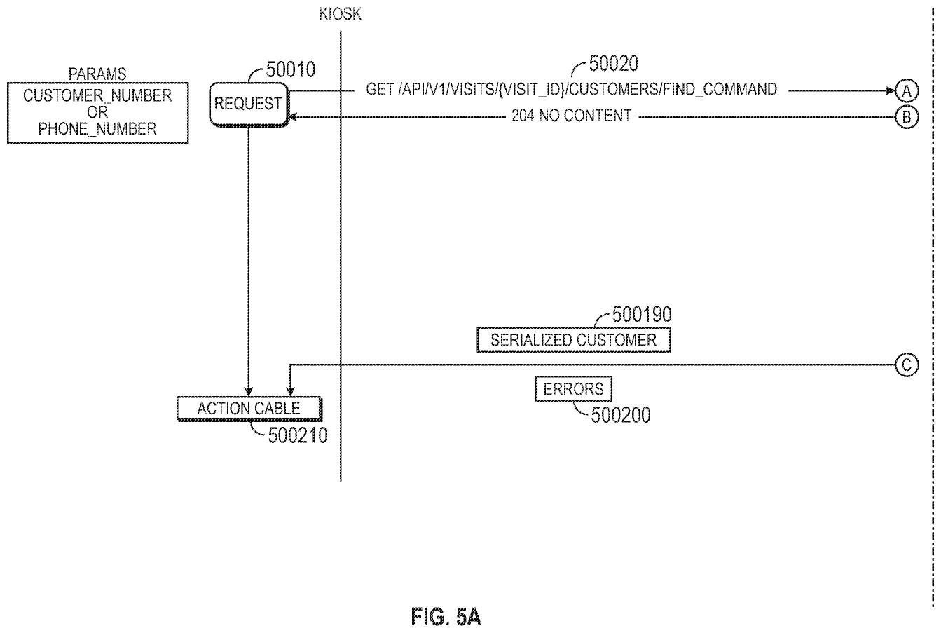

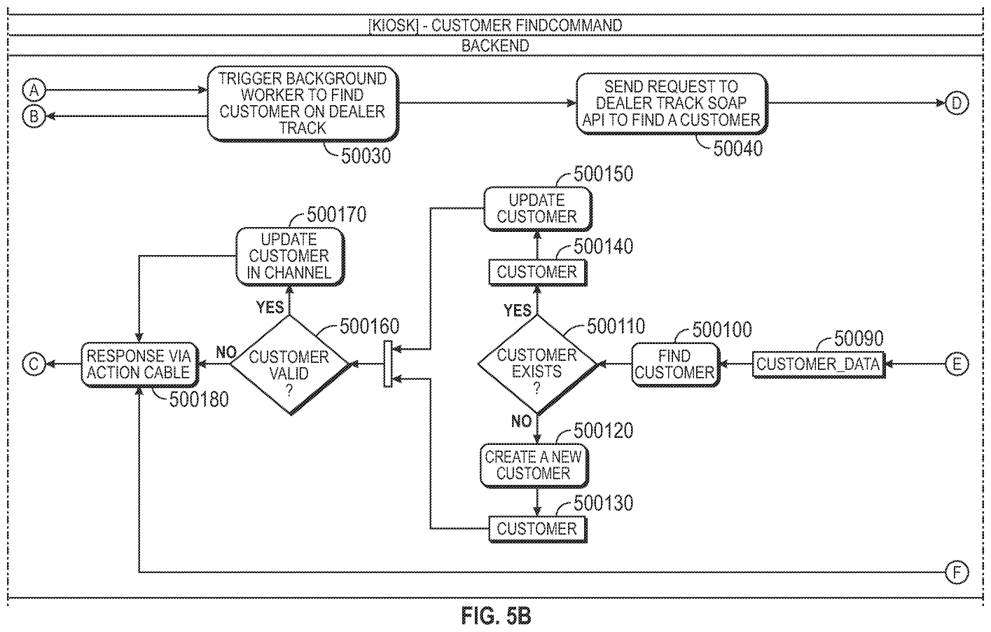

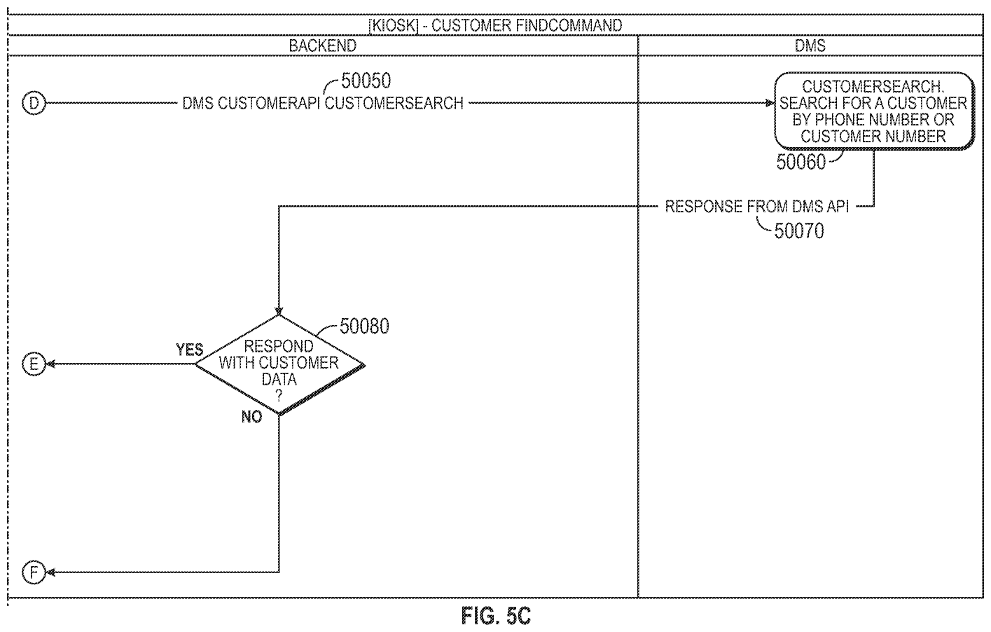

FIG. 5A, 5B, 5C: Customer Record Number and Customer Information Look-up Using SCD
50010: Customer initiates a request for finding customer record with customer's phone number as customer identifier. Customer uses the touch screen to interact with website and initiate such a request. A software module at the kiosk initiates customer find request with customer's phone number as parameter in the request. It creates and establishes a software connection to an action cable mentioned in block 500210.
50020: The request is sent to Concierge via an API by a software module in the kiosk. The software module also initiates an action cable.
50030: Service Concierge device triggers software process to find customer on DMS.
50040: This process sends a request to DMS via API.
50050: This request results in the invocation of customer search API exposed at DMS.
50060: DMS performs customer search by customer's phone number
50070: DMS returns the response via an API.
50080: The software process at Concierge checks whether the customer data response is empty or not. If empty, it sends a failure message on the action cable.
50090: Otherwise, software process at Concierge creates a customer data object and puts the control at step 500100.
500100: A software process Concierge searches for customer data in Concierge's local database.
500110: A check is made by Concierge to see if customer record exists
500120: The customer record is written to Concierge's local database if step 500110 reveals that customer record does not exist in Concierge's local database.
500130: A customer object is created for the customer record found at DMS if software control reaches step 500120.
500140: A customer record object is created for the customer record found at DMS.
500150: If the customer record does not match with the customer record in DMS.
500160: A software process at Concierge checks whether customer record created at Step
500120 or possibly updated at Step 500150 is a valid customer record. If the customer record is found to be invalid, a response indicating error is shared on the action cable.
500170: If the customer record is found to be valid at step 500160, customer record is updated in channel and a response indicating success is shared on action cable.
500180: Response from steps 50080, 500160 and 500170 is captured for an action cable by a software process at Concierge. An error message indicated at block 500200 is sent if control reached the action cable from steps 50080 and 500160. Otherwise a serialized customer record indicated at block 500190 is shared on the action cable.
500210: An action cable responsible for communication between software components is initiated by kiosk. The error and success messages shared on this are used by kiosk to show appropriate messages to the customer via kiosk touch screen. If Service Concierge device fails to identify the customer, or any other identification or DMS communication errors appear, Concierge will either connect the customer with one of the service advisors during business hours or ask the customer to leave a message after hours.

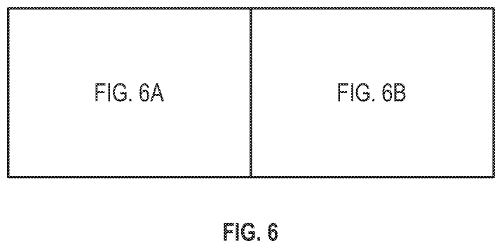

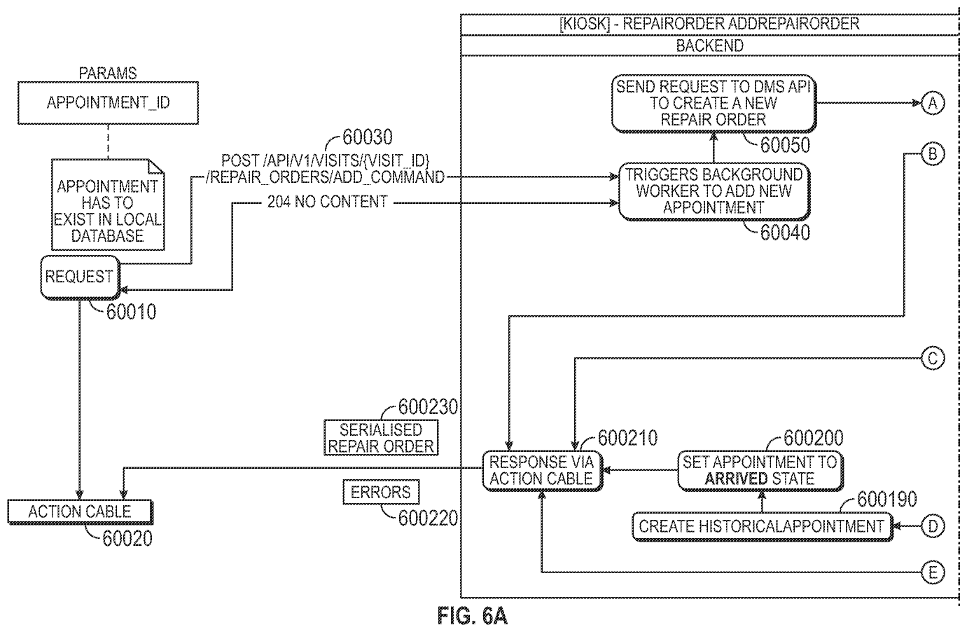

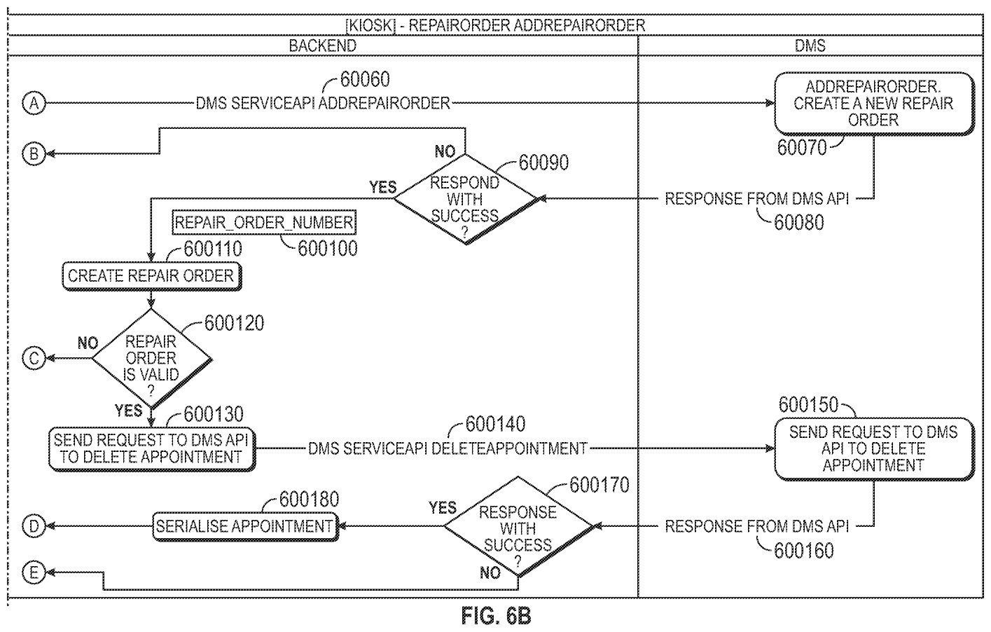

FIG. 6A, 6B: Customer New Repair Order Sequence for SCD
60010: A customer uses the touch screen of a kiosk to request a new repair order by providing an appointment id by scanning QR code corresponding to the appointment. Kiosk creates an action cable for the same request.
60030: Kisok initiates a request for repair order creation with Service Concierge device. This request contains appointment id.
60040: Service Concierge device triggers a software process that is responsible for adding new appoint record.
60050: Software process triggered at Step 60040 at Service Concierge device sends a request to create a new repair order by connecting with a DMS API.
60060: An add repair order command is invoked by software process triggered at Step 60050.
60070: DMS initiates the creation of a repair order corresponding to the appointment id.
60080: A response object is created by DMS and returned to Concierge via an API.
60090: Service Concierge device checks whether response from DMS is a success flag.
600100: If response at Step 60090 indicates a repair order object is created by Service Concierge device.
600110: Once repair order object is created, Service Concierge device writes a repair order record in a local database hosted by Concierge.
600120: Service Concierge device uses the repair order number created at Step 600100 and checks whether repair order created is valid.
600130: If repair order is valid, an API request is sent by Service Concierge device to DMS to delete the appointment corresponding to the repair order created. This request contains appoint id.
600140: Delete appointment command is invoked by software process triggered at Step 60050.
600150: DMS sends a request to DMS database to delete appointment record that matches the appointment id in the request sent at Step 600130.
600160: DMS returns a response with status flag indicating the success of appointment deletion.
600170: Service Concierge device checks the status of this message and returns an error to action cable.
600180: Service Concierge device creates a serialized appointment object using response checked at Step 600170.
600190: Appointment object is stored as historical data in Concierge's database.
600200: Service Concierge device sets appointment to ‘arrived’ state and send the response to the corresponding action cable.
600210: An action cable gets activated to receive messages from Steps 600200, 600120, 60090, and 600170. An error message is sent to the action cable if the repair order is not valid when checked by Concierge.
600220: If action cable received messages generated at Step 600120 or Step 60090 or Step 600170, an error message is created at kiosk.
600230: If action cable received messages generated at Step 600200, a success message along with repair order details is created at kiosk.
60020: Action cable initiates appropriate messages with repair order details or error messages at the user interface of the kiosk with messages generated at Step 600220 or Step 600230.

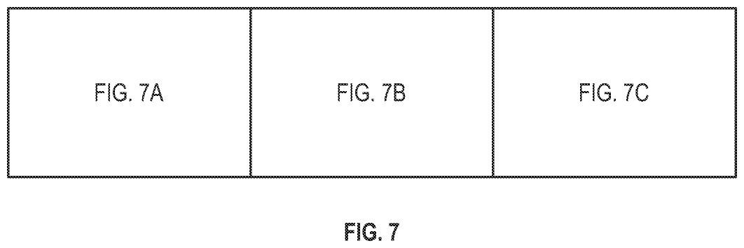

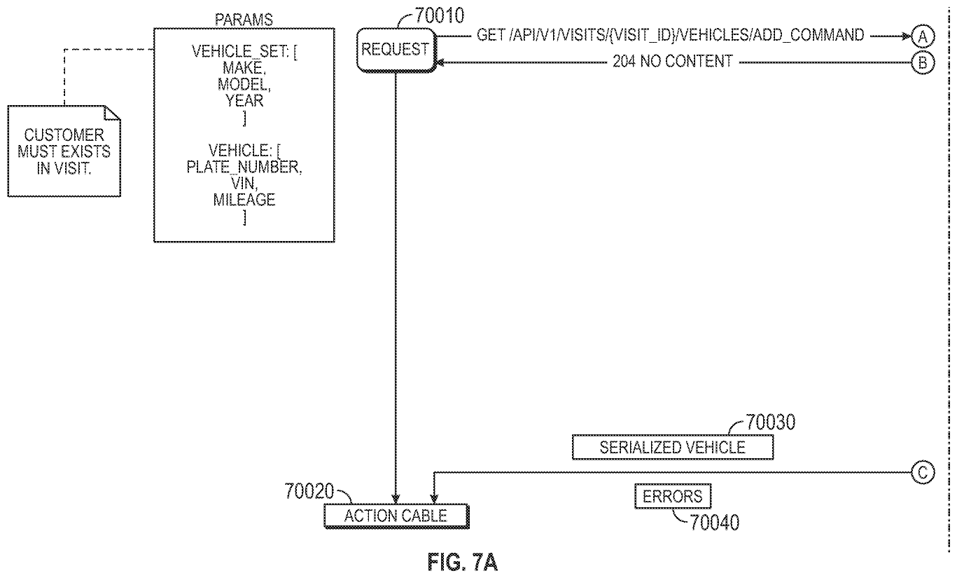

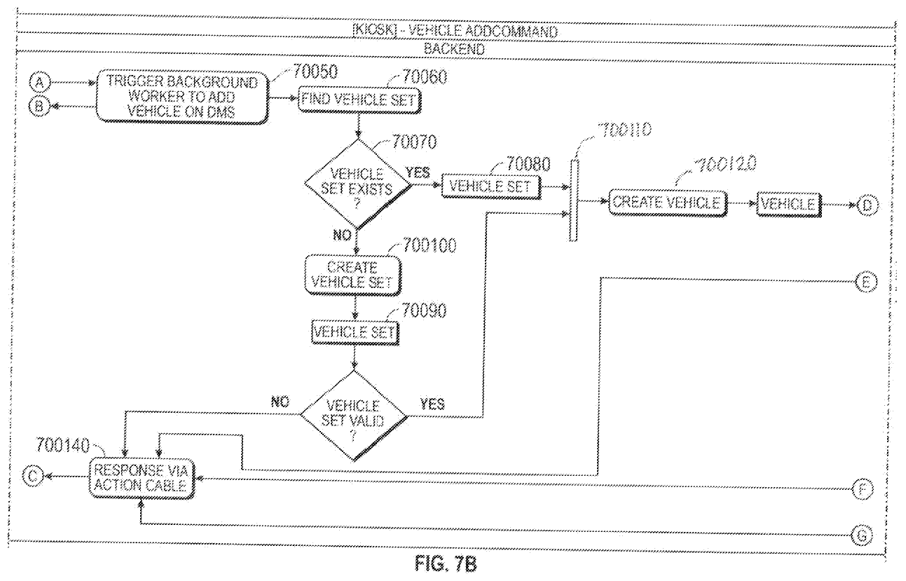

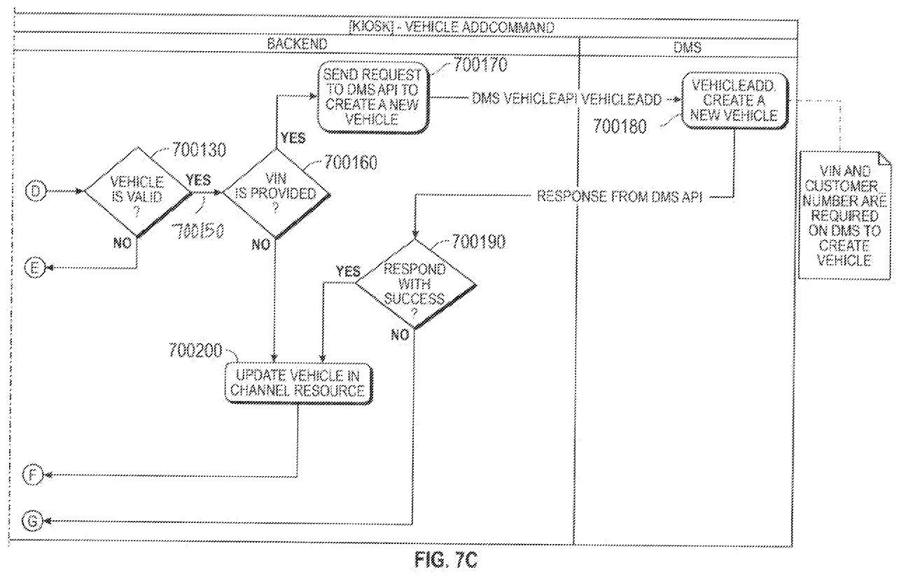

FIG. 7A, 7B, 7C: Initial Vehicle Registration using SCD
70010: A customer requests to register details of a vehicle in Service Concierge device (SCD) by interacting with a UI screen on a kiosk where customer provides details including make, model, manufacturing year, registration number, VIN and mileage of the vehicle. The request is sent to Concierge via an API.
70050: Service Concierge device triggers a software process to add vehicle details on DMS.
70060: A query is made in the local database of Service Concierge device to check whether a record for the vehicle set exists matching the vehicle details sent at Step 70010.
70070: A check is made whether data retrieved at Step 70060 indicates the presence of vehicle set corresponding to the vehicle details sent at Step 70010.
70080: If a record for vehicle set is found at Step 70070, a vehicle set object is created in Concierge's memory.
70090: If a record for vehicle set is not found at Step 70070, a vehicle set record is written to the local database of Concierge with the vehicle details provided at Step 70010.
700100: A vehicle set object is created in Concierge's memory once a vehicle set record is written at Step 70090.
700130: A check is made to see whether a vehicle set object created at Step 700100 is valid. A response indicating an error is sent to action cable on Service Concierge device if vehicle set object created at Step 700110 is found to be invalid.
700110: A vehicle record is written to the local database based on vehicle set object created at Step 70080 or Step 700130.
700120: A vehicle object is created with details of vehicle record written at Step 700110.
700150: A check is made to see whether the vehicle object created at Step 700120 is valid. A response indicating an error is sent to action cable on Service Concierge device if vehicle object created at Step 700120 is found to be invalid.
700160: A check is made whether VIN data attribute exists in the vehicle object validated at Step 700150
700170: A request is made to DMS API to create a new vehicle record by sending vehicle object created at Step 700120.
700180: DMS creates a new vehicle record in its database using vehicle object sent at Step 700170 and sends a response to Service Concierge device regarding the result of vehicle record creation.
700190: A check is made whether response from DMS at Step 700180 indicates a successful record creation. A response indicating an error is sent to action cable on Service Concierge device if vehicle object created at Step 700120 is found to be invalid.
700200: If check at Step 700190 indicates a successful record creation at DMS, vehicle details are updated on channel at Concierge. A response indicating success along with vehicle details are passed to action cable at Concierge.
700140: Action cable at Concierge receives response that indicates a success from Step 700200 or an error from Step 700130 or Step 700150 or Step 700190.
70030: A serialized vehicle object is created if a response indicating success is received from Step 700140.
70040: An error message with details of errors is created if action cable receives response indicating error from Step 700130 or Step 700150 or Step 700190.
70020: Action cable at kiosk receives response from action cable at Service Concierge device regarding status of vehicle set and vehicle data creation at Concierge and DMS. It sends either the response shown at Step 70030 or Step 70040 to a UI software module in kiosk which further displays the response along with details on a UI screen of kiosk.

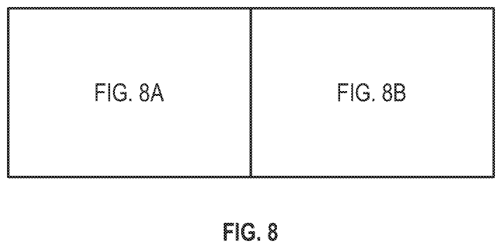

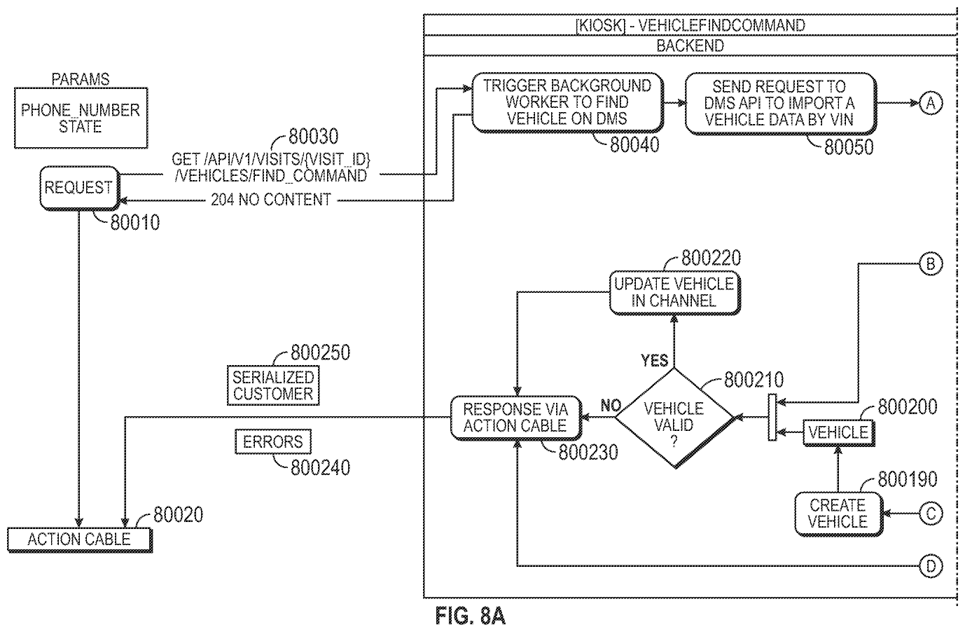

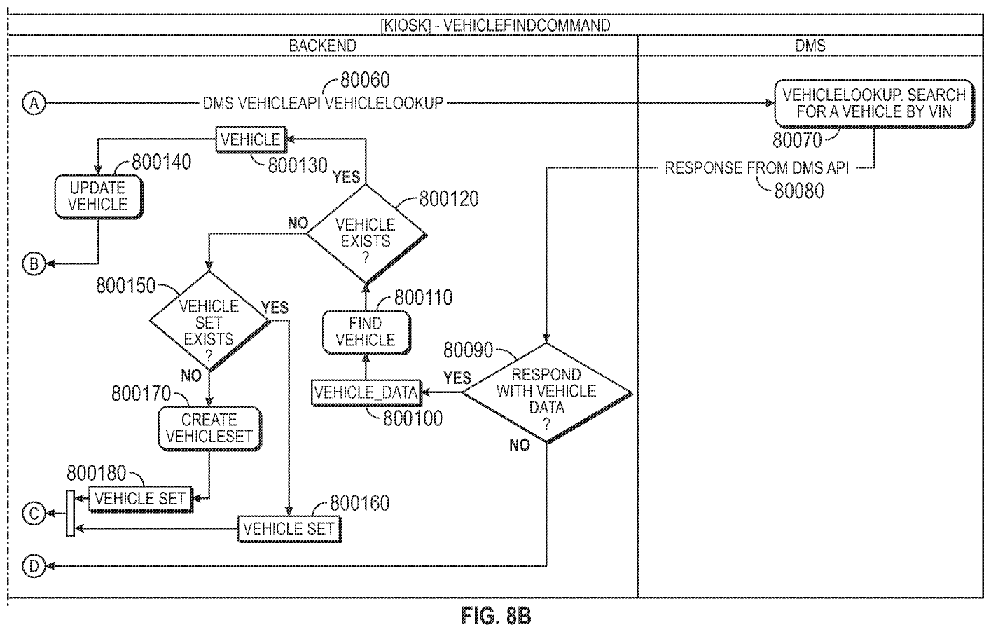

FIG. 8A, 8B: First Stage for Kiosk Interaction with the SCD
80010: Customer initiates a request at Kiosk by interacting with UI screen to find a vehicle based on customers' phone number. Kiosk waits for response on an action cable at kiosk.
80030: Kiosk triggers a request to initiate vehicle find command on Service Concierge device.
80040: Service Concierge device triggers a software process to initiate a search process for vehicle at DMS.
80050: Software process triggered at Step 80040 sends a vehicle find request to DMS via DMS vehicle lookup command created at Step 80060. The fnd request contains phone number of the customer and expects vehicle details by VIN number.
80070: DMS searches for vehicle records by VIN number.
80080: DMS sends a response with vehicle details to Service Concierge device via an API.
80090: Service Concierge device checks whether vehicle details returned at Step 80080 contain non-empty response that has details of vehicles.
800100: If check at Step 80090 reveals that response from DMS has vehicle data, Service Concierge device creates vehicle data object.
800110: If vehicle data is found to be successfully retrieved at Step 80090, Service Concierge device queries for the vehicle in Concierge's local database.
800120: A check is made to see whether vehicle object returned at Step 800110 contains vehicle details.
800130: If check at Step 800120 indicates that a vehicle exists in Service Concierge device's local database, a vehicle object is created in the physical memory of Service Concierge device.
800140: Vehicle records are updated in the local database of Service Concierge device.
800150: Service Concierge device checks whether corresponding vehicle set exists in the local database.
800160: If vehicle set is found in the local database of Service Concierge device with a check at Step 800150, a vehicle set object is created.
800170: If vehicle set does not exist in local database hosted by Service Concierge device, a vehicle set record is written to the local database at Concierge.
800180: A vehicle set object is created based vehicle set record created at Step 800170.
800190: A vehicle object is created based on vehicle set data available at Step 800160 or Step
800180 and written to Service Concierge device's local database.
800200: A copy of vehicle object is created using vehicle object written at Step 800190.
800210: A check is made by Service Concierge device to see whether vehicle objects created at Step 80020 or Step 800140 are valid.
800220: If check at Step 800210 indicates that vehicle object is valid, vehicle objects are updated on channel.
800230: Response is captured in action cable at Service Concierge device based on response at Step 800220 or Step 800210.
800240: If response captured on action cable present in Service Concierge device 800210 indicated an invalid vehicle, an error object is shared on Service Concierge device's action cable.
800250: If valid vehicle is found, a serialized customer object that contains customer details and vehicle details is shared on Service Concierge device's action cable.
80020: Action cable at kiosk receives either a success message with customer, vehicle details or an error message with error details based on objects created at Step 800240 or Step 800250 and shares the messages with software processes including the one created at Step 80010.

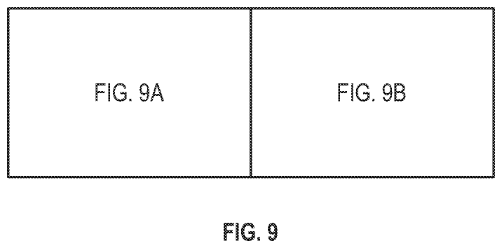

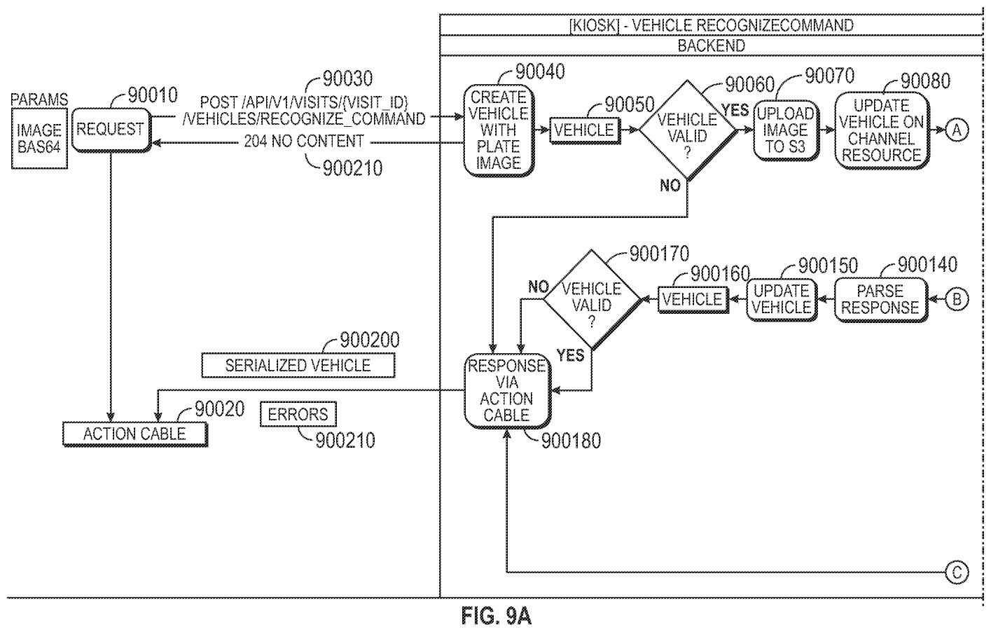

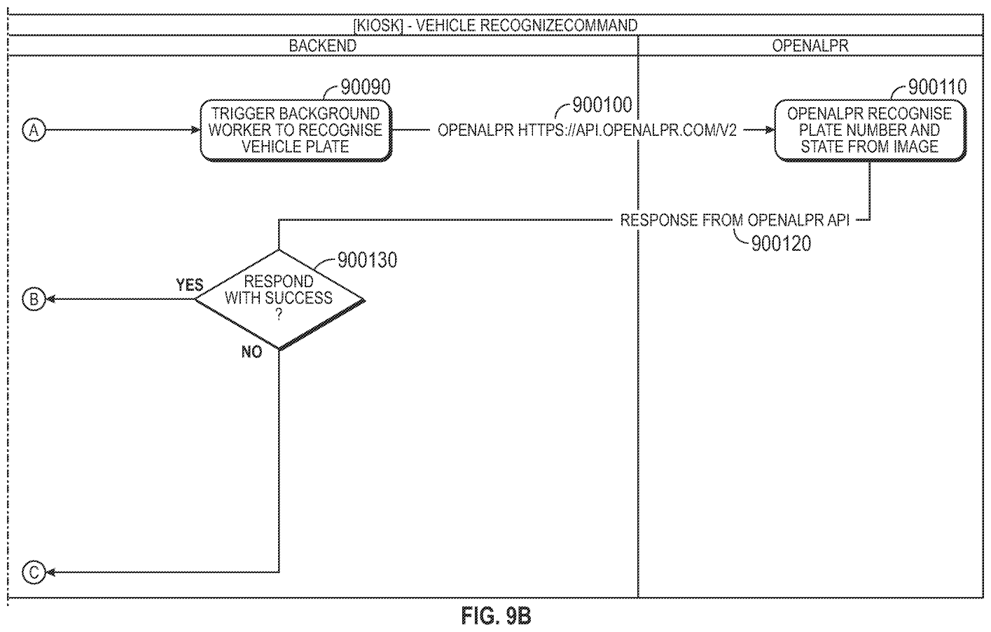

FIG. 9A, 9B: Second Stage Interaction with Kiosk with SCD Interaction
90010: When a customer enters a dealership's vehicle, kiosk initiates a request to Service Concierge device via an API to recognize the vehicle entered.
90030: An API gets activated to on kiosk and sends find vehicle command to Service Concierge device.
90040: A camera and GPS sensor software module capture image and location of the vehicle.
90050: A vehicle object containing vehicle's images and vehicle geolocation is created by Service Concierge device.
90060: Service Concierge device checks whether vehicle object created at Step 90050 is valid.
90070: If a valid vehicle object is found at Step 90060, vehicle images and geolocation are uploaded to S3 file system supported by Amazon Web Services.
90080: Service Concierge device updates its channel resource with vehicle data if Step 90070 is successfully executed.
90090: Service Concierge device triggers a software process to recognize number plate of vehicle based on vehicle images captured at Step 90070 to retrieve registration number of the vehicle.
900100: A request is sent to an API of OpenAlpr webservice to retrieve vehicle registration of a vehicle based on vehicle images captured at Step 90070.
900110: Image processing is done on the license plate by OepnAlpr webservice to retrieve the vehicle registration number.
900120: OpenAlpr web service sends response that potentially includes vehicle registration number corresponding to the vehicles images sent in the request at Step 900100.
900130: Service Concierge device checks whether response at Step 900120 contains vehicle registration number details along with a success flag.
900140: The registration number details received at Step 900120 are parsed if response check at Step 900130 indicates a success.
900150: Service Concierge device updates vehicle information in local database with response data parsed at Step 900140.
900160: A vehicle object is created with response data parsed at Step 900140.
900170: Service Concierge device checks whether vehicle object created at Step 900160 is valid.
900180: Action cable receives vehicle details from vehicle object created at Step 900160 or responses indicating errors generated at Step 900130 or Step 90060.
900200: If action cable at Service Concierge device receives vehicle object at Step 900180, then Service Concierge device creates a serialized vehicle object on action cable.
900210: If action cable at Service Concierge device receives vehicle object at Step 900180, then Service Concierge device creates a serialized vehicle object on action cable.
90020: Kiosk initiates a display of the information on the user interface of the kiosk based on information received on action cable.

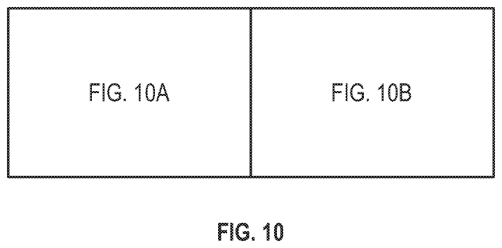

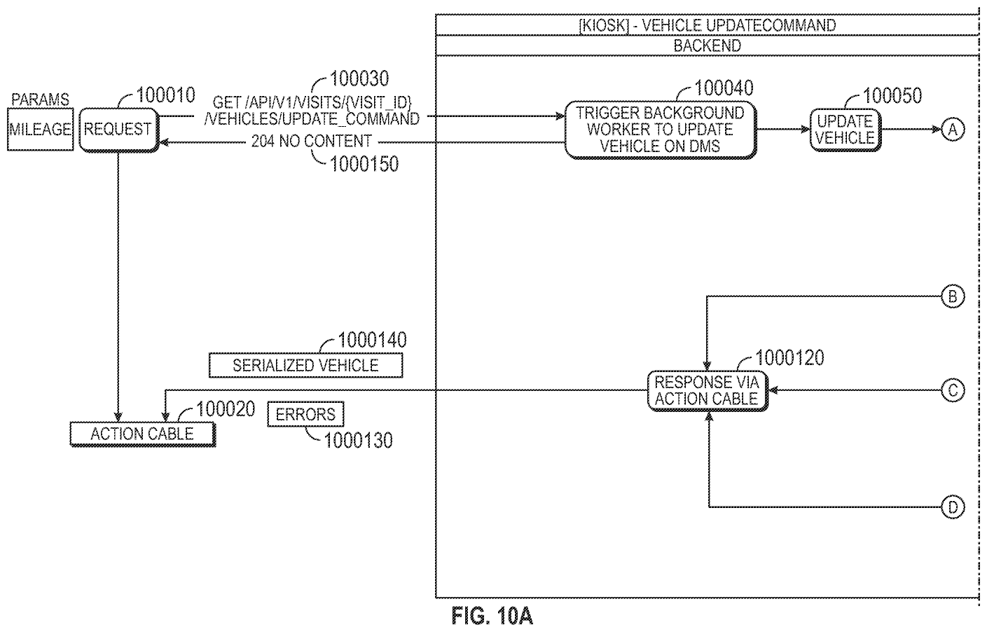

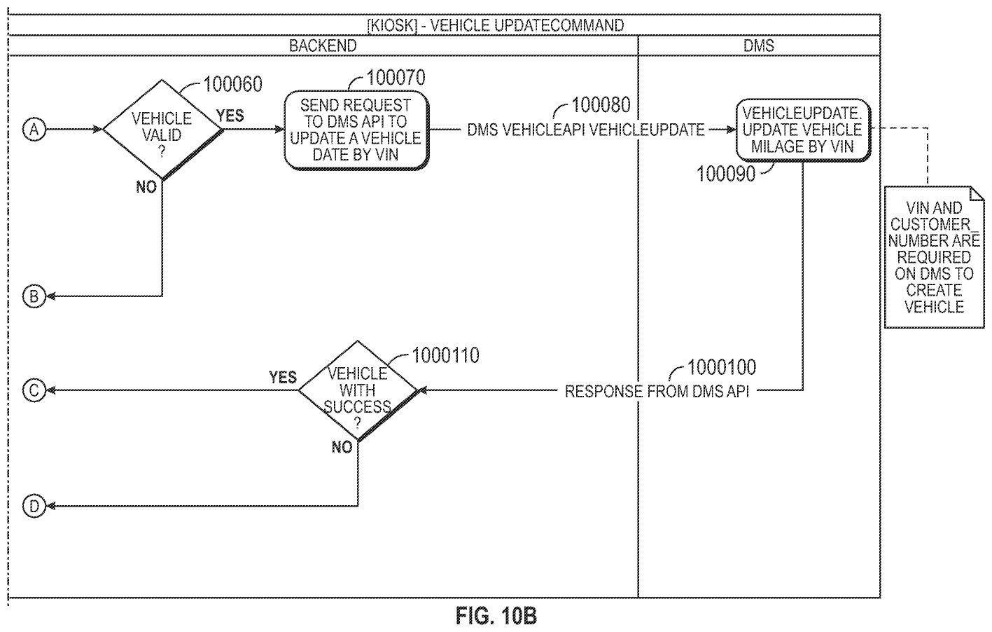

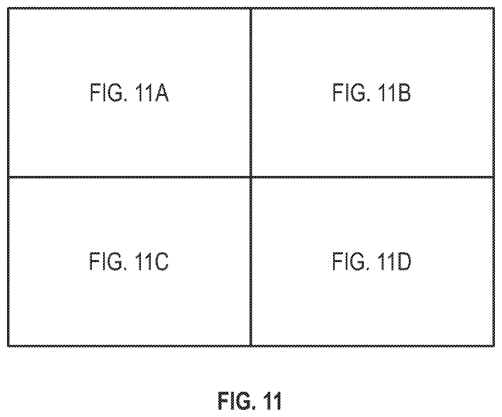

FIG. 10A, 10B: Third Stage Kiosk Operating Procedures for the SCD Customer/Kiosk Interaction Operating Procedures for the SCD
100010: Customer interacts with the UI screen at a kiosk. Kiosk asks customer to provide any updates on mileage. Customer enters mileage details if there are any updates.
100030: Kiosk software process sends a request to Service Concierge device to update vehicle information regarding mileage data attributes.
100040: Service Concierge device triggers a software process to update vehicle details on DMS.
100050: Software process triggered at Step 100040 initiates an update vehicle request.
100060: Service Concierge device checks whether vehicle object corresponding to vehicle details entered at Step 100010 is valid.
100070: If vehicle object is found to be valid at Step 100060, software process triggered at Step 100050 sends a request to DMS to update vehicle data by corresponding VIN number available in local database.
100080: DMS vehicle update API is triggered by the request created at Step 100070.
100090: DMS updates vehicle data including vehicle mileage.
1000100: Response from DMS is sent via an API.
1000110: Service Concierge device checks whether response sent at Step 1000100 is valid.
1000120: An action at Service Concierge device receives responses based on data generated at Step 1000100 and Step 100060.
1000140: Service Concierge device creates a serialized vehicle object if action cable activated at Step 1000120 gets a response after a valid vehicle data is found at Step 1000110.
1000130: Service Concierge device creates an error message if action cable activated at Step 1000120 gets an error response at Step 1000110 or Step 100060.
100020: Action cable at kiosk receives message created at either Step 1000130 or Step 1000140 and initiates a request to the user interface to show an error message or updated vehicle information.

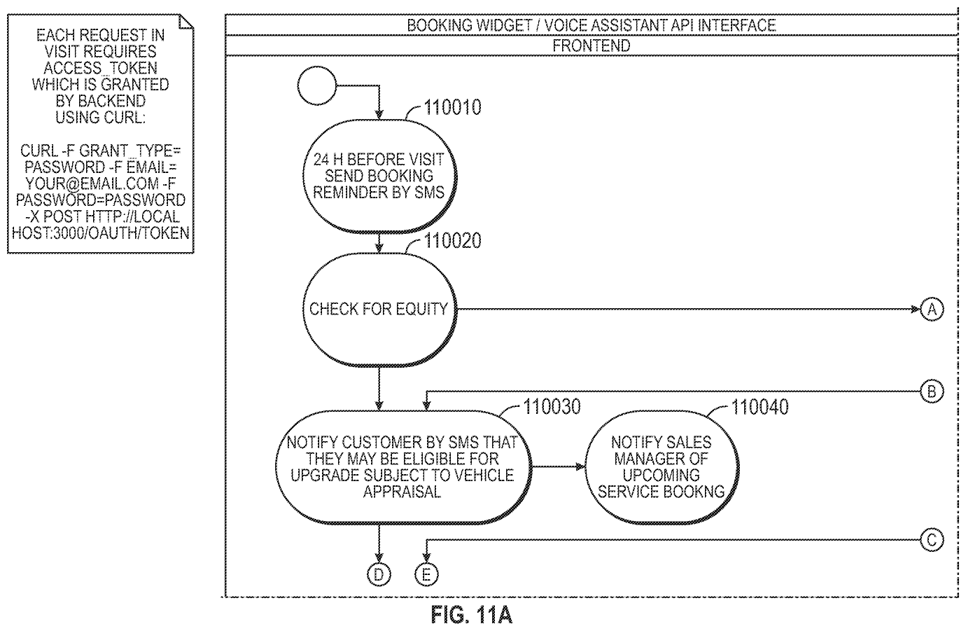

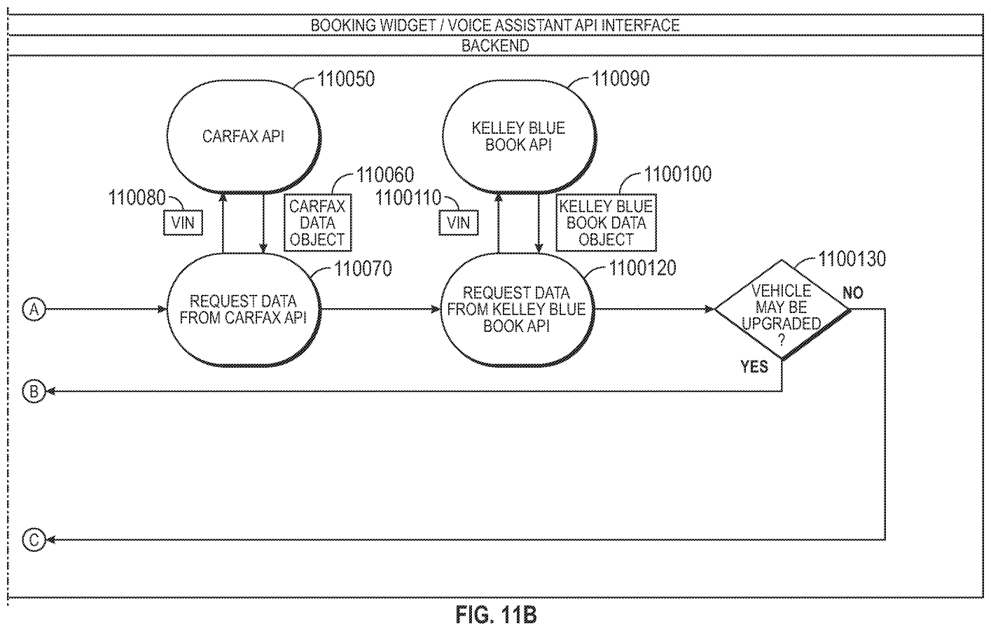

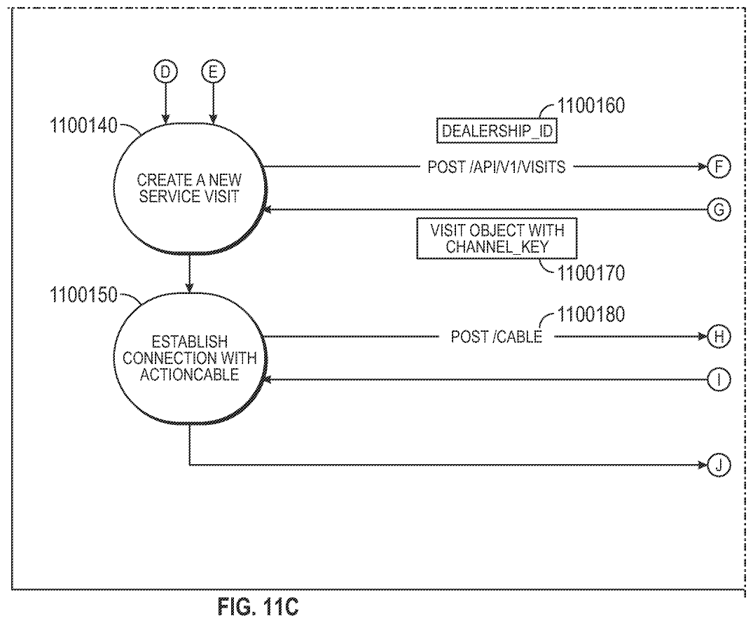

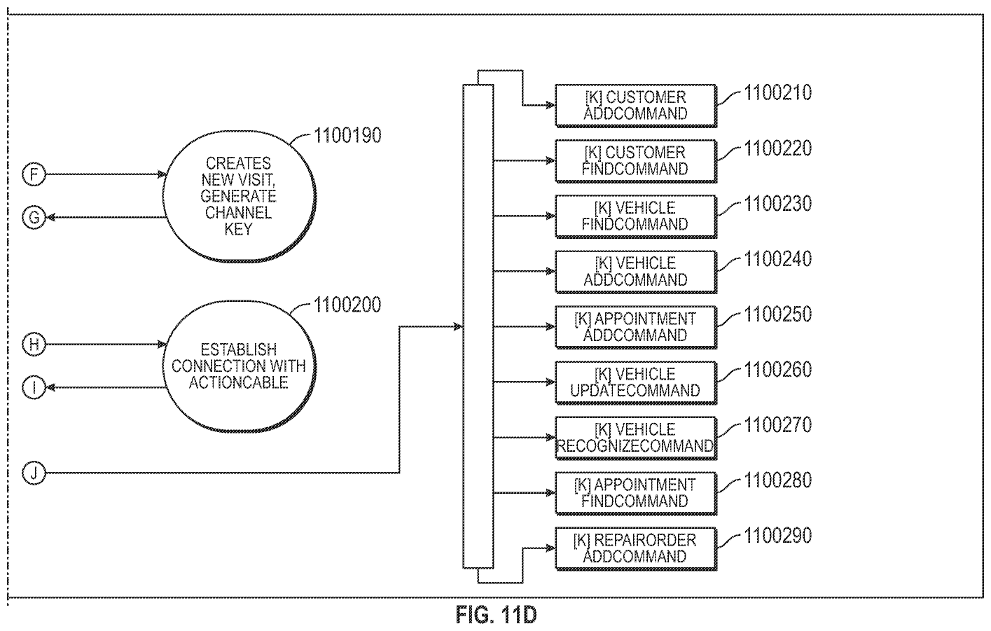

FIG. 11 A, 11B, 11C, 11D: Final Stage Kiosk Operating Procedures for the SCD
110010: Kiosk sends a booking reminder to registered phone number of the relevant customer via a short message service (SMS) 24 hours prior to the booking date.
110020: Kiosk initiates request to Service Concierge device via an API for vehicle equity mining process for the vehicle that is about to be serviced. Equity mining process includes checking the financial credibility of a vehicle such as loan, conditions of vehicle, insurance claims etc. The request includes VIN of the vehicle. Kiosk waits for Service Concierge device to send a response.
110070: Service Concierge device initiates a request via Carfax API to retrieve vehicle information such as loan, conditions of vehicle, insurance claims etc. Service Concierge device waits to get Carfax data object.
110080: A VIN object is created based on VIN value received at Step 110070 by Service Concierge device.
110050: A software instance triggered by Carfax API due to request at Step 110070 retrieves vehicle details based on VIN number available at Step 110080.
110060: A Carfax data object is created by Carfax API.
1100120: Service Concierge device initiates a request via Kelley Blue Book API to retrieve vehicle information such as loan, conditions of vehicle, insurance claims etc. Service Concierge device waits to get Kelley Blue Book data object.
110110: A VIN object is created based on VIN value received at Step 110120 by Service Concierge device.
110090: A software instance triggered by Kelley Blue Book API due to request at Step 110070 retrieves vehicle details based on VIN number available at Step 110080.
1100100: A Kelley Blue Book data object is created by Kelley Blue Book API.
1100130: Service Concierge device combines the results from Step 110070 and Step 1100120 and checks whether a vehicle has financial and logistical credibility to be considered for an upgrade to a new vehicle.
110030: Kiosk checks the result from Step 1100130 to see whether a vehicle upgraded with a new vehicle. Kiosk sends a message on short message service (SMS).
110040: Kiosk sends a message to Sales manager of upcoming service booking.
1100140: Once the software control reaches the kiosk after the completion of Step 110030 or Step 1100130, Kiosk creates a new service visit request. VIN number of the vehicle to be serviced is included in this request which it sends to DMS via an API.
1100160: A dealership object that corresponds to the vehicle to be serviced is created by kiosk as an object in the request at Step 1100140.
1100190: Service Concierge device creates a channel key that corresponds to communication line between Service Concierge device and kiosk based on VIN and dealership information received at Step 1100140.
1100170: A visit object corresponding to the vehicle's visit is created by Service Concierge device. This object includes channel key. Service Concierge device sends back the visit object to kiosk via an API.
1100150: Once the software control finishes executing Step 1100140, kiosk sends a request to Service Concierge device to create a channel key via an API. Kiosk waits for the software control to return from Service Concierge device. Once the software control returns from Service Concierge device, kiosk connects with instances software modules activated at Service Concierge device which are listed at Step 1100210, 1100220, 1100230, 1100240, 1100250, 1100260, 1100270, 1100280, and 1100290.
1100180: An action cable object is augmented to the request created at Step 1100150.
1100200: Service Concierge device establishes connection with kiosk using the action cable object created at Step 1100180 and sends the response to kiosk software control waiting at Step 1100150.
1100210: Service Concierge device activates an instance of a software module that can add a customer record to Concierge database and DMS.
1100210: Service Concierge device activates an instance of a software module that can search a customer record from Concierge database and DMS.
1100230: Service Concierge device activates an instance of a software module that can search a vehicle record to Concierge database and DMS.
1100240: Service Concierge device activates an instance of a software module that can add a vehicle record to Concierge database and DMS.
1100250: Service Concierge device activates an instance of a software module that can add a vehicle appointment record to Concierge database and DMS.
1100260: Service Concierge device activates an instance of a software module that can update a vehicle record to Concierge database and DMS.
1100270: Service Concierge device activates an instance of a software module that can recognize a vehicle and retrieve and/or update vehicle record at Concierge database and DMS.
1100280: Service Concierge device activates an instance of a software module that can find an vehicle appointment record from Concierge database and DMS.
1100290: Service Concierge device activates an instance of a software module that can add a vehicle repair order record to Concierge database and DMS.

### FIG. 12: Use of Historical Data for Predictive Analytics for SCD

120010: Historical data about cars which exist in database systems hosted at Concierge devices are retrieved.
120020: Historical data about drivers such as location, age, gender, spending behavior, temporal and spatial aspects of service visits which exist in database systems hosted at Concierge devices are retrieved.
120030: Data that match with data records found at Step 120010, Step 120020 are used to retrieve specific data attributes from dealership management systems. These data attributes include details about advisers such as qualification, time on job etc.
120040: Historical data records that match with data items retrieved at Step 120030 are used to get SCD predictive analytics dataset (SCDPAD) from historical repair order database systems. Historical repair order data includes recommended items, sold items, advisor involved etc. SCDPAD represents dataset that is used by various predictive analytics modules at Service Concierge device to derive statistical patterns from the data and provide predictive and prescriptive insights for business stakeholders which includes manufacturers, dealers, vehicle owners.

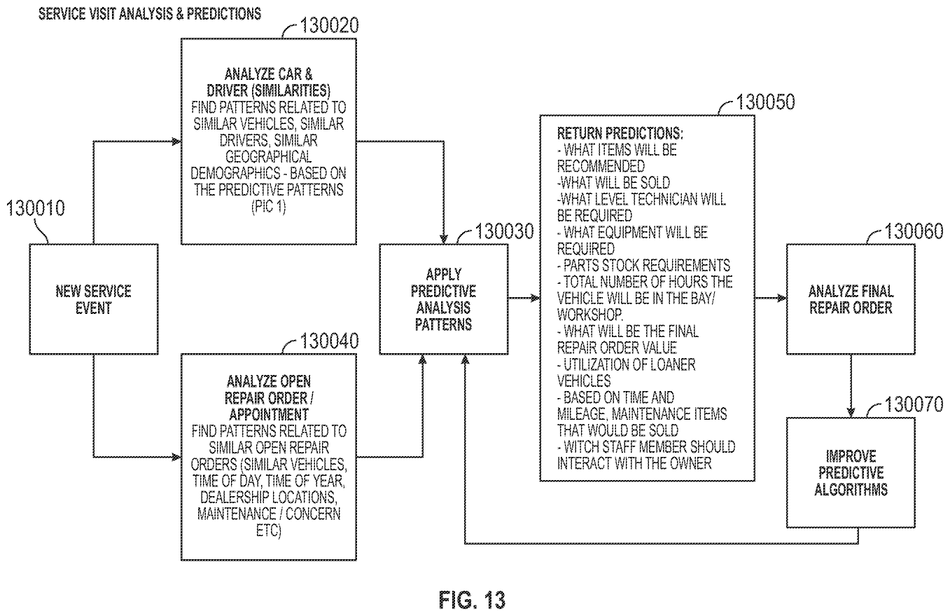

FIG. 13: Use of AI and Historical Data for SCD Operations
130010: A new vehicle service event is captured by Service Concierge device.
130020: Service Concierge device finds similar vehicles, similar drivers etc. based on data attributes related to the vehicle that is under consideration for a service and historical vehicle and customer data. Simple similarity metrics such as cosine distance are used.
130040: Service Concierge device finds open repair orders that are similar to the service request for the vehicle considered at Step 130010. Simple similarity metrics such as cosine distance are used.
130030: Predictive analytics algorithms are applied to derive insights listed at Step 130050.
130050: Service Concierge device returns predictions for quantities including items sold, total number of hours spent by a vehicle in a workshop, utilization of loaner vehicles among other quantities listed in FIG. 13.
130060: Service Concierge device uses output from Step 130020, Step 130040 and Step 130050 to predict final repair order details.
130070: The outcome of service operation on the vehicle arrived at Step 130010 and predictive outputs derived at Step 130060 are used to improve predictive analytics algorithms.

FIG. 14: Analysis for SCD Predictions
140010: A query is made by a business stakeholder of a dealership to derive predictive and prescriptive analytics-based insights.
140020: Service Concierge device analyses dealership data to find similar dealerships based on criteria such as brands, locations, business hours etc.
140030: Service Concierge device employs predictive analytics algorithms to derive patterns from the data retrieved at Step 140020.
140040: Predictive and prescriptive insights are presented to the business user in various formats so that operational efficiency can be improved by the dealership.

FIG. 15A and FIG. 15B: First Set of SCD System Architecture Schematic Diagrams
150010: A customer drives a vehicle to a dealership or connects to digital channels to interact with Service Concierge device.
150020: A vehicle identification process is carried out depending on the digital communication channel used by a customer. If customer drives a vehicle to a dealership, images of the vehicle are captured and sent to Service Concierge device. If customer connects via digital voice assistant inbuilt in the vehicle, the identification number of hardware device hosting the digital voice assistant is sent to Concierge via an API.
150030: If customer drives a vehicle to a dealership, image processing is done by Concierge with software libraries like Tesseract to retrieve registration number of the vehicle.
150040: A request is sent by Concierge to DMS via an API to retrieve details of vehicle such as owner name, phone number, vehicle set, vehicle registration details. Vehicle registration number retrieved from Step 150030 and/or digital id of digital communication channel retrieved from Step 150020 are sent as parameters of the request.
150050: DMS queries its database with parameters passed in Step 150040 to retrieve vehicle and owner details. DMS returns results via an API. The results will include VIN and vehicle owner details if matching records are found for parameters received by DMS.
150060: Service Concierge device returns the response along with vehicle, owner details if any to digital communication channel via an API.
150070: Digital communication channel displays or presents the customer with details of vehicle and customer for confirmation.

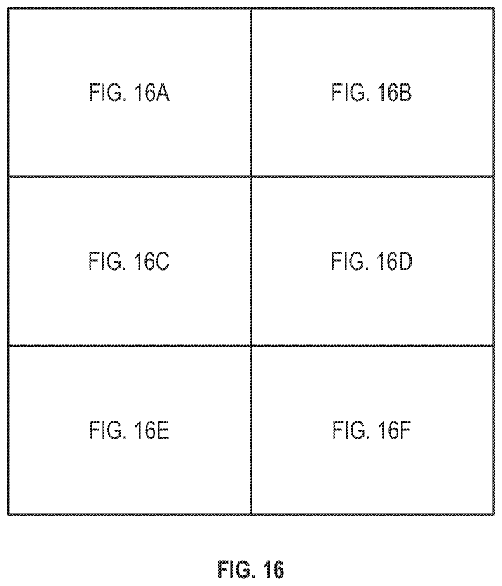

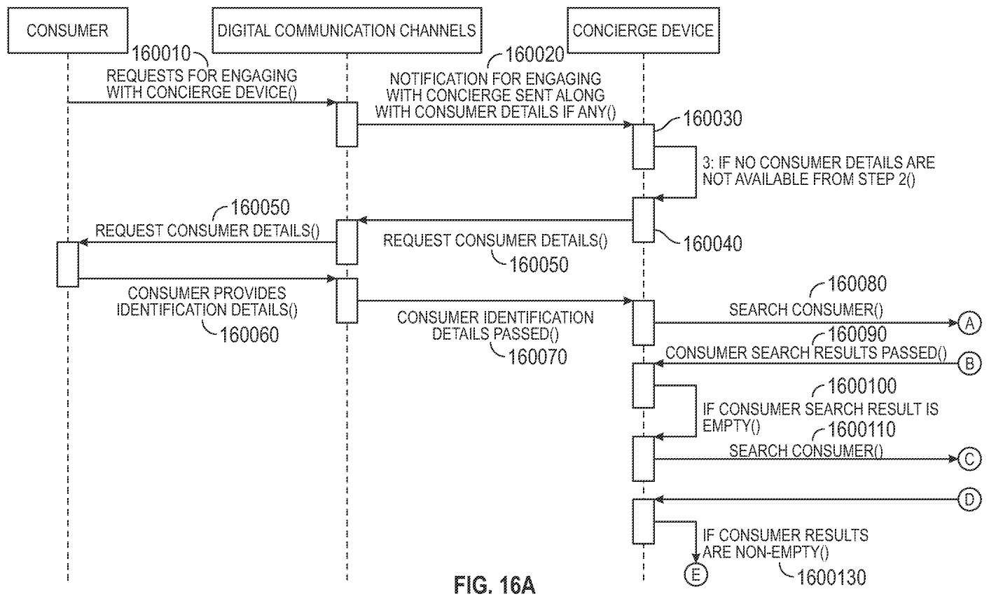

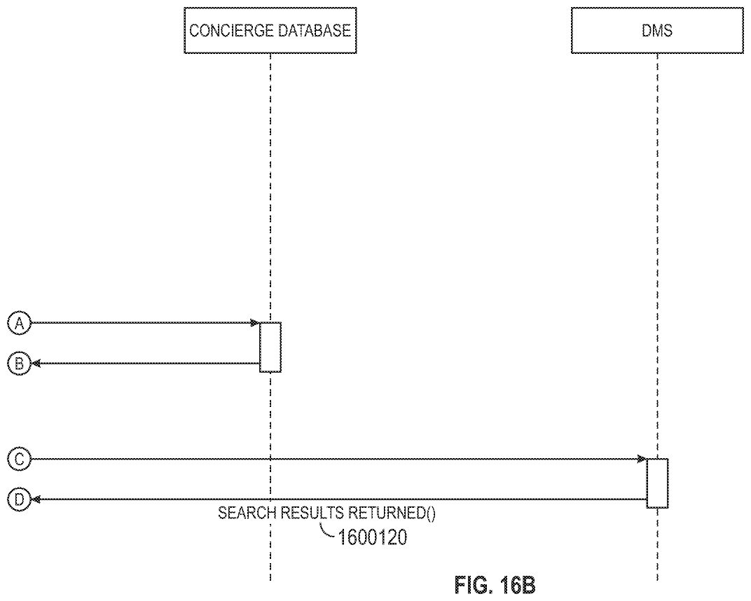

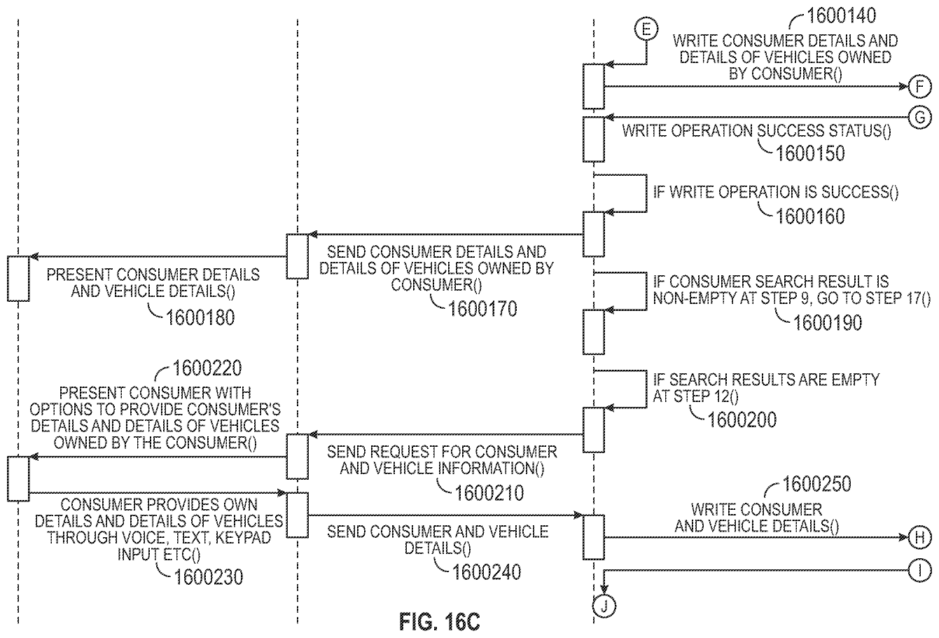

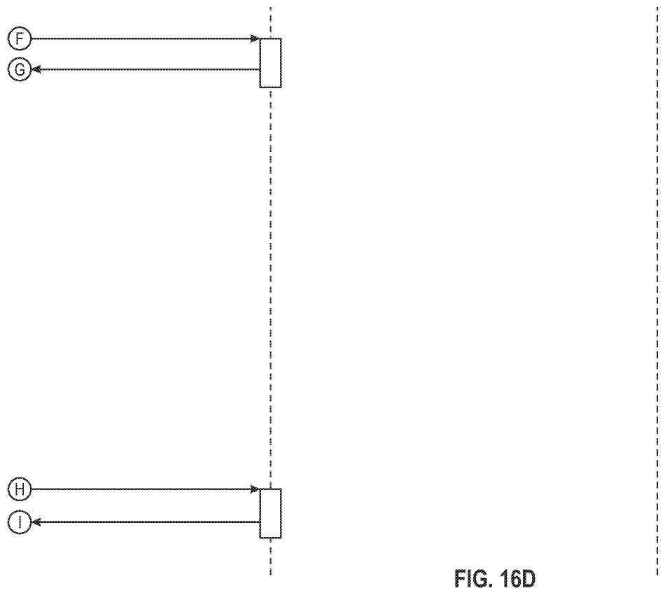

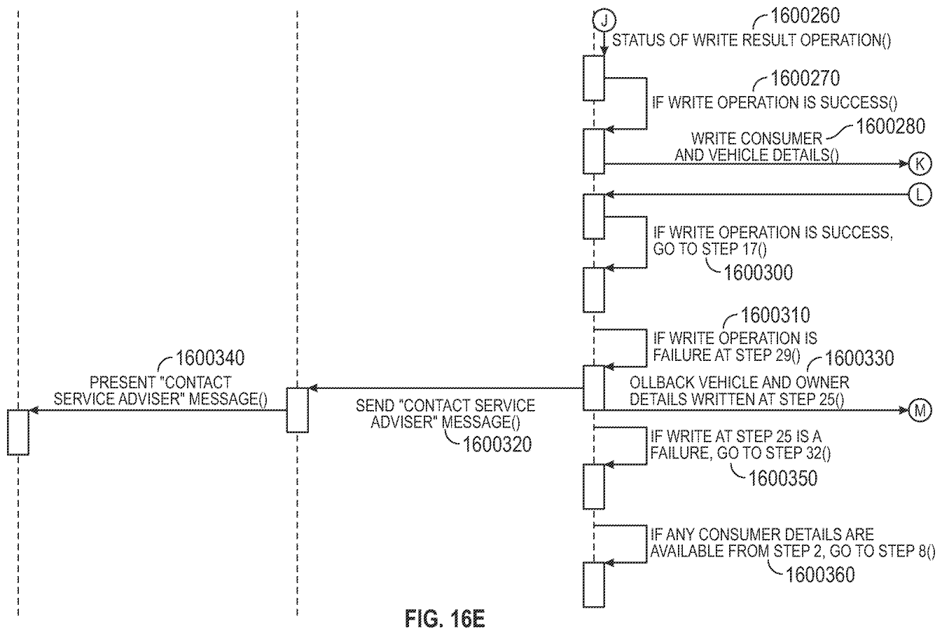

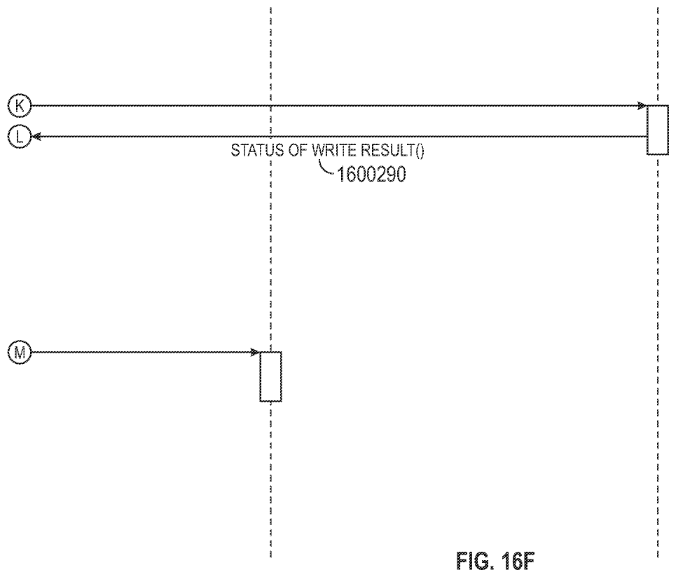

FIGS. 16 A, B, C, D, E and F (Second Set of SCD System Architecture Schematic Diagrams
160010: A customer interacts with a digital communication channel to connect with Service Concierge device.
160020: A digital communication channel captures customer identifier data if available and sends a request to Service Concierge device via an API. These customer identifier data include phone number or id of the digital communication channel itself or voice signature of customer.
160030: A check is made by Service Concierge device to see whether customer details are available in the request sent at Step 160020.
160040: If no customer identifier data are available, a request is sent back to the digital communication channel via an API requesting customer identifier data.
160050: Digital communication channel requests customer to provide customer identification data including phone number, vehicle registration number.
160060: A customer provides customer identification data if a request for such details is shown in Step 160050.
160070: Digital communication channel captures customer identification data and sends the data to Service Concierge device via an API.
160080: Service Concierge device searches for customer data in Concierge's local database with customer identification data as parameters of the search.
160090: Concierge database returns all details of customer including full name, phone number, email address and vehicle details including vehicle registration number, make, manufacturing year if search for records is successful at Step 160080.
1600100: Service Concierge device checks whether results returned by Concierge database has empty results.
1600110: If Service Concierge device finds the results to be empty at Step 1600100, it sends a request to DMS via an API to search for customer data with customer identification details received at Step 160070.
1600120: DMS queries its database against the request sent at Step 1600110 and sends search results that might include non-empty customer details and vehicle details.
1600130: Service Concierge device checks whether search results returned from Step 1600120 are non-empty and have customer data.
1600140: If DMS is found to have returned customer data at Step 1600130, Concierge sends a request to Concierge's database to write customer details and details of vehicles owned by customer.
1600150: Database deployed by Service Concierge device writes customer details, vehicle details and returns the status of write operation to Service Concierge device via an API.
1600160: Service Concierge device checks whether customer data and vehicle data are successfully written based on the results returned at Step 1600160.
1600170: If write operation is found to be successful, Service Concierge device sends customer and vehicle details to digital communication channel via an API.
1600180: Digital communication channel presents customer with the customer details, vehicle details.
1600190: If customer search results are found to have customer details and vehicle details at Step 160090, Concierge sends the software control to Step 1600170.
1600200: If customer and vehicle details are found to be empty at Step 1600120, Service Concierge device triggers a software process.
1600210: Software process triggered at Step 1600120 sends a request to digital communication channel via an API to capture customer and vehicle details from the customer.
1600220: Digital communication channel presents a customer with options to provide customer details including full name, phone number and details of vehicle including vehicle registration number, make, model, year of registration.
1600230: Customer interacts with digital communication channel via text/voice/gesture and provides details requested in Step 1600220.
1600240: Digital communication channel sends the details captured in Step 1600230 to Service Concierge device via an API.
1600250: Service Concierge device sends a request to Concierge database via an API to write the data sent at Step 1600240.
1600260: Concierge database performs a write operation based on the request sent at Step 1600250 and returns the status of write operation to Service Concierge device via an API.
1600270: Service Concierge device checks whether write operation is successful at Step 1600260 based on the status returned by Concierge database.
1600280: If Service Concierge device finds that write operation is successful at Concierge database, it sends a request to DMS via an API to write customer and vehicle details captured at Step 1600230.
1600290: DMS writes customer details and vehicle details to database in DMS and sends back the results of write operation to Service Concierge device via an API.
1600300: Service Concierge device sends the software control to Step 1600170 if write operation at Step 1600290 is found to be successful.
1600310: Service Concierge device prepares two messages to Concierge database and digital communication channel if write operation at Step 1600290 is found to be unsuccessful.
1600320: Service Concierge device sends a “Contact Service Adviser” message prepared at Step 1600310 to digital communication channel via an API.
1600330: Service Concierge device sends a request to Concierge database via an API to roll back the database entries written at Step 1600250.
1600340: Digital communication channel presents the customer with a “Contact Service Adviser” message.
1600350: Service Concierge device places the software control at Step 1600320 if write operation at Step 1600250 is unsuccessful.
1600360: If Service Concierge device finds that customer details are available at Step 160020, software control is placed at Step 160080.

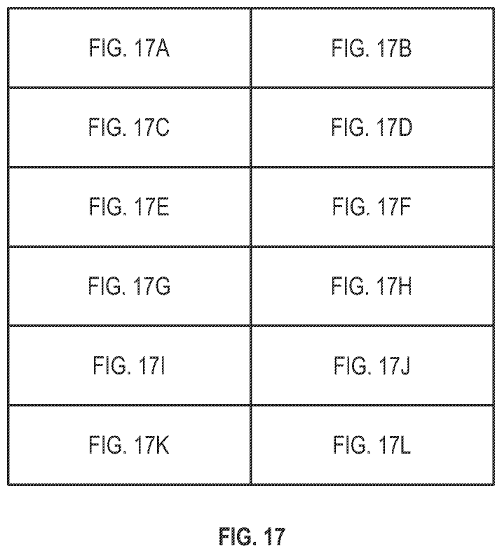

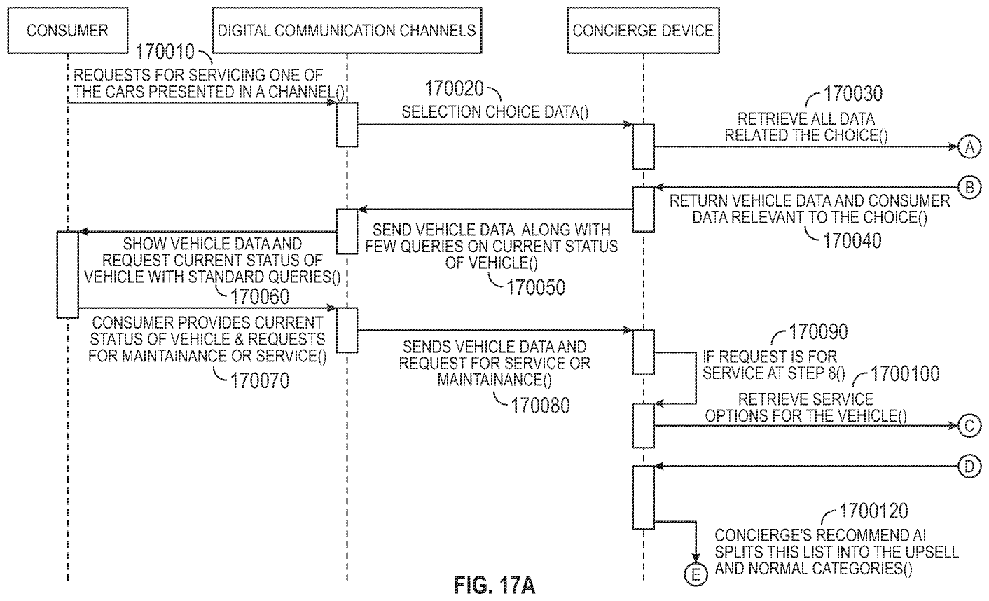

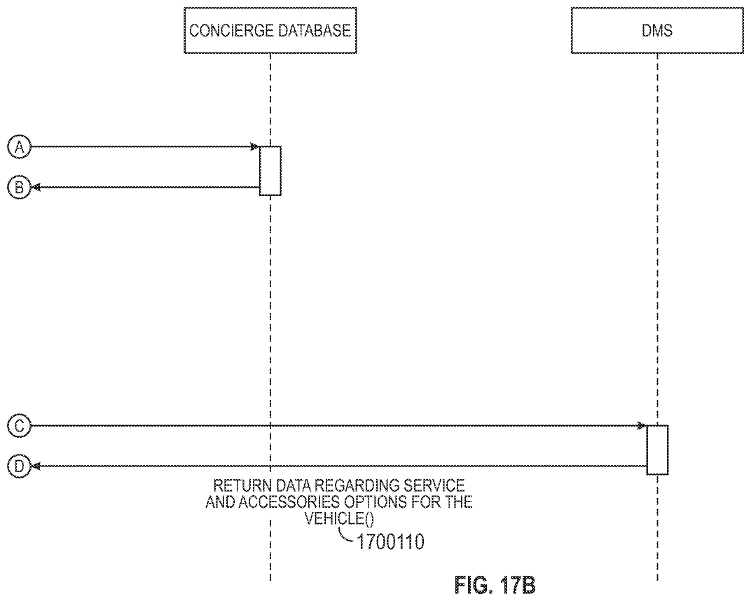

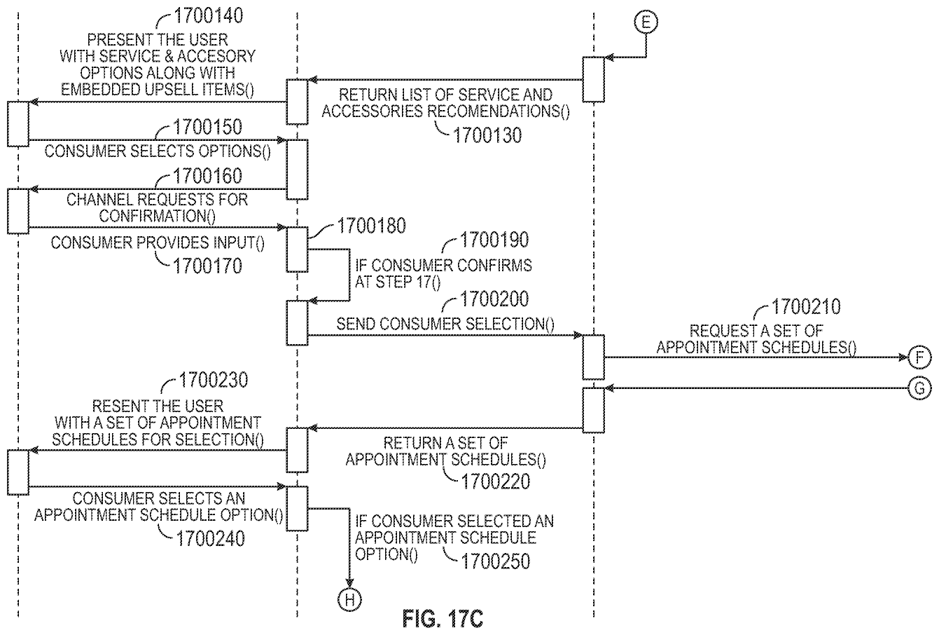

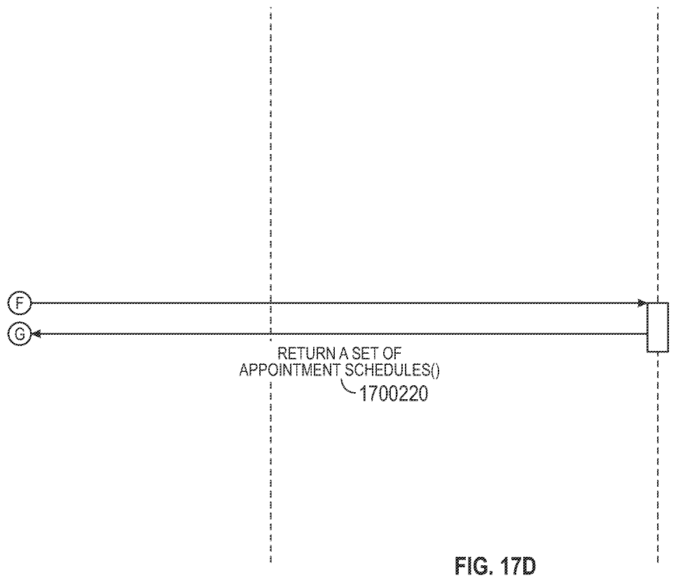

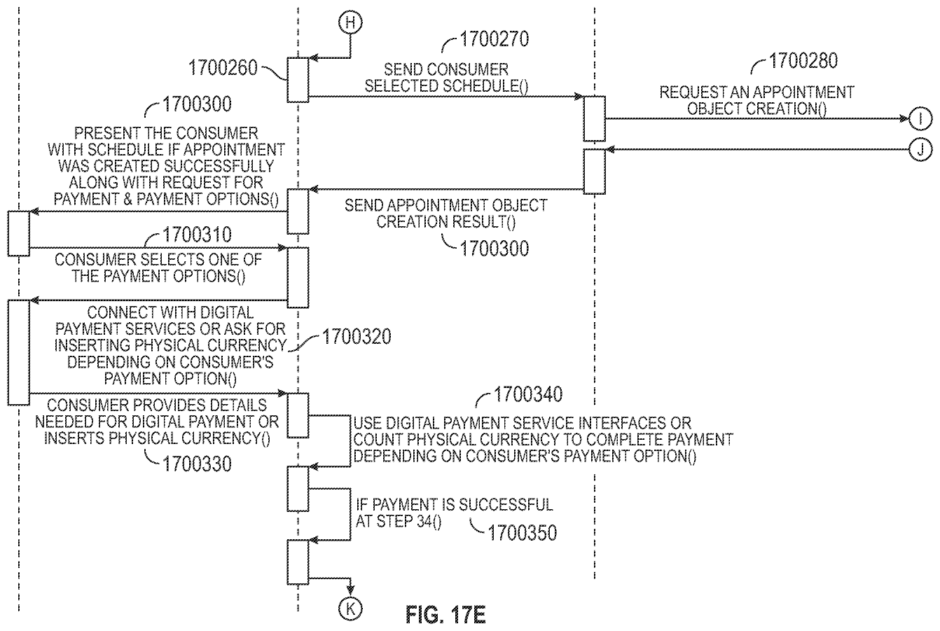

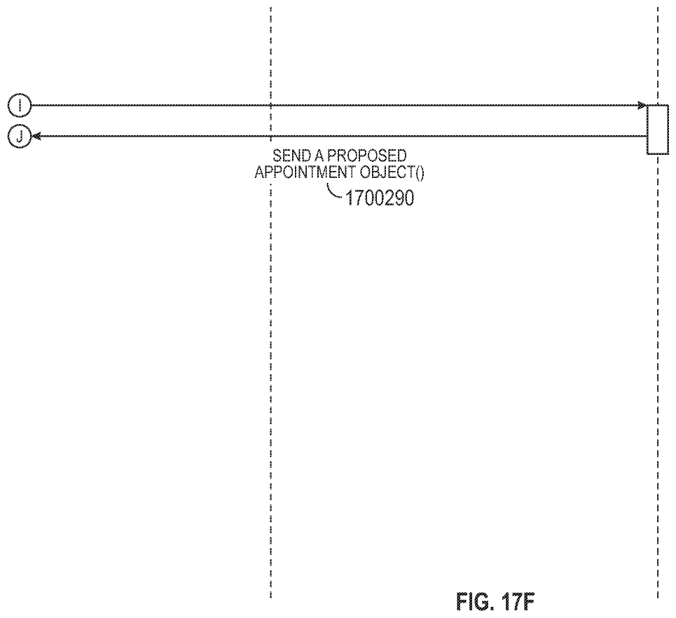

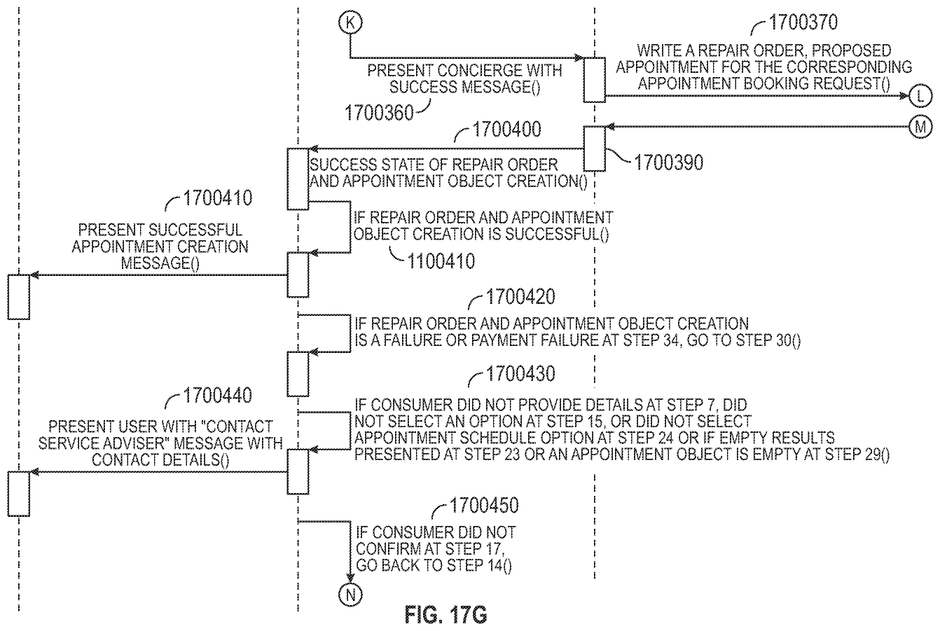

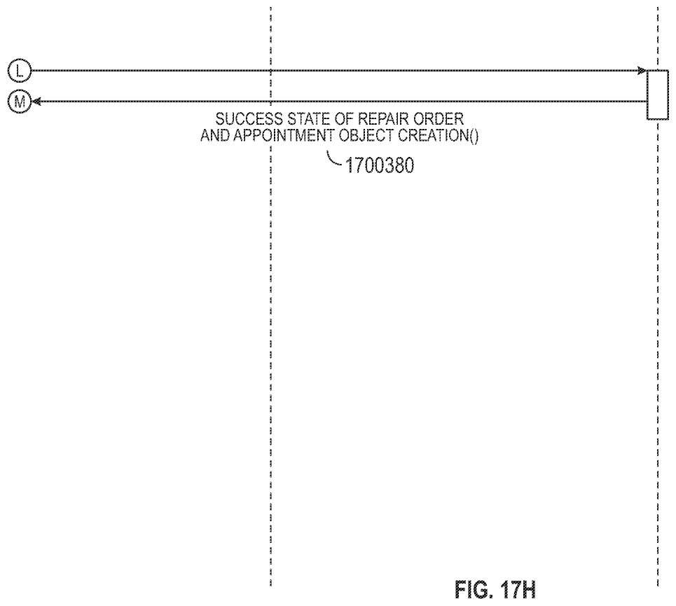

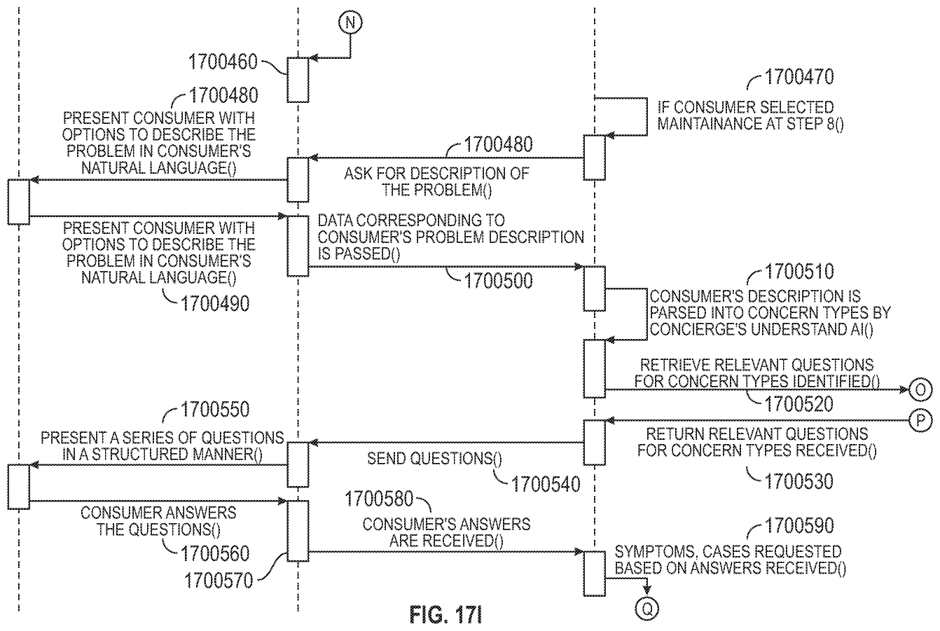

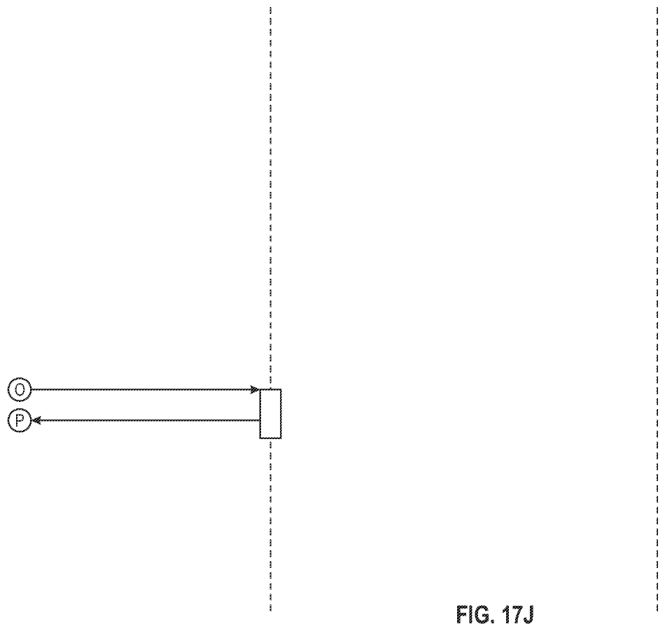

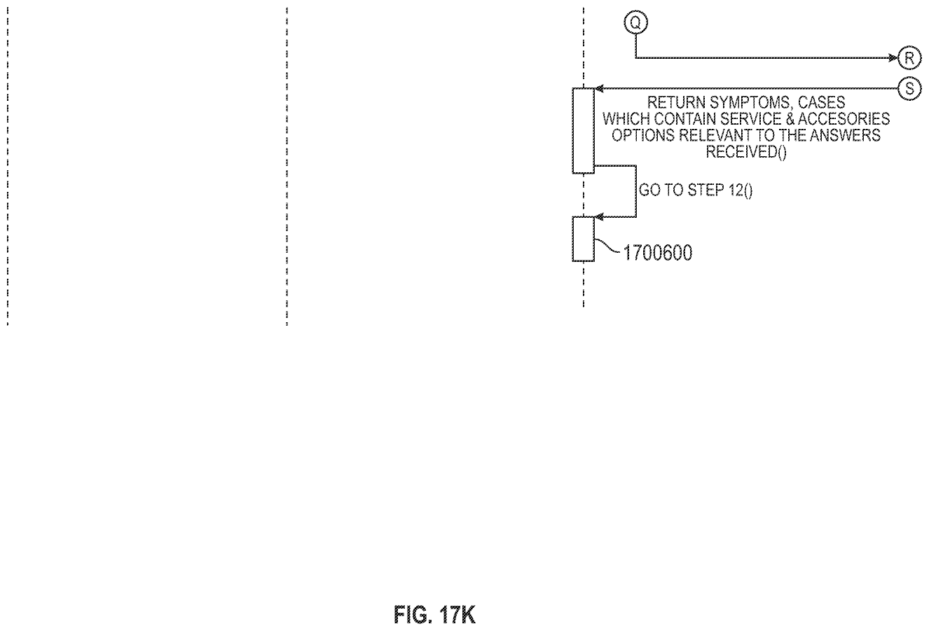

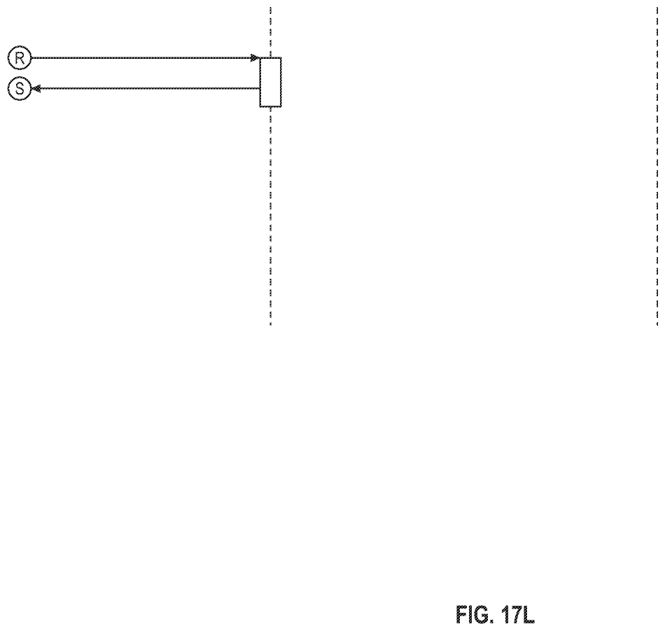

FIGS. 17A, B, C, D, E, F, G, H, I, J, K, L (Third Set of SCD System Architecture Schematic Diagrams):
170010: Customer interacts with a digital communication channel and requests for servicing one of the cars presented.
170020: Digital communication channels sends the details of the vehicle chosen by customer at Step 170010 to Service Concierge device via an API as a vehicle object. The details of vehicle include registration number, VIN.
170030: Service Concierge device sends a request to Concierge database via an API to retrieve details of vehicle object sent at Step 170030.
170040: Concierge database returns vehicle details including registration number, VIN and customer details including full name of vehicle's owner, phone number, preferred contact email address. These are results are returned by Concierge database via an API to Concierge.
170050: Service Concierge device sends vehicle data, customer data and a set of queries regarding mileage, last service date etc. via an API to digital communication channel.
170060: Digital communication channel presents the customer with data details request received at Step 170050.
170070: Customer provides the details requested at Step 170060 and selects a request for maintenance or resolving concerns about vehicle as reason for visit.
170080: Digital communication channel sends the details of vehicle received at Step 170070 to Concierge along with a request for maintenance or concern resolution via an API.
170090: Service Concierge device checks whether request details received at Step 170080 indicates a request for maintenance service.
1700100: If request at Step 170090 is for maintenance service, Service Concierge device sends a request to DMS via an API to retrieve vehicle details along with maintenance service options for the vehicle.
1700110: DMS sends service and accessories available as options for vehicle along with vehicle details via an API to Service Concierge device.
1700120: Service Concierge device triggers Concierge Recommend AI (RAI) software module. RAI uses content based and content agnostic recommendation algorithms including collaborative filtering, random forest to split the accessories and services received at Step 1700110 into upsell, cross sell and essential items.
1700130: Items listed in Step 1700120 are sent to digital communication channel via an API.
1700140: Digital communication channel presents these services and accessories in a fashion that maximizes the expected revenue for the dealership. The probability of a customer buying an accessory or a service and price of that accessory or service is used to estimate the expected revenue for the dealership. The probability of a customer buying are calculated using historical buying pattern of customers for a given accessory or service.
1700150: Customer selects one or more of the items presented at Step 1700140.
1700160: Digital communication channel requests customer to confirm the items selected by customer at Step 1700150.
1700170: Customer provides confirmation input.
1700180: Digital communication channel checks whether customer confirmation is available from Step 1700170.
1700190: If customer confirmation is found at Step 1700180, digital communication channel sends the set of services and accessories opted by customer at Step 1700150 to Service Concierge device via an API.
1700200: Service Concierge device sends a request via an API to DMS to provide a set of available appointment schedules for services and accessories opted by customer for a customer's vehicle at Step 1700150.
1700210: DMS returns a set of available appointment schedules for providing requested services and accessories at Step 1700200 via an API to Service Concierge device.
1700220: Service Concierge device sends the appointment schedules received at Step 1700210 to digital communication channel via an API.
1700230: Digital communication channel presents the customer with a set of appointment schedules received at Step 1400220.
1700240: Customer selects one of the proposed appointment schedules or rejects all of them.
1700250: A check is made by digital communication channel to see whether the customer selected an appointment schedule.
1700260: If customer is found to have selected an appointment schedule at Step 1700250, the selected appointment schedule is sent to Service Concierge device by digital communication channel via an API.
1700270: Service Concierge device sends a request to DMS to create an appointment object via an API exposed by DMS.
1700280: DMS creates and writes an appointment object based on schedule in the appointment object received at Step 1700270. DMS sends an API-based response to Service Concierge device indicating the status of appointment creation at DMS.
1700290: Service Concierge device sends appointment summary object to digital communication channel via an API.
1700300: Digital communication channels checks the appointment summary object received at Step 1700290. If the response is non-empty, it presents the customer with appointment summary, payment details and payment options for securing the appointment.
1700310: Customer selects one of the payment options.
1700320: Digital communication channel presents the customer with options to connect with digital payment services or insert physical currency into a Service Concierge machine. The digital payment services include payments with credit card, debit card, e-wallets such as Paypal, cryptocurrencies.
1700330: Customer connects with one of the digital payment services presented at Step 1700320 or inserts physical currency into a Service Concierge machine available to the customer.
1700340: Digital communication channel processes the payment made by interacting with digital payment service or initiating a count of physical currency inserted into a Service Concierge machine.
1700350: Digital communication channel checks whether payment is successfully received via either a digital payment service or successful counting of physical currency that matches with payment amount presented at Step 1700300.
1700360: Digital communication channel presents Service Concierge device with a payment success message via an API if successful payment is confirmed at Step 1700350.
1700370: Concierges device sends a request to DMS via an API to write repair order details based on items selected by customer at Step 1700190. The request includes writing appointment object against order details in a DMS database.
1700380: DMS writes order details and appointment object into a database in DMS. It sends state of write operation to Service Concierge device via an API.
1700390: Service Concierge device sends state of DMS write operation at Step 1700380 to digital communication channel via an API.
1700400: Digital communication channel checks whether status response sent at Step 1700390 indicates successful write operation at DMS.
1700410: Digital communication channel presents a success message along with appointment details for customer's reference.
1700420: If appointment creation status indicates an error at Step 1700290 or payment status is found to be a failure after Step 1700340, digital communication channel places the software control at Step 1700300.
1700430: A check is made by digital communication channel to verify
   1. whether a customer has not provided details at Step 170070
   2. whether a customer has not selected any option at Step 1700150
   3. whether a customer has not selected any appointment schedules at Step 1700240
   4. whether empty results are presented at Step 1700230
   5. whether empty appointment object is received at Step 1700290
1700440: If answer to any of these checks at Step 1700430 is found to be positive, then digital communication channel presents the customer with “Contact Service Adviser” message.
1700450: If customer does not confirm any of the items presented at Step 1700170, digital communication channel takes the software control back to Step 1700140.
1700460: Service Concierge device checks whether customer choice is maintenance at Step 170080.
1700470: If a check at Step 1700460 indicates that customer choice is maintenance, Service Concierge device sends a request to digital communication channel to ask the customer to describe the concerns of customer regarding maintenance work.
1700480: Digital communication channel presents the customer with options to describe the concerns customer has regarding customer's vehicle. It enables customer to describe the concern in natural languages such as English.
1700490: Customer describes the concerns customer has in natural language such as English which is captured by digital communication channel via media including keyboard, digital voice assistant etc.
1700500: Digital communication channel extracts the textual data from the concern description received at Step 1700490 and sends the textual data to Service Concierge device via an API.
1700510: Understand AI (UAI) hosted on Service Concierge device performs topic analysis of the textual data using text processing algorithms including latent dirichlet allocation (LDA) to derive hidden topics in textual data to obtain concern types. These concern types represent the summary of concern shared by customer.
1700520: UAI sends concern types to a database of Service Concierge device to retrieve questions and all possible answers against the combination of concern types identified. The questions and all possible answers are represented as N-ary tree where edges represent answers and nodes represent questions. The leaf nodes represent symptoms. Symptoms represent specific problems with a vehicle.
1700530: Concierge database returns dataset corresponding to the query made at Step 1700520.
1700540: Service Concierge device sends the dataset obtained at Step 1700530 to digital communication channel via an API.
1700550: Digital communication channel presents the questions, answers obtained at Step 1700540 in a depth-first traversal of tree data structure to reach leaf nodes of N-ary tree data structure holding the questions and answers.
1700560: Customer answers the questions posed at Step 1700550 in an interactive fashion which results in the customer indirectly reaching the leaf node of the N-ary tree. The answers and the leaf node reached are stored by digital communication channel.
1700570: Digital communication channel sends answers and the leaf node stored at Step 1700560 to Service Concierge device via an API.
1700580: Service Concierge device makes a request to local database to retrieve symptoms and cases related to the answers and leaf node received from Step 1700570.
1700590: A database at Concierge retrieves symptoms and cases related to answers received at Step 1700580. A further query is made to retrieve accessories and services available for the identified case. These are returned to Service Concierge device as result set.
1700600: Concierge device stores the result set returned at Step 1700590 and places the software control at Step 1700120.

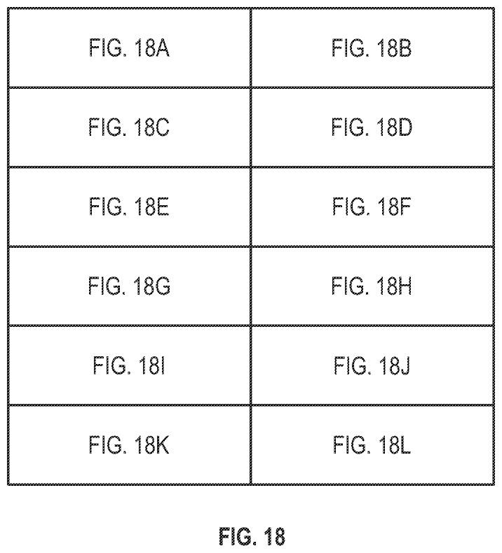

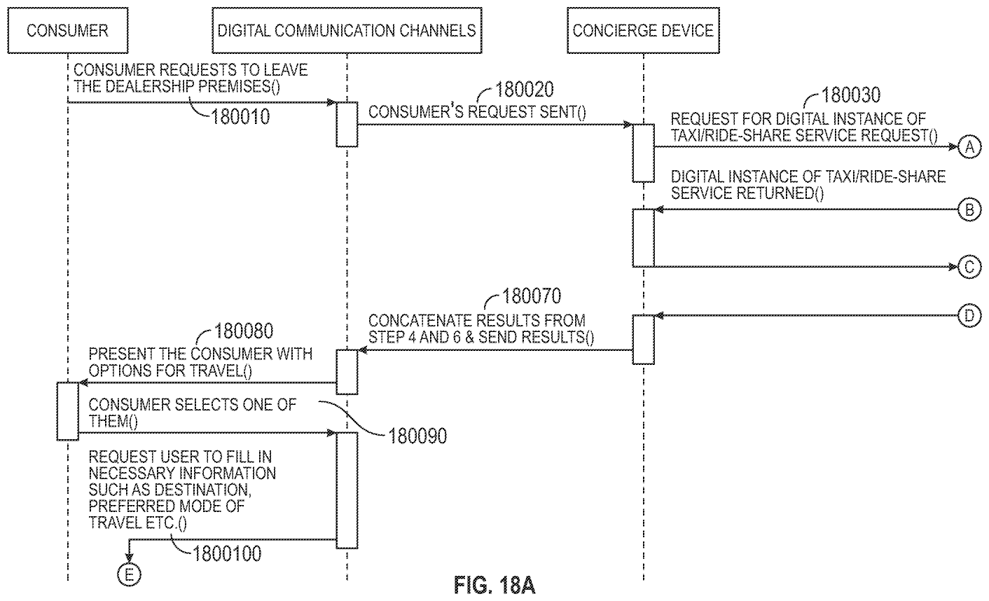

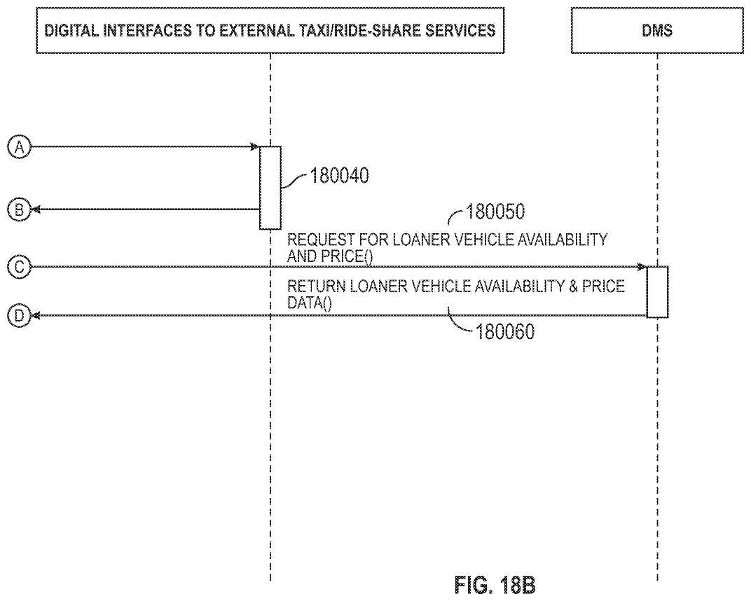

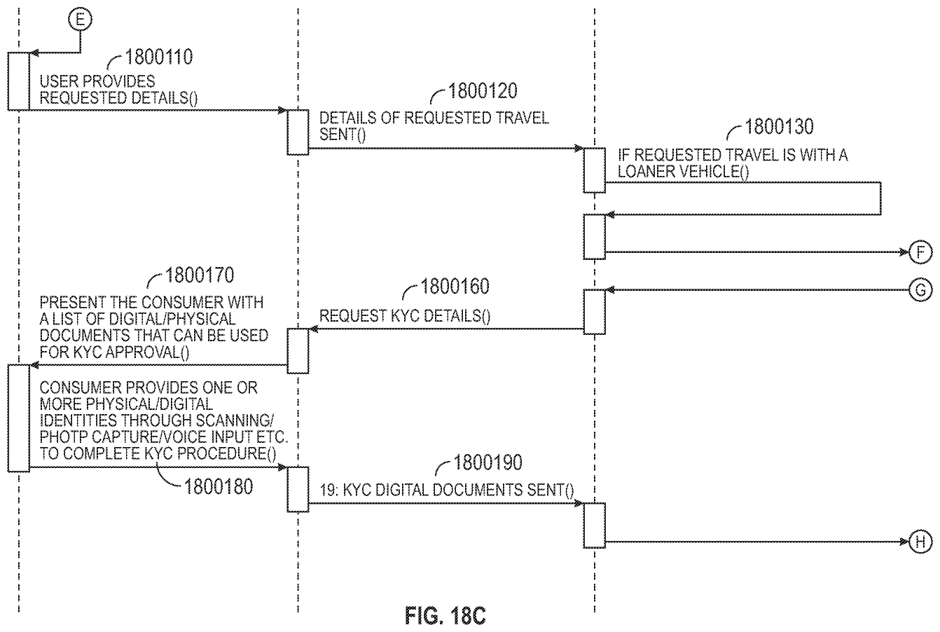

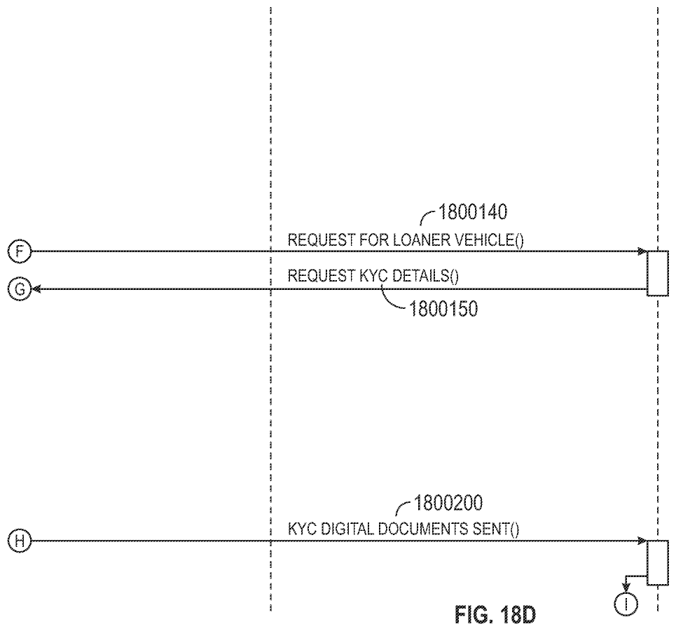

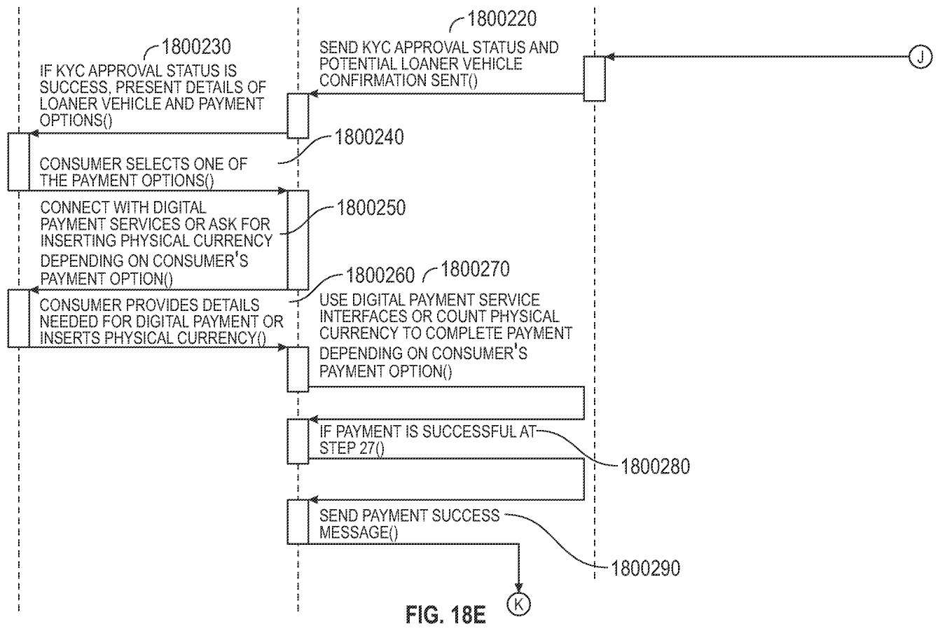

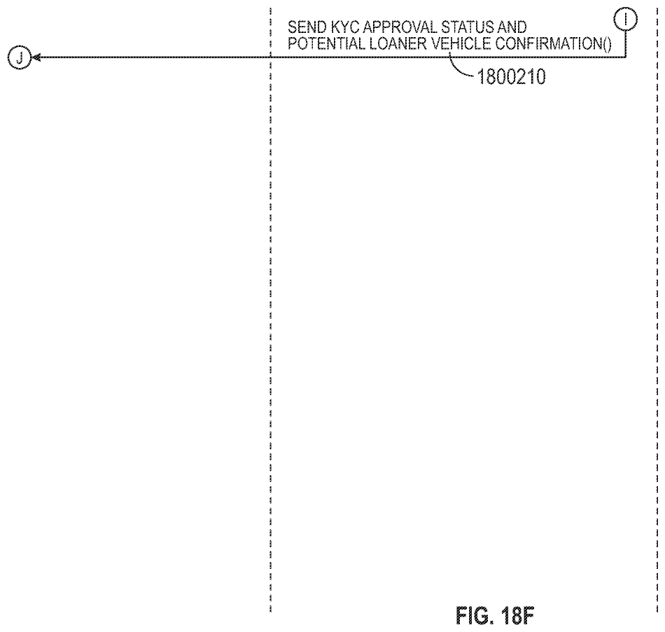

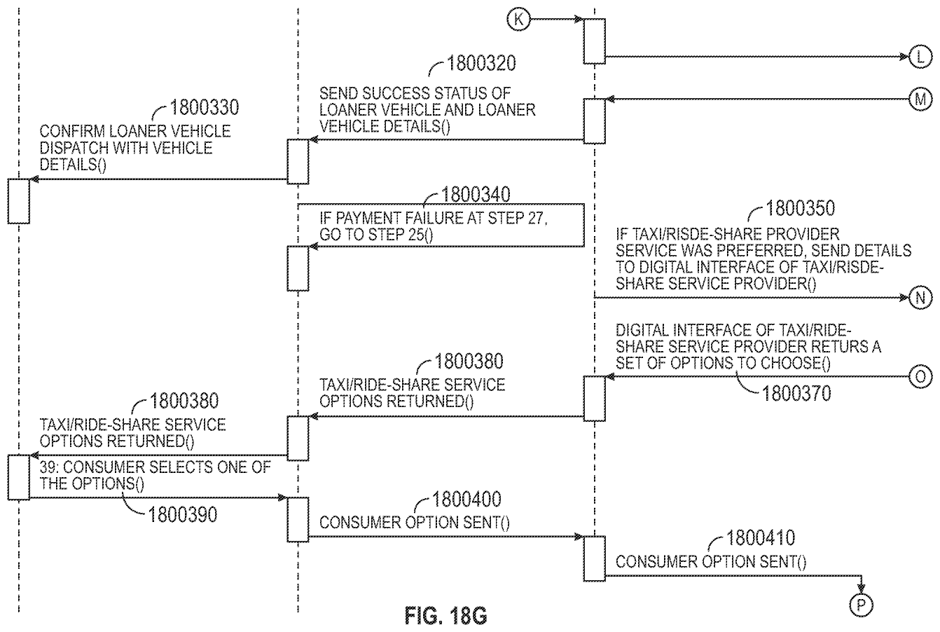

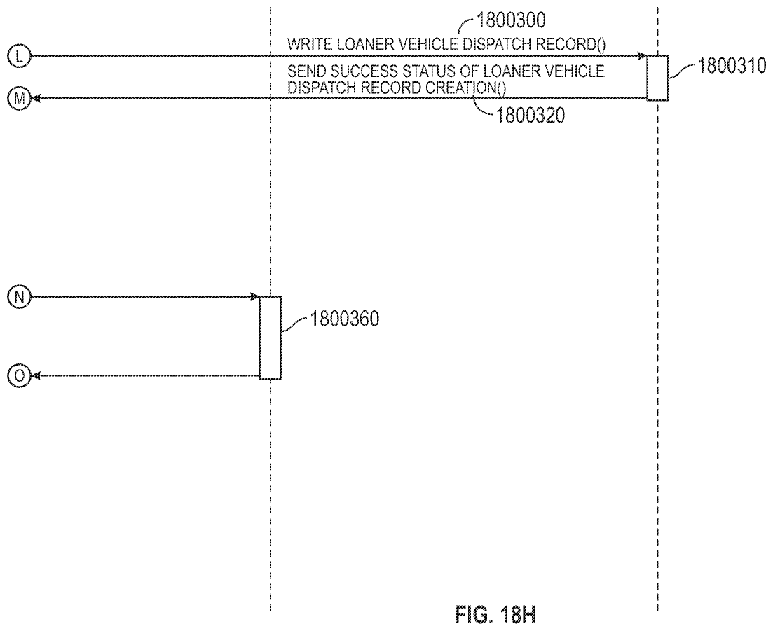

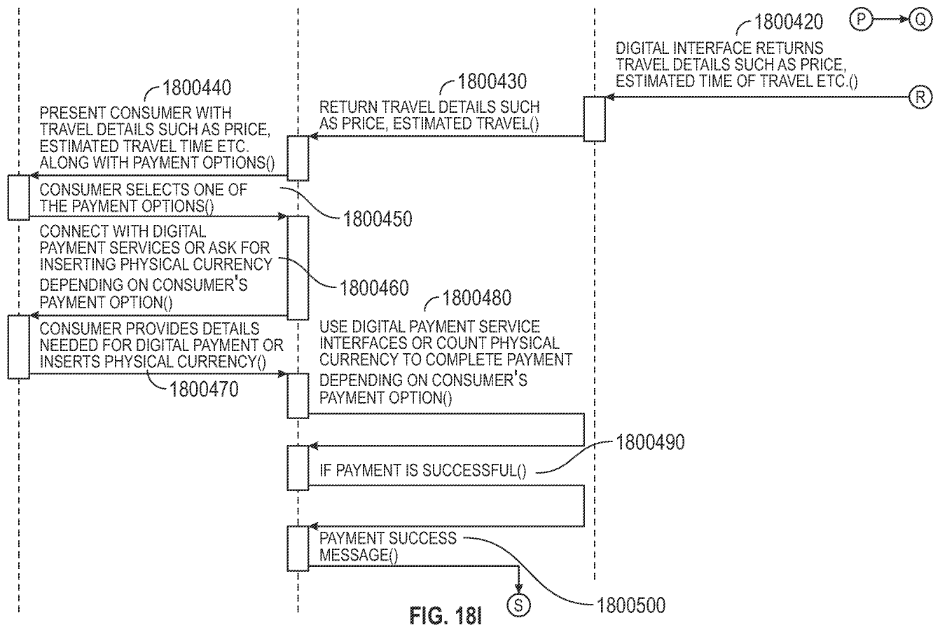

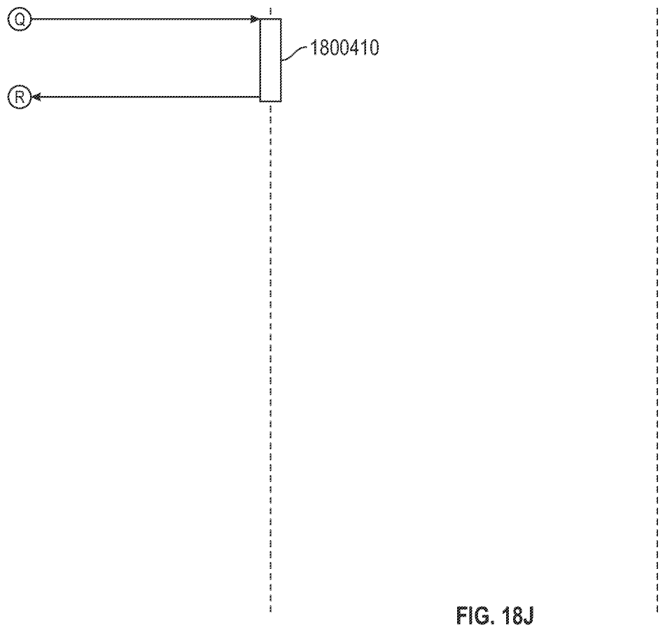

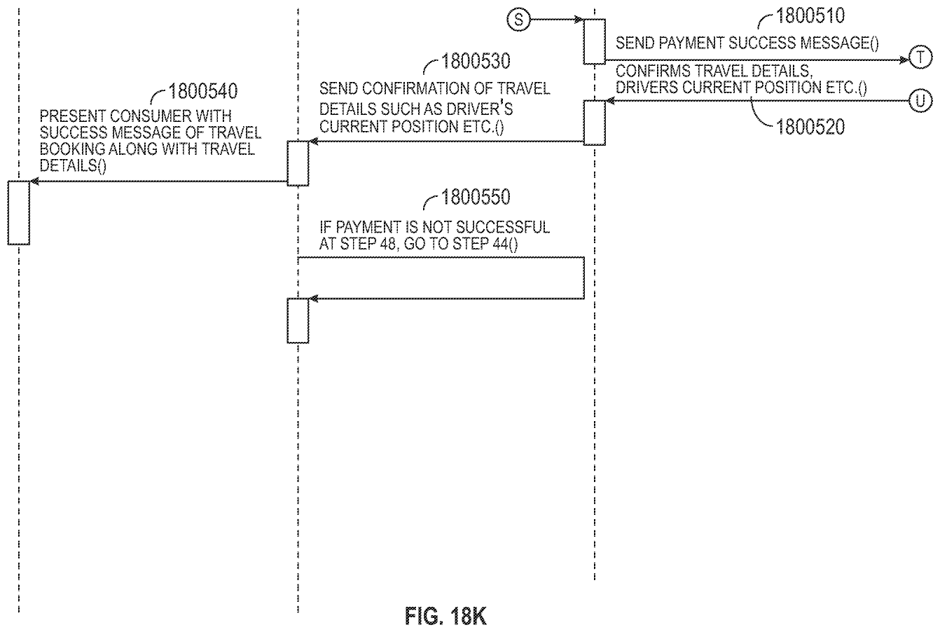

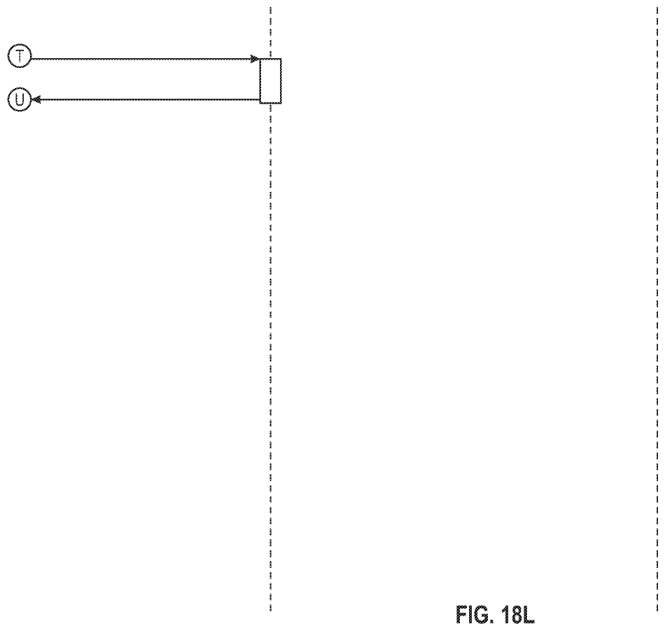

FIGS. 18 A, B, C, D, E, F, G, H, I, J, K, L (Third Set of SCD System Architecture Schematic Diagrams)
180010: Customer puts a request onto digital communication channel to leave the dealership premises.
180020: Digital communication channel sends a request to Service Concierge device regarding customer's intent to leave dealership premises along with location details of customer.
180030: Service Concierge device connects with digital interface of taxi and/or rideshare services via externally exposed APIs by these services and requests an instance of taxi and/or rideshare services based on time of customer request and location of customer at the time of request.
180040: Service Concierge device receives instances of taxi and/or rideshare services as a response to request made at Step 180030 via an API.
180050: Service Concierge device sends a request to DMS via an API to return availability and price information for loaner vehicles available at the time of customer's request at Step 180040 and in the vicinity of customer's location.
180060: DMS returns availability and price information requested at Step 180050 to Service Concierge device via an API.
180070: Service Concierge device concatenates the results from Step 180040 and Step 180060 and sends a single list of results to digital communication channel via an API.
180080: Digital communication channel presents the list of transportation options available from the list of results obtained at Step 180070.
180090: Customer selects one of the options available from the list at Step 180080.
1800100: Digital communication channel requests the customer to provide information around the intended travel including destination location, preferred mode of travel.
1800110: Customer provides details requested in Step 1800100 to digital communication channel.
1800120: Digital communication channel sends the details of requested travel to Service Concierge device via an API.
1800130: Service Concierge device checks whether requested travel involves a loaner vehicle.
1800140: If check at 1800130 indicates that requested travel involves a loaner vehicle, Service Concierge device sends a request to DMS to allocate a loaner vehicle.
1800150: DMS sends a know your customer (KYC) request to Service Concierge device with few data fields including customer's as full name, age via an API.
1800160: Service Concierge device sends the KYC request received at Step 1800150 to digital communication channel via an API.
1800170: Digital communication channel uses the KYC request data and presents the customer with a list of options indicating the digital/physical documents that can be used for KYC procedure approval by DMS.
1800180: Customer provides the digital communication with customers' digital/physical identity through various means including scanning, photo capture, voice input etc. to complete the KYC procedure for DMS.
1800190: Digital communication channel prepares the data that represent the physical/digital identity of customer based on the data received at Step 1800180. An API is used by digital communication channel to send the data to Service Concierge device.
1800200: Service Concierge device sends the data captured from Step 1800190 to DMS via an API.
1800210: DMS verifies KYC data provided by customer by analysing data from Step 1800200 and sends back a response to Service Concierge device via an API. The response potentially contains loaner vehicle information if KYC procedure is successfully carried out at DMS.
1800220: Service Concierge device sends KYC approval status including loaner vehicle information to digital communication channel via an API.
1800230: Digital communication channel checks the KYC approval status. If KYC approval status indicates a success, it presents customer with loaner vehicle details and payment options.
1800240: Customer selects one of the payment options presented at Step 1800230.
1800250: Digital communication channel presents the customer with options to connect with digital payment services or insert physical currency into a Service Concierge machine. The digital payment services include payments with credit card, debit card, e-wallets such as Paypal, cryptocurrencies.
1800260: Customer connects with one of the digital payment services presented at Step 1800250 or inserts physical currency into a Service Concierge machine available to the customer.
1800270: Digital communication channel processes the payment made by interacting with digital payment service or initiating a count of physical currency inserted into a Service Concierge machine.
1800280: Digital communication channel checks whether payment is successful at Step 1800270.
1800290: If payment is found to be successful at Step 1800270, digital communication channel sends a success message to Service Concierge device along with loaner vehicle, payment details.
1800300: Service Concierge device sends a request to DMS via an API to write loaner dispatch record based on data received from Step 1800290.
1800310: DMS writes a loaner vehicle dispatch record in its database. It sends a message to Concierge via an API. The message indicates the status of writing a vehicle dispatch record to its database and potentially contains loaner vehicle details.
1800320: Service Concierge device sends status of loaner record creation at DMS along with any details of loaner vehicle to digital communication channel via an API.
1800330: Digital communication channel presents the customer with loaner vehicle details and trip details based on data received at Step 1800320.
1800340: Digital communication channel checks whether payment is successful at Step 1800270. If payment process is a failure at Step 1800270, software control is placed at Step 1800250 by digital communication channel.
1800350: Service Concierge device checks whether customer preferred taxi/rideshare service at Step 1800120. If so, it sends the request to a particular taxi/rideshare service opted by the customer via the digital instance of that taxi/rideshare service obtained at Step 180040.
1800360: Digital interface of taxi/rideshare service activated by digital instance at Step 1800350 returns a list of travel options available for the customer. The communication between digital interface of taxi/rideshare service and Service Concierge device is handled by an API.
1800370: Service Concierge device sends list of travel options to digital communication channel based on data received at Step 1800360.
1800380: Digital communication channel presents the customer with a list of travel options available with the taxi/rideshare option chosen by customer at Step 1800120. Data received at Step 1800370 is used to present such a list of travel options.
1800390: Customer selects one of the travel options presented at Step 1800380.
1800400: Digital communication channel sends the travel option selected by customer at Step 1800390 along with details of the travel to Service Concierge device via an API.
1800410: Service Concierge device sends the travel option and travel details to digital interface exposed by taxi/rideshare service provider preferred by customer at Step 1800390.
1800420: Digital interface hosted by customers' preferred taxi/rideshare service sends back details of travel including cost, estimated time of travel, driver details to Service Concierge device. This is in response to the request made by Service Concierge device at Step 1800410.
1800430: Service Concierge device sends the details of the travel received at Step 1800420 to digital communication channel via an API.
1800440: Digital communication channel presents the customer with details of travel such as cost, estimated travel time, driver details etc along with payment options.
1800450: Customer selects one of the payment options presented at Step 1800440.
1800460: Digital communication channel presents the customer with options to connect with digital payment services or insert physical currency into a Service Concierge machine. The digital payment services include payments with credit card, debit card, e-wallets such as Paypal, cryptocurrencies.
1800470: Customer connects with one of the digital payment services presented at Step 1800460 or inserts physical currency into a Service Concierge machine available to the customer.
1800480: Digital communication channel processes the payment made by interacting with digital payment service or initiating a count of physical currency inserted into a Service Concierge machine.
1800490: Digital communication channel checks whether payment is successful at Step 1800480.
1800500: If payment is found to be completed at Step 1800590, digital communication channel sends a success message to Service Concierge device along with payment details via an API.
1800510: Service Concierge device sends a message to digital interface of taxi/rideshare provider that responded at Step 1800420. This message indicates a successful payment and is sent via an API.
1800520: Digital interface of taxi/rideshare service preferred by customer responds back to Service Concierge device with details of travel, including taxi/rideshare vehicle's current location, estimated arrival time at customers' location for pick up. This response is due to the message sent by Service Concierge device at Step 1800510.
1800530: Service Concierge device shares the details of travel received at Step 1800520 with digital communication channel via an API.
1800540: Digital communication channel presents the customer with travel details using the information received at Step 1800530.
1800550: A check is made by Service Concierge device to see whether payment process is successfully completed at Step 1800480. If payment process is found to be unsuccessful, software control is placed at Step 1800440 by Service Concierge device.

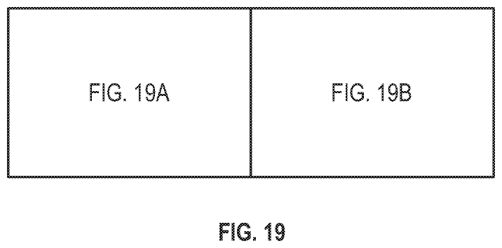

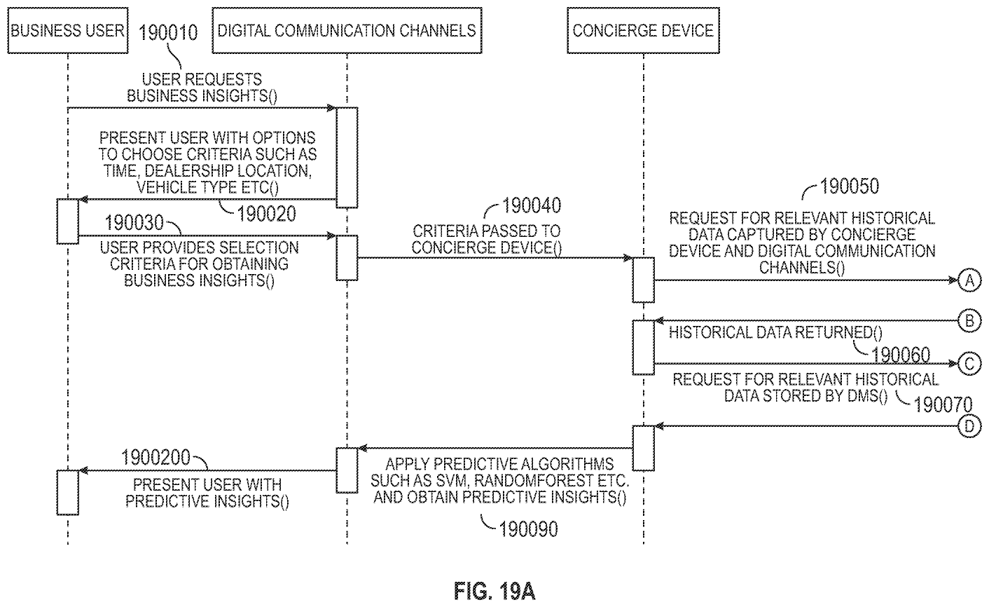

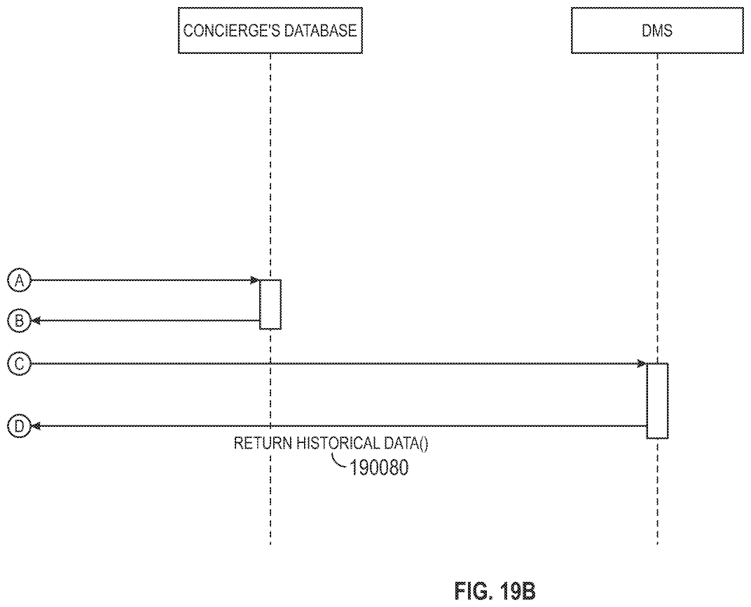

FIGS. 19A and B: Fourth Set of SCD System Architecture Schematic Diagrams
190010: A business user requests business insights through a digital communication channel.
190020: Digital communication channel requests the business user to provide data filtering criteria including dealership location, vehicle type, time range among others.
190030: Business user provides data filtering criteria requested by digital communication channel at Step 190020.
190040: Data filtering criteria captured at Step 190030 is sent to Service Concierge device by digital communication channel via an API.
190050: Service Concierge device requests databases at Concierge to retrieve historical data captured by Service Concierge device and digital communication channel which interact with Service Concierge device to provide customer data.
190060: Databases at Concierge return data requested at Step 190050 to Service Concierge device.
190070: Service Concierge device requests DMS to retrieve data that are related to the data retrieved at Step 190060. This request is made via an API.
190080: DMS returns datasets that match the data retrieved at Step 190060 and sends back the results to Service Concierge device via an API.
190090: Service Concierge device applies various supervised machine learning algorithms including Random forest, support vector machines and unsupervised machine learning techniques including infinite mixture models, Bayesian graphical models to derive predictive insights on the datasets retrieved at Step 190060 and Step 190080.
1900200: Present user with predictive insights via audio/visual, or audio and visual or both in written report form and where the data is transferred as needed.

FIG. 20 is a schematic diagram that indicates the procedures and operations for the SC Devices and associated systems including implementation of the AI modules as follows. An owner of a vehicle who is a customer (2001) that utilizes a number of businesses including dealerships, manufacturers etc. needs support regarding three major aspects in order to maintain a vehicle in a smooth and drivable running condition. More specifically, one embodiment of this procedure is as follows;
1. Service appointment booking (2010): A customer needs support in booking appointment for vehicles owned by the customer. This support needs to be available at vehicle dealerships, other servicing facilities and on various digital platforms such as mobile applications, inbuilt digital voice assistants in vehicle among others.
2. Self-check-in and check-out (2020): A customer needs to check-in and check-out from a vehicle dealership or a servicing facility using various hardware, software systems available at those facilities. This needs to involve minimal human interaction so that dealerships can provide services to customers in an economically viable fashion.
3. Update and notifications (2030): A customer needs support for updating real time, near real time updates and notifications about progress of various on-going vehicle repair/servicing operations along with any upcoming appointments.

A vehicle dealership organization (2090), vehicle manufacturer, and other stakeholders (2085) that operate in the automobile and mobility industry need support from IT (information technology) systems that can manage vehicle delivery, vehicle servicing, replenish vehicle accessories and other related stock items as well as determine and assign tasks in these organizations (2090, 2085) to optimize costs etc. These two major categories of stakeholders also need software and hardware systems that can provide business insights by deploying advanced analytics so that cost optimization and revenue generation targets can be accomplished effectively by employees in these organizations. Employees in these organizations also need real time and/or near real time updates and notifications (2095) regarding the progress of various on-going vehicle repair/servicing operations along with any upcoming appointments so that they can be efficient in their operations and increase customer satisfaction.

The Service Concierge device (SCD) handles and supports the needs of these stakeholders using a combination of hardware, software, and database systems and integration with third party software systems that are available on-premise or on cloud-based technologies. SCD hosts and/or connects with hardware and software ecosystems such as kiosks, digital voice assistants, and gesture-based interaction hardware devices including computer terminals and displays, networked computer devices, cell and smart phones, and other systems to provide on-premise or remote service appointment booking facilities (2015) that satisfy customer needs around service appointment booking (2010). SCD hosts and/or connects with digital interfaces mentioned above (2023) to support self-check-in and check-out facilities (2020). A notification engine (2035) is hosted by SCD to provide customers with updates regarding vehicle repair and maintenance work. It facilitates easier transactions by connecting stakeholders (2001, 2090) with 3^{rd} party software systems (2050) that facilitate payments, equity mining of vehicle to check for new vehicle upgradations, booking taxi, rideshare facilities among others. It hosts software modules (2045) to accomplish the connection and communication between stakeholders and 3^{rd} party software systems. SCD hosts a set of software modules (2070) which interact with dealership management systems (DMS) hosted by dealerships (2090) to support the needs (2015, 2023) of vehicle owners.

In order to satisfy the requirements of dealerships and manufacturers (2090, 2085), SCD hosts business intelligence software modules (2055) which derive predictive insights (2080) into business operations to achieve operational efficiency across organizations. These software modules interact with artificial intelligence (AI) modules (2070) on SCD which analyze and understand customer complaints, customer buying behavior and customer demographic profiles in order to gain deep insights about customers. SCD hosts a set of hardware, software and database systems (2040) to provide the functionalities to all stakeholders (2001, 2085, 2090).

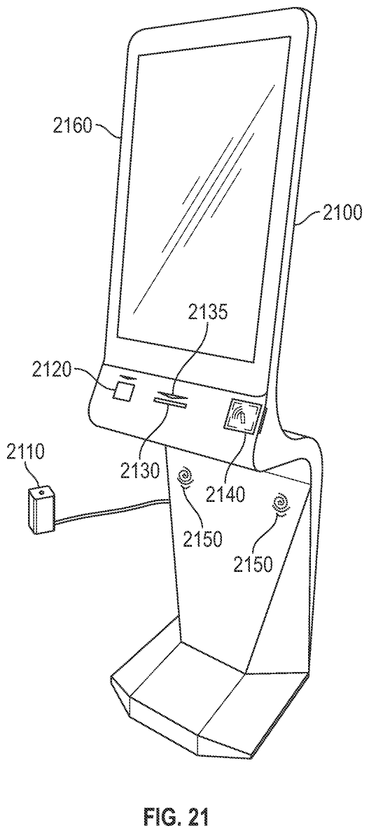

FIG. 21 is 3-D representation of the use of a kiosk and stand combination (2100) which includes a stand with speakers (2150) and an electrical cord for plugging into an electrical box (2110), complete with several additional functionalities that include but are not limited to a switch for powering on (2120), slots for processing credit cards and cash bills/coins (2130 and 2135), one or more scanners for key fobs, biometrics analysis, Q and bar code readers which can interact with computer terminals, laptops, fax machines, cell and smart phones, etc., as well as with autonomous and driverless vehicles, and a terminal display and/or touchscreen (2160).

Description of the Service Concierge (SC) Understand AI Module

The Service Concierge's Understand AI module interacts with a customer to determine (in many cases by interpreting) problems that the customer's vehicle is facing and conclude with a set of potential service operations needed to resolve the problems with the vehicle. Specifically, the Concierge's Understand AI module involves computing processes to analyze concerns that a customer expresses in their natural language via text, voice etc. regarding his/her vehicle. Once the Concierge's Understand AI module determines the vehicle's problems, known as Concern Types, the module via AI and software analytics with, in many cases, hardware interfaces, presents the customer with a set of interactive questions which are further used to conclude how to address specific vehicle problems or Symptoms. These symptoms have corresponding Cases which are descriptive of specific repair operations to be carried out to resolve symptoms regarding the vehicle.

The Service Concierge Understand AI module acts as an artificial bridge between customers who have problems with an owned vehicle and service technicians who can repair a vehicle to resolve its problems. This essentially eliminates the need for most if not all service adviser personnel. Currently, a service adviser can interact with a customer and determine possible Concern types, Symptoms and Cases relevant to a vehicle with various issues and needs and assign service repair tasks to service technicians. The Concierge Understand AI module achieves the important task of handling more than one customer at any given time. This is not possible for human service adviser personnel. This module makes it possible for the SC to provide scalability in customer interaction as well as vehicle problem analysis but is just not achievable with human personnel.

In addition, the Service Concierge Understand AI module analyzes text corresponding to the issues described by a vehicle consumer to derive Concern types. The SC extracts such data from digital communication channels which can receive and transmit data in formats such as keyboard input, voice etc. Digital voice assistants such as Alexa, Google Assistant etc are deployed/interfaced with these digital communication channels. These channels can be securitized and encrypted by methods described in U.S. Pat. Nos. 10,154,015, 10,154,016, 10,154,021, 10,154,031, 10,158,613, 10,171,435, and 10,171,444, the full contents embodiments and claims of which are hereby incorporated by reference The SC Service Concierge Understand AI module(s) utilize textual topic analysis models such as Latent Dirichlet Allocation (LDA), Explicit Semantic Analysis (ESA), and Named Entity Recognition (NER) tools such as Stanford NER and structured information extraction services such as DBpedia Spotlight to derive Concern types from the free text corresponding to one or more descriptions of at least one vehicle's problems. Furthermore, sentiment analysis of the free text is performed to infer the sentiments of the consumer such as “frustrated”, “little concerned”, “angry” etc. This is achieved through pre-processing steps such as stop-word removal, tokenization etc. and then applying lexicon based supervised classifiers such as Support Vector Machine (SVM). Advanced analytics are applied in cases where the accuracy of classifiers is found to be below a predetermined threshold score of acceptance. This score is derived from the evaluation of sentiment label accuracies achieved when derived emotion labels are compared to the ground truth initially generated by human evaluators. The predetermined threshold will change according to the advanced training and subsequent knowledge that the SC can achieve over time. Advanced analytics metrics such as Jensen-Shannon divergence, Entropy scores and clustering techniques such as K nearest neighbor (KNN)-, as well as Infinite Mixture Models can be applied to achieve similarity and/or distance scores that are obtained via standard emotion labels and preprocessed text.

Once the Concern types are identified by Service Concierge Understand AI module, the SC device(s) will retrieve the questions that correspond to the Concern types from one or more Symptoms databases. These questions have multiple sources and options for providing the customer/consumer with answers. Depending on the data derived from new and existing databases the SC will then retrieve the answers corresponding to these questions from the one or more Symptoms databases. These questions and answers can be presented as N-array tree data structures that represents networked data structures where questions can be represented as nodes and edges (which define a tree data structure) to ascertain answers. Typical questions include “What is the color of fluid leaking from the engine?”, “When do you receive a rattling sound on the windscreen?” etc. Each combination of Concern types will have its own N-array tree for Symptoms. The leaf nodes of the tree represent various Symptoms obtained in the form of data from the databases. Questions can be presented to a consumer by digital communication channels such as digital voice assistant e.g., Alexa, Google assistant etc., as well as touch screen based kiosks among the numerous software/hardware I/O devices available. Answers (responses) provided by the customer consumer are returned to SC devices and via AI and database capabilities, the responses/answers are matched with the initial queries/questions to achieve an ever-evolving dataset that is self-improving as it receives additional data. The data must be parsed to achieve the proper use of the learning algorithms developed with various forms of machine language (ML) techniques.

This question and answer (querie and response) session(s) between digital communication channels and the customer/consumer results in an in-depth first traversal of a N-array tree. Reaching the leaf node of the tree stops the traversal of the tree, as a leaf node represents a Symptom. Consumers/customers are presented with an option to start the question-answer session(s) from the beginning by utilizing digital communication channels that includes transmitters and receivers and/or transceivers. This allows the user to input multiple Symptoms data during a given interaction session with a digital communication channel. Once the SC devices interprets one or more symptoms relevant to a customer's vehicle, it queries the Cases database and suggests a list of repairs and/or accessories for approval by the consumer/customer via the digital channel preferred by the customer. Note that an N-array tree structure corresponding to a Symptom in the Symptom database is periodically updated based on feedback from manufacturers, expert service technicians, service advisers and other service and/or non-service personnel that can contribute to the data within the various Symptom and Cases databases. As stated earlier, the feedback data obtained from these professionals and manufacturers is also used to update Symptoms and Cases databases.

Description of the Service Recommender AI Module

Here, the SC device retrieve a set of services and/or accessories for at least two possibilities. If a consumer selects maintenance for a vehicle, a list is provided with of all the services and accessories associated with the specific vehicle which is retrieved from the DMS based on vehicle information supplied by the customer/consumer. If a customer/consumer selects services for a vehicle, the SC will determine Concern issues from data existing or being added/removed from the Concern, Symptom, and Cases database(s) by employing the Service Concierge Understand AI module. Once relevant Cases are understood and provided, the SC device(s) will retrieve a list of all services and accessories related to the cases identified. The SC device(s) exist to provide an increase in revenue of dealerships and other vehicle dependent businesses by providing the opportunity to upsell services and/or accessories to consumers. The SC recommends to the customer/consumer with an assortment of upsell services and/or accessories. The goal for the dealership/business is to obtain the highest expected revenue. Expected upsell revenue is a product of probability that an upsell item will be purchased by a given customer and the cost of the upsell item is normally much less than the price passed onto the customer. In order to accurately determine the upsell probability of an item based upon a customer profile, the SC utilizes a combination of content-based and content-agnostic systems, which are two broad classes of recommender schemes.

Content-based systems analyze content of products, for example textual description, and historical transactions, as well as customer profile similarities with other customers to predict the probability of purchase by a user/consumer/customer. Simple text processing techniques include stemming and tokenization which are used for analyzing textual descriptions of products. Bayesian networks that can respond to conditional probabilities for any nodes are deployed to derive the upsell probabilities. Historical upsell and buying data which is stored, retrieved and analyzed as needed from appropriate databases or via streaming data transceived to and from the SC during the course of business transactions are used to train the network nodes of the Bayesian network. Customer profile similarities are derived using distance metrics such as cosine distance. The SC device(s) implement various versions of affinity analyses that include for example market basket analysis in situations where extensive data is not available for a specific customer. The SC device(s) do not consider the textual content of items/vehicles/customers with respect to the deployment of content-agnostic methods. Instead it considers the values of data attributes for historical data and values of data attributes for the most current data that is obtained and represents the consumer/customer's trends and consumer's vehicle needs to derive upsell probabilities.

The SC device(s) utilize a wide selection of content which is provided to Service Concierge recommender AI module and includes at least the following data:
a. Vehicle year/make/model
b. Previous vehicle service history
c. Vehicle owner's previous purchase habits
d. Similar vehicles historical repair orders information
e. Time of year (eg. offer winter tires in December)
f. Current weather (eg. offer wiper blades when wet weather exists or is forecast)
g. Dealer preference settings (eg. mandatory upsell items).

This data and associated information is combined with behavioral results based on historical customer purchase decisions that enable the Concierge Recommender AI module to provide accurate upsell probabilities and in turn expected upsell revenue for various combinations of upsell recommendations by utilizing computer(s) and/or network systems that analyze data and provide useful results based on the data analysis. The upsell item combinations that result in maximum upsell revenue are presented to a customer/consumer via digital communication channels for data transceived to and from (transmitted and received) the SC device(s).

Description of the Service Concierge (SC) Predictor AI Module

The Service Concierge Predictor AI module is a software module that operates together with and can reside within or external to the SC device(s) that is responsible for delivering descriptive, predictive and prescriptive business insights for vehicle dealerships, associated vehicle businesses and any of the stakeholders. The Service Concierge Predictor AI module provides unique data type that utilizes the ability to provide accurate predictions and unique business insights for these vehicle businesses. The Service Concierge Predictor AI module is an improvement over the state-of-the-art predictive analytics solutions available today. The Service Concierge Predictor AI module uses not only the data stored in DMS and related databases with data derived from dealerships and associated businesses but also generates data using digital communication channels that are either housed within SC device(s) or from external data and databases. This unique and constantly updated data includes a consumer's description of a vehicle's problem, consumer's emotion(s), Concern types detected by Service Concierge Understand AI module, etc. This continuously improving data (in terms of useful data capture) and data analysis is based upon at least Consumer interaction data and Vehicle interaction data. The Vehicle interaction data includes customer's vehicle data captured by sensors that utilize digital communication channels including vibration sensors in addition to additional data captured from vehicles.

Current predictive analytics solutions do not have access to the consumer interaction data and vehicle interaction data. Current predictive analytics solutions use only transactional data that are available in DMS systems and related databases. The unique consumer interaction data and vehicle interaction data available on SC device(s) are transformed by Service Concierge Predictor AI module using techniques that include log transformation, and binarizing categorical predictor variables. This allows the Service Concierge Predictor AI module to generate business analytics including at least those listed below.

A) Real-time service visit outcomes and customer behavior predictions based on the VIN number of a vehicle which either enters the workshop/garage or is scheduled for service). The list below is not intended to be all inclusive but at least a portion of the business analytic capabilities available by utilizing the SC and SC Predictor module(s)—there may be more than one Module;
1. Predict what items will be recommended
2. Predict what will be sold (parts and labor\Predictions based on time and mileage, maintenance items that would be sold
3. Predict what will be the final repair order value
4. Predict the total number of hours the vehicle will be in the bay/workshop.
5. Predict what level technician will be required
6. Predict what equipment will be required for repairs/maintenance/upgrades
7. Predict parts stock requirements
8. Predict and optimize the utilization of loaner vehicles
9. Predict which staff member should interact with the owner

B) Business intelligence predictive reports (Dealership/associated business analytics dashboard)
1. Predict future shop revenues
2. Predict future shop efficiency
3. Predict future staffing needs
4. Predict future bay needs
5. Define and predict most efficient process models
6. Predict future average and broken down by vehicle make/model/year repair order values
7. Predict future parts inventory requirements
8. Predict the number of service vehicles to be traded in and upgraded
9. Predict most appropriate time to present the customer with an offer for trade-in

The data input required to create a predictive analysis model includes but not limited to the following:
a. Historical repair order information (booked service items, recommended items, sold items) from
   i. Particular store
   ii. Region
   iii. Vehicle brand and model
b. Historical vehicle owner's spending patterns
   i. Type of recommendations previously purchased
   ii. Percentage of recommendations previously purchased
   iii. Dollar amount spent per visit
   iv. Service visit frequency
c. Time of day when the vehicle arrived at the store
d. Technician's number of recommendations
e. Technician's value of recommendations
f. Technician's recommendation rate based on year, make, model and mileage
g. Advisor close rate on recommendations percentage
h. Advisor close rate on customer pay recommendations
i. Advisor recommendation rate based on year, make, model and mileage
j. Vehicle make/model/year/mileage
k. Driver's age group/gender/location
l. Time of year/month/weather
m. Dealership location
n. Dealership business hours
o. Number of shop bays
p. Number of shop technicians
q. Number of advisors
r. Repair order/hours sold and number of technicians ratio
s. Repair order/hours sold and number of bays ratio

AD-HOC Predictive Analysis Process: Repair Recommendations with Customer Decision Predictions

The Service Concierge Predictor AI module utilizes a combination of content-based analysis of historical repair orders together with a content-agnostic analysis of a combination of the above-mentioned data input factors. The Service Concierge Predictor AI module performs content-based analysis of the content of historical repair orders, their textual description of line items recommended and sold, and based on historical transaction outcomes, predicts the probability of vehicle owner's purchase behaviors. Historical transaction data, consumer interaction data, vehicle interaction data related to a vehicle are used to derive features for content-agnostic predictive algorithms. The underlying concept is that similar customers, driving similar vehicles, in similar locations, etc, normally approve similar recommendations. Affinity analysis such as market basket analyses are utilized by the Service Concierge Recommender AI module to recommend a group of services and/or accessories available for upsell. The Service Concierge Predictor AI module analyzes the probability or likelihood of upsell items purchased by a customer/consumer.

Input Data

The Service Concierge Prediction AI module uses historical data regarding previous vehicle service visits by consumers/customers. For each such appointment, the SC Prediction AI module uses data about the vehicle (such as its model, mileage, year of production, history of previous repairs), data about the client (e.g. demographics, ideally historical vehicle spending patterns, state of mind in various settings and at various times) and spatio-temporal data such as date of visit (the time of year might be relevant) and location. The Service Concierge Prediction AI module automatically selects those independent variables or predictors that have greatest predictive power. Techniques such as Lasso regression are used to pick these variables based upon historical data to ensure that maximum predictive accuracy attainable for a given dataset is achieved by SC Prediction AI module. Supervised predictive algorithms including SVM (support vector machines), neural networks, random forests, etc. have been implemented and are utilized by the SC Predictive AI module.

Additionally, to calculate quantities that are dependent on manufacturer, consumer and the vehicle, SC device(s) utilizes data from manufacturers and predictive insights provided by Service Concierge Predictive AI module which utilizes Consumer interaction data and vehicle interaction data. For example, insights regarding the total number of hours one or more vehicles remain in a bay/workshop and equipment that will be required for service/repair depends on data from the manufacturer, driver/customer/consumer/caretaker of a vehicle along with historical data of the vehicle.

The Service Concierge Predictor AI module also provides ad-hoc, real-time predictions for each vehicle service visit as an appointment or repair order is generated. The Service Concierge Predictor AI module also utilizes machine learning techniques (part of the AI capability) for predicting various business metrics that are of interest to a dealership, vehicle associated businesses and stakeholders (e.g. type of repair). The Service Concierge Predictor AI module auto-adjusts its predictive accuracy performance by deploying a series of supervised machine learning algorithms on a test dataset where ground truth (initial data set based on actual data captured) of response variables is known and employs data and data analysis resulting in maximum accuracy for those tasked with the need for business analytics.

It is to be understood that the disclosure is not limited to the exact construction illustrated and described above, but that various changes and modifications may be made without departing from the spirit and scope of the invention as defined in the following claims. For example, the present disclosure also includes sending an electronic message to the customer to remind them of an upcoming servicing appointment that the customer has made or provide a servicing reminder at a particular time interval (e.g., when the vehicle has approximately reached 30,000 miles and it is time for a 30,000 mile servicing checkup).

We claim:

1. One or more access and user devices comprising: at least one computer processing unit (CPU) with computational capabilities that is connected to and controls a computer memory via an address bus and a data bus where said address bus accesses a designated range of computer memories and range of memory bits and said data bus provides a flow of transmission(s) of data into and out of said CPU and computer memory; so that one or more computer-based vehicle concierge service (SC) devices are operational in connection with or separately from said access and user devices, said (SC) devices comprising; an ability to communicate with a vehicle owner, obtain a description of an owner's concern regarding a vehicle, assess potential issues that might exist for each vehicle, as well as to determine, schedule, and individualize and match each detail of a vehicle visit to any vehicle associated business that enters a workshop, wherein said (SC) devices are employed to provide predictive analysis that includes and predicts or monitors or predicts and monitors services and associated costs required for each vehicle and/or fleet of vehicles on a per vehicle basis and that includes a time required for accomplishment of said services.

2. The one or more SC devices of claim 1, wherein said SC devices provide information in a form of data and act to control one or more outputs devices, wherein said output devices are computing devices, wherein databases store data and configure bi-directional transmission of data to and from multiple SC devices, wherein said user devices, said access devices, and said SC devices are computing devices, and wherein one or more user, access, and SC devices store and provide at least partial copies of portions of a master database, and wherein said master database can also include partial databases and each of said databases are linked and communicate with each other and wherein said user, access and/or SC devices include one or more logging and monitoring databases that provide statistical and numerical calculations utilizing data.

3. The one or more SC devices of claim 1, wherein said one or more SC devices authenticate using a first set of computing operations, and validate using a second set of computing operations, and wherein a third set of computing operations controls access for a specified set of users of said SC devices and wherein data associated with said operations is securitized or encrypted or securitized and encrypted.

4. The one or more SC devices of claim 1, wherein said SC devices provide information in data format that optimizes performance and profitability for said vehicle associated business and wherein said data is accessible in order that said data is produced, analyzed, and interpreted and is optionally contained within a report that summarizes interpretation of said data and wherein said vehicle associated business is a dealership.

5. The one or more SC devices of claim 4, wherein said vehicle abruptly enters a dealership's workshop in an unscheduled manner.

6. The one or more SC devices of claim 5, wherein said vehicle is scheduled for future service at said dealership's workshop.

7. The one or more SC devices of claim 1, wherein said predictive assessments provide statistical certainty with regard to vehicular needs based upon historical data obtained from each vehicle and wherein said historical data resides in one or more static or dynamic databases that are included within said one or more computer-based SC devices.

8. The one or more SC devices of claim 1, wherein said databases are located within at least one of a group consisting of; a stand-alone, laptop, or mobile computer, a client-server, a network of computers that are networked individually or together and access an internet, a cellular phone that is a smart phone, and a cloud computer.

9. The one or more SC devices of claim 1, wherein said devices access at least one of a group consisting of an internet, intranet, and extranet such that said devices can obtain data generated from multiple sources in addition to data obtained from a single or multiple vehicle related businesses and/or dealerships.

10. The one or more SC devices of claim 1, wherein costs, profitability and associated services required data is provided on a per owner basis for individual or fleets of vehicles to vehicle related businesses and dealerships.

11. The one or more SC devices of claim 1, wherein prediction of items required to service said vehicles are selected from at least one of a group consisting of; non-essential items that will be recommended for/while service is performed for said vehicles during servicing, a level of skill of one or more technicians that will be required, essential equipment required, essential and non-essential parts stock requirements, a total number of hours said vehicle(s) will reside in a vehicle bay/workshop of said dealership, a final repair order value that includes a cost to a consumer, and prediction and optimization of utilization and need of and for loaner vehicles, wherein said prediction is based on data attributes including time and mileage, time on roadways, streets, and highways, as well as customer spending habits, number of vehicles owned and maintenance items that will be sold so that how and which one or more staff members of said vehicle related business and/or dealership should interact with an owner of said vehicle.

12. The one or more SC devices of claim 1, wherein use of data from databases created or obtained using said SC devices provides business intelligence in a form of predictive reports that at least predict and can also provide plots with said reports that provide details from at least one of a group consisting of; current/future shop revenues, current/future shop efficiencies, current/future staffing needs, current/future bay needs, current/future averages regarding all vehicle makes/models/years and associated repair order values, current/future parts inventory requirements, a number of service vehicles to be traded in and upgraded, and an appropriate time to present customers with an offer for trade-in that is dependent on predictions obtained from said SC.

13. The one or more SC devices of claim 2, wherein said databases are protected via securitization and/or encryption and are dynamically changing databases that can accumulate and sort data as needed to provide artificial intelligence (AI) to said SC devices.

14. The one or more SC devices of claim 1, wherein said devices are virtual devices.

15. The one or more SC devices of claim 1, wherein said devices are real devices.

16. One or more transaction secured computer-based dealership concierge service predictor (SC) devices that transmit to and receive data from one or more transaction secured SC devices to another, comprising: a housing; a computer driven communication processor containing a microprocessor and data storage encryption capacity fixedly mounted in said housing; one or more circuits fixedly mounted in said housing and communicatively coupled with said computer driven communication processor; a power source coupled with said circuits; at least one transceiver including a data transceiver portion coupled with said housing and coupled with said circuits and with said computer driven communication processor where one or more sensors are held within or on one or more surfaces of said transaction secured SC devices; wherein said transaction secured SC devices transmit and receive encrypted signals from one or more said transaction secured SC devices to another that form specific transmissions determined by one or more users, to said transceiver and a vehicle data transceiver portion of said transceiver;
wherein said transceiver and said vehicle data transceiver portion of said transceiver determines, via authentication and validation, identification of said users and confirms if said users are allowed access and manipulation of said transaction secured SC devices via utilization of said computer driven communication processor;
wherein said computer driven communication processor provides, processes, and analyzes confirmation and authentication of said users and allows a designated set of users of said SC transaction secured devices to operate said SC devices.

17. The SC transaction secured devices of claim 16, wherein said circuits are connected to sensors or said circuits themselves function as sensors.

18. The SC transaction secured devices of claim 16, wherein said circuits are selected from the group consisting of; electronic, optical, and radiation emitting or receiving or both radiation emitting and receiving energized circuits that transmit and receive signals.

19. The SC transaction secured devices of claim 16, wherein one or more display portions are communicatively coupled with said circuits.

20. The SC transaction secured devices of claim 19, wherein said display portions display timepiece data or transaction data or both timepiece data and transaction data.

21. The SC transaction secured devices of claim 19, wherein said devices are either real devices, virtual devices, or both real and virtual devices.

22. The SC transaction secured devices of claim 19, wherein said devices are selected from one or more of a group consisting of; computer terminals, laptop computers, smart phones that are cell phones with computation capabilities, printers, kiosks, vehicular dashboards with computational capabilities and visual or audio or both visual and audio displays, and transceivers with visual or audio or visual and audio information conveyance capabilities.

23. The one or more devices of claim 1, wherein said SC devices includes one or more Service Concierge (SC) Predictor AI module(s) that is a software module that operates together with and can reside within or external to said SC device(s) and that is responsible for provision of descriptive, predictive, and prescriptive business data for vehicle dealerships, associated vehicle businesses, and any stakeholders of said businesses, and wherein said Service Concierge Predictor AI module provides data that utilizes data stored in Dealership Management Systems DMS and related databases with data derived from dealerships and vehicle associated businesses and generates data using digital communication channels either housed within said SC device(s) or data derived from external data and databases.

24. The SC Predictor AI Module of claim 23, wherein said data is continuously updated data that includes a consumer's description of vehicle problems, concern types detected by a Service Concierge Understand AI module, and consumer's emotion(s) regarding said vehicle wherein said continuously updated data is continuously improving data in that data capture is useful for data analysis of one or more vehicles and said data analysis is based upon at least consumer interaction with vehicle(s) data and direct from vehicle automated interaction data.

25. The SC Predictor AI Module of claim 24, wherein vehicle interaction data includes customer's vehicle data that is captured by sensors that utilize data sent through digital communication channels including vibration sensors in addition to additional data captured directly from informational data that is contained within vehicles.

26. The SC Predictor AI Module of claim 25, wherein unique consumer interaction data and vehicle interaction data available on SC device(s) are transformed by said SC Predictor AI module using techniques that include log transformation and binarizing categorical predictor variables in order to allow said SC Predictor AI module to generate business analytics for said vehicle associated businesses, said business analytics selected from at least one or more of a group consisting of a dealership, a customer/consumer, vehicle repair and maintenance records, and wherein said vehicles include at least one or more of a group consisting of automobiles, trucks, motorcycles, snowmobiles, above and below water transportation craft, aircraft, and spacecraft and wherein said group can also be a fleet of said vehicles.

27. The (SC) devices of claim 1, wherein said devices are employed to provide at least one of a group consisting of service, repairs, maintenance and predictive analysis for autonomous or driverless or autonomous and driverless vehicles on a per vehicle basis and includes a time required for accomplishment of said services.

28. One or more access and user systems comprising: at least one computer processing unit (CPU) with computational capabilities that is connected to and controls a computer memory via an address bus and a data bus where said address bus accesses a designated range of computer memories and range of memory bits and said data bus provides a flow of transmission(s) of data into and out of said CPU and computer memory; so that one or more computer-based vehicle concierge service (SC) systems are operational in connection with or separately from said access and user devices, said (SC) systems comprising; an ability to communicate with a vehicle owner, obtain a description of an owner's concern regarding a vehicle, assess potential issues that might exist for each vehicle, as well as to determine, schedule, and individualize each detail of a vehicle visit to any vehicle associated business that enters a workshop, wherein said (SC) systems are employed to provide predictive analysis that includes and predicts or monitors or predicts and monitors services and associated costs required for each vehicle and/or fleet of vehicles on a per vehicle basis and that includes a time required for accomplishment of said services.

29. The one or more SC systems of claim 28, wherein said SC devices provide information in a form of data and act to control one or more outputs devices, wherein said output devices are computing devices, wherein databases store data and configure bi-directional transmission of data to and from multiple SC systems, wherein said user systems, said access systems, and said SC systems are computing systems, and wherein one or more user, access, and SC systems store and provide at least partial copies of portions of a master database, and wherein said master database can also include partial databases and each of said databases are linked and communicate with each other and wherein said user, access and/or SC systems include one or more logging and monitoring databases that provide statistical and numerical calculations utilizing data.

30. The one or more SC systems of claim 28, wherein said one or more SC systems authenticate using a first set of computing operations, and validate using a second set of computing operations, and wherein a third set of computing operations controls access for a specified set of users of said SC systems and wherein data associated with said operations is securitized or encrypted or securitized and encrypted.

31. The one or more SC systems of claim 28, wherein said SC systems provide information in data format that optimizes performance and profitability for said vehicle associated business and wherein said data is accessible in order that said data is produced, analyzed, and interpreted and is optionally contained within a report that summarizes interpretation of said data and wherein said vehicle associated business is a dealership.

32. The one or more SC systems of claim 31, wherein said vehicle abruptly enters a dealership's workshop in an unscheduled manner.

33. The one or more SC systems of claim 32, wherein said vehicle is scheduled for future service at said dealership's workshop.

34. The one or more SC systems of claim 28, wherein said predictive assessments provide statistical certainty with regard to vehicular needs based upon historical data obtained from each vehicle and wherein said historical data resides in one or more static or dynamic databases that are included within said one or more computer-based SC systems.

35. The one or more SC systems of claim 28, wherein said databases are located within at least one of a group consisting of; a stand-alone, laptop, or mobile computer, a client-server, a network of computers that are networked individually or together and access an internet, a cellular phone that is a smart phone, and a cloud computer.

36. The one or more SC systems of claim 28, wherein said systems access at least one of a group consisting of an internet, intranet, and extranet such that said systems can obtain data generated from multiple sources in addition to data obtained from a single or multiple vehicle related businesses and/or dealerships.

37. The one or more SC systems of claim 28, wherein costs, profitability and associated services required data is provided on a per owner basis for individual or fleets of vehicles to vehicle related businesses and dealerships.

38. The one or more SC systems of claim 28, wherein prediction of items required to service said vehicles are selected from at least one of a group consisting of; non-essential items that will be recommended for/while service is performed for said vehicles during servicing, a level of skill of one or more technicians that will be required, essential equipment required, essential and non-essential parts stock requirements, a total number of hours said vehicle(s) will reside in a vehicle bay/workshop of said dealership, a final repair order value that includes a cost to a consumer, and prediction and optimization of utilization and need of and for loaner vehicles, wherein said prediction is based on data attributes including time and mileage, time on roadways, streets, and highways, as well as customer spending habits, number of vehicles owned and maintenance items that will be sold so that how and which one or more staff members of said vehicle related business and/or dealership should interact with an owner of said vehicle.

39. The one or more SC systems of claim 28, wherein use of data from databases created or obtained using said SC systems provides business intelligence in a form of predictive reports that at least predict and can also provide plots with said reports that provide details from at least one of a group consisting of; current/future shop revenues, current/future shop efficiencies, current/future staffing needs, current/future bay needs, current/future averages regarding all vehicle makes/models/years and associated repair order values, current/future parts inventory requirements, a number of service vehicles to be traded in and upgraded, and an appropriate time to present customers with an offer for trade-in that is dependent on predictions obtained from said SC.

40. The one or more SC systems of claim 29, wherein said databases are protected via securitization and/or encryption and are dynamically changing databases that can accumulate and sort data as needed to provide artificial intelligence (AI) to said SC devices.

41. The one or more SC devices of claim 28, wherein said devices are virtual devices.

42. The one or more SC devices of claim 28, wherein said devices are real devices.

43. One or more transaction secured computer-based dealership concierge service predictor (SC) systems that transmit to and receive data from one or more transaction secured SC systems to another, comprising: a housing; a computer driven communication processor containing a microprocessor and data storage encryption capacity fixedly mounted in said housing; one or more circuits fixedly mounted in said housing and communicatively coupled with said computer driven communication processor; a power source coupled with said circuits; at least one transceiver including a data transceiver portion coupled with said housing and coupled with said circuits and with said computer driven communication processor where one or more sensors are held within or on one or more surfaces of said transaction secured SC devices; wherein said transaction secured SC systems transmit and receive encrypted signals from one or more said transaction secured SC systems to another that form specific transmissions determined by one or more users, to said transceiver and a vehicle data transceiver portion of said transceiver;
wherein said transceiver and said vehicle data transceiver portion of said transceiver determines, via authentication and validation, identification of said users and confirms if said users are allowed access and manipulation of said transaction secured SC systems via utilization of said computer driven communication processor;
wherein said computer driven communication processor provides, processes, and analyzes confirmation and authentication of said users and allows a designated set of users of said SC transaction secured systems to operate said SC systems.

44. The SC transaction secured systems of claim 43, wherein said circuits are connected to sensors or said circuits themselves function as sensors.

45. The SC transaction secured systems of claim 43, wherein said circuits are selected from the group consisting of; electronic, optical, and radiation emitting or receiving or both radiation emitting and receiving energized circuits that transmit and receive signals.

46. The SC transaction secured systems of claim 43, wherein one or more display portions are communicatively coupled with said circuits.

47. The SC transaction secured systems of claim 46, wherein said display portions display timepiece data or transaction data or both timepiece data and transaction data.

48. The SC transaction secured systems of claim 46, wherein said systems are either real devices, virtual devices, or both real and virtual devices.

49. The SC transaction secured systems of claim 46, wherein said systems are selected from one or more of a group consisting of; computer terminals, laptop computers, smart phones that are cell phones with computation capabilities, printers, kiosks, vehicular dashboards with computational capabilities and visual or audio or both visual and audio displays, and transceivers with visual or audio or visual and audio information conveyance capabilities.

50. The one or more systems of claim 28, wherein said SC systems include one or more Service Concierge (SC) Predictor AI module(s) that is a software module that operates together with and can reside within or external to said SC system(s) and that is responsible for provision of descriptive, predictive, and prescriptive business data for vehicle dealerships, associated vehicle businesses, and any stakeholders of said businesses, and wherein said Service Concierge Predictor AI module provides data that utilizes data stored in Dealership Management Systems DMS and related databases with data derived from dealerships and vehicle associated businesses and generates data using digital communication channels either housed within said SC device(s) or data derived from external data and databases.

51. The SC Predictor AI Module of claim 50, wherein said data is continuously updated data that includes a consumer's description of vehicle problems, concern types detected by a Service Concierge Understand AI module, and consumer's emotion(s) regarding said vehicle wherein said continuously updated data is continuously improving data in that data capture is useful for data analysis of one or more vehicles and said data analysis is based upon at least consumer interaction with vehicle(s) data and direct from vehicle automated interaction data.

52. The SC Predictor AI Module of claim 51, wherein vehicle interaction data includes customer's vehicle data that is captured by sensors that utilize data sent through digital communication channels including vibration sensors in addition to additional data captured directly from informational data that is contained within vehicles.

53. The SC Predictor AI Module of claim 52, wherein unique consumer interaction data and vehicle interaction data available on SC device(s) are transformed by said SC Predictor AI module using techniques that include log transformation and binarizing categorical predictor variables in order to allow said SC Predictor AI module to generate business analytics for said vehicle associated businesses, said business analytics selected from at least one or more of a group consisting of a dealership, a customer/consumer, vehicle repair and maintenance records, and wherein said vehicles include at least one or more of a group consisting of automobiles, trucks, motorcycles, snowmobiles, above and below water transportation craft, aircraft, and spacecraft and wherein said group can also be a fleet of said vehicles.

54. The (SC) systems of claim 28, wherein said devices are employed to provide at least one of a group consisting of service, repairs, maintenance and predictive analysis for autonomous or driverless or autonomous and driverless vehicles on a per vehicle basis and includes a time required for accomplishment of said services.

55. The one or more transaction secured computer-based dealership concierge service predictor (SC) systems of claim 43, wherein said transaction and/or transactions are secured by one or more access devices or one or more user devices or both one or more access devices and one or more user devices comprising: at least one computer processing unit (CPU) with computational capabilities that is connected to and controls a computer memory via an address bus and a data bus where said address bus accesses a designated range of computer memories and range of memory bits and said data bus provides a flow of transmission(s) into and out of said CPU and computer memory; one or more real or one or more virtual master distributed auto-synchronous array (DASA) databases or both one or more real and one or more virtual master distributed auto-synchronous array (DASA) databases located within or external to said access devices and said user devices, where said master (DASA) databases at least store and retrieve data and also include at least two or more partial distributed auto-synchronous array (DASA) databases, wherein said partial DASA databases function in either an independent manner, a collaborative manner or both an independent manner and a collaborative manner, wherein said master and said partial DASA databases analyze and provide information in a form of data and act to control one or more output devices, wherein said output devices are computing devices, wherein said one or more output devices create user devices, and wherein said master and said partial DASA databases configure bi-directional transmission of data to and from multiple partial user devices, to and from multiple partial access devices or to and from both multiple partial user and multiple partial access devices, wherein said user devices and said access devices are computing devices, and wherein one or more partial user and one or more partial access devices store and provide at least partial copies of portions of said master DASA databases, and wherein said master DASA databases, said partial DASA databases or both said partial DASA databases and said master DASA databases are linked and communicate with each other as well as inclusion of one or more logging and monitoring databases that provide statistical and numerical calculations utilizing data, wherein said one or more access devices authenticate using a first set of computing operations, and validate using a second set of computing operations, and wherein a third set of computing operations controls access for a specified set of users.
